(19) United States
(12) Patent Application Publication
(10) Pub. No.: US 2017/0180778 A1
(43) Pub. Date: Jun. 22, 2017

(54) BROADCAST TRANSMISSION APPARATUS, BROADCAST RECEPTION APPARATUS, BROADCAST TRANSMISSION APPARATUS OPERATING METHOD, AND BROADCAST RECEPTION APPARATUS OPERATING METHOD

(71) Applicant: LG ELECTRONICS INC., Seoul (KR)

(72) Inventors: Jinwon LEE, Seoul (KR); Seungryul YANG, Seoul (KR); Seungjoo AN, Seoul (KR); Woosuk KO, Seoul (KR); Minsung KWAK, Seoul (KR); Kyoungsoo MOON, Seoul (KR); Sungryong HONG, Seoul (KR)

(73) Assignee: LG ELECTRONICS INC., Seoul (KR)

(21) Appl. No.: 15/410,267

(22) Filed: Jan. 19, 2017

Related U.S. Application Data
(63) Continuation of application No. PCT/KR2015/007870, filed on Jul. 28, 2015.
(60) Provisional application No. 62/030,620, filed on Jul. 30, 2014.
(60) Provisional application No. 62/033,094, filed on Aug. 4, 2014.

(51) Int. Cl. H04N 21/43; H04N 21/436; H04N 21/63

(52) U.S. Cl. CPC H04N 21/4302; H04N 21/631; H04N 21/436; H04N 21/64707

(57) ABSTRACT

A broadcast reception apparatus comprises: a broadcast interface for receiving a service including a program, and signaling information, wherein the signaling information includes media time information of the program being reproduced; a companion screen interface for discovering a companion screen device; and a controller for operating the broadcast interface and the companion screen interface, wherein the controller includes a time synchronization service processor for generating service time information providing data related to a time synchronization between the program and a program being displayed on the companion screen device on the basis of the signaling information, and the companion screen interface transmits the service time information to the companion screen device.

### TECHNICAL FIELD

The present invention relates to a broadcast transmitting apparatus, a broadcast receiving apparatus, a method of operating a broadcast transmitting apparatus, and a method of operating a broadcast receiving apparatus.

### BACKGROUND ART

By virtue of the development of digital broadcast environments and communication environments, hybrid broadcast using a communication network (a broadband network) as well as an existing broadcast network has attracted much attention. In addition, such hybrid broadcast has provided an application or broadcast service that is operatively associated with a terminal device such as a smartphone or a tablet. The hybrid broadcast has provided a personalization function of providing an application associated with a broadcast service and content appropriate for each user.

For such hybrid broadcast, a broadcast receiving apparatus needs to freely access a communication network (a broadband network). The broadcast receiving apparatus needs to present content received through a communication network (a broadband network). To this end, a broadcast receiving apparatus and a broadcast transmitting apparatus need to support a content transfer protocol for supporting both a broadcast network and a communication network (a broadband network). To this end, there has been proposed use of MPEG-dynamic adaptive streaming over HTTP (DASH), which is standard technology for adaptively transmitting media content and MPEG media transport (MMT), which is a transmission standard for effectively transmitting media content via an IP network by the broadcast transmitting apparatus and the broadcast receiving apparatus according to a network environment.

### DISCLOSURE

### Technical Problem

An object of the present invention devised to solve the problem lies in a broadcast transmitting apparatus, a broadcast receiving apparatus, a method of operating a broadcast transmitting apparatus, and a method of operating a broadcast receiving apparatus, for providing transmission and presentation of media content through a communication network (a broadband network) and a broadcast network.

An object of the present invention devised to solve the problem lies in an opt-in/out method with respect to an application executed in a hybrid broadcast system by a user in an environment in which a terrestrial broadcast network and the Internet are available.

An object of the present invention devised to solve the problem lies in a method of supporting association between broadcast content and content transmitted through DASH in an environment in which next-generation hybrid broadcast using a terrestrial broadcast network and the Internet is supported.

An object of the present invention devised to solve the problem lies in a method of transmitting service time information to a companion screen device by a broadcast receiving apparatus.

An object of the present invention devised to solve the problem lies in a method of supporting time-shift by an interactive application that is also executable along with a program when the program is time-shifted.

### Technical Solution

The object of the present invention can be achieved by providing a broadcast receiving apparatus including a broadcast interface configured to receive signaling information and a service including a program, the signaling information including media time information of the presented program, a companion screen interface configured to discover a companion screen device, and a controller configured to operate the broadcast interface and the companion screen interface, wherein the controller includes a time synchronization service processor configured to generate service time information for providing information related to time synchronization between the program and a program displayed by the companion screen device based on the signaling information, and the companion screen interface transmits the service time information to the companion screen device.

The service time information may include at least one of serviceId attribute indicating an identifier (ID) of the service, programId attribute indicating an ID of the program presented in the service, mediaTime element indicating the media time information of the program, and/or currentTime element indicating wall-clock time.

The companion screen interface may transmit the service time information to the companion screen device based on a first request of making a request for acquisition of the service time information received from the companion screen device.

The time synchronization service processor may generate update interval information indicating an interval for transmitting the service time information, and the companion screen interface may transmit the service time information to the companion screen device based on the update interval information.

The update interval information may be one of delivery duration information indicating duration for transmitting the service time information and delivery frequency information indicating a frequency for transmitting the service time information.

The companion screen interface may receive a second request of making a request for acquisition of the update interval information, the time synchronization service processor may generate current update interval information indicating a value of the update interval information at a time point indicated by the wall-clock time based on the second request, and the companion screen interface may transmit the current update interval information to the companion screen device.

The companion screen interface may receive a third request of making a request for setup of the update interval information from the companion screen device, the third request may include requested update interval information indicating a value of update interval information requested by the companion screen device, the time synchronization service processor generates confirmed update interval information indicating one of the same value as the requested update interval information and a closest value to the requested update interval information, and the companion screen interface may transmit the service time information to the companion screen device based on the confirmed update interval request information.

The signaling information may include an activation message table including at least one trigger of the program, the controller may further include a time-shift manager configured to generate a time-shift management table that describes an application operated in the time-shifted program based on the activation message table, and the controller may operate the application based on the time-shift management table.

The signaling information may include triggering application information including metadata of the application, the controller may extract the trigger and the triggering application information based on the time-shift management table, and the controller may operate the application based on the trigger and the triggering application information.

The triggering application information may include timeShiftEnabled attribute indicating whether the application is operated with respect to the time-shifted program.

The activation message table may include at least one of majorProtocolVersion attribute indicating a major protocol version, minorProtocolVersion attribute indicating a minor protocol version, segmentId attribute indicating an ID matched with an ID of the triggering application information, beginMT attribute indicating start media time of a program segment, and Activation element including an activation message.

The broadcast receiving apparatus may further include a broadband interface connected to a content server through the Internet, wherein the activation message table may further include TPTURL attribute indicating a location of the triggering application information, and the broadband interface may receive the triggering application information from the content server based on the TPTURL attribute.

The activation message table may further include expireDate attribute indicating an available time of the activation message table, and the controller may delete the activation message table when a time indicated by the expireDate attribute elapses.

The time-shift management table may include at least one of serviceId attribute indicating a unique ID of the service, programId attribute indicating a unique ID of the program, fileLocation attribute indicating a location of a file, TPTId attribute indicating a unique ID of triggering application information, AppInfo element including attribute of the application, and ActivationInfo element including trigger information indicating attribute of the trigger.

The companion screen interface may transmit the time-shift management table to the second screen device.

### Advantageous Effects

According to an embodiment of the present invention, provided are a broadcast transmitting apparatus, a broadcast receiving apparatus, a method of operating a broadcast transmitting apparatus, and a method of operating a broadcast receiving apparatus, for transmission and presentation of media content through a communication network (a broadband network) and a broadcast network.

According to an embodiment of the present invention, usability setting such as Optin/out may be achieved for each application using a PDI system for personalization in a hybrid broadcast system.

According to an embodiment of the present invention, when a receiver configures application notification and manages Optin/out, the receiver may transmit application notification information to a companion device.

According to an embodiment of the present invention, application signaling may be divided and transmitted for each application ID during transmission of the application signaling to a companion device.

According to an embodiment of the present invention, provided is a delivery method of interactive application signaling of a next-generation hybrid broadcast system.

According to an embodiment of the present invention, interactive application signaling received by a TV, i.e., a primary device may be transmitted to a second screen, that is, a companion device in a next-generation hybrid broadcast system.

According to an embodiment of the present invention, time synchronization between content displayed by a broadcast receiving apparatus and content displayed by a companion screen device may be provided.

According to an embodiment of the present invention, time-shift may also be supported by an interactive application that is executable along with a program when the program is time-shifted.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structure of an apparatus for transmitting broadcast signals for future broadcast services according to an embodiment of the present invention.

FIG. 2 illustrates a BICM block according to an embodiment of the present invention.

FIG. 3 illustrates a frame building block according to one embodiment of the present invention.

FIG. 4 illustrates an OFDM generation block according to an embodiment of the present invention.

FIG. 5 illustrates a structure of a broadcast receiving apparatus according to an embodiment of the present invention.

FIG. 6 illustrates a structure of a broadcast receiving apparatus according to another embodiment of the present invention.

FIG. 7 illustrates a structure of a broadcast receiving apparatus according to another embodiment of the present invention.

FIG. 8 is a view showing a TPT including content advisory information (ContentAdvisoryInfo element) according to an embodiment of the present invention.

FIG. 9 is a view showing an application programming interface (API) for acquiring a rating value according to an embodiment of the present invention.

FIG. 10 is a diagram illustrating a structure of a transceiving system according to an embodiment of the present invention.

FIG. 11 is a diagram illustrating event information according to an embodiment of the present invention.

FIG. 12 is a diagram illustrating XML format of event information according to an embodiment of the present invention.

FIG. 13 is a diagram illustrating UPnP Action Mechanism according to an embodiment of the present invention.

FIG. 14 is a diagram illustrating a REST mechanism according to an embodiment of the present invention.

FIG. 15 is a diagram illustrating state variables for transmitting a trigger according to an embodiment of the present invention.

FIG. 16 is a diagram illustrating trigger list information according to an embodiment of the present invention.

FIG. 17 is a diagram illustrating XML format of trigger list information according to an embodiment of the present invention.

FIG. 18 is a diagram illustrating trigger transmission information according to an embodiment of the present invention.

FIG. 19 is a diagram illustrating trigger transmission information according to an embodiment of the present invention.

FIG. 20 is a diagram illustrating trigger list information according to an embodiment of the present invention.

FIG. 21 is a diagram illustrating XML data format of trigger list information according to an embodiment of the present invention.

FIG. 22 is a diagram illustrating trigger transmission information according to an embodiment of the present invention.

FIG. 23 is a flow diagram when trigger type information indicates “action” according to an embodiment of the present invention.

FIG. 24 illustrates XML format of TriggerInfoList when trigger type information indicates “action” according to an embodiment of the present invention.

FIG. 25 is a flow diagram when trigger type information indicates “action” according to an embodiment of the present invention.

FIG. 26 illustrates XML format of TriggerInfoList when trigger type information indicates “action” according to an embodiment of the present invention.

FIG. 27 is a flow diagram when trigger type information indicates “status” according to an embodiment of the present invention.

FIG. 28 is a diagram illustrating XML format of TriggerInfoList when trigger type information indicates “status” according to an embodiment of the present invention.

FIG. 29 is a flow diagram when trigger type information indicates “mediaTime” according to an embodiment of the present invention.

FIG. 30 is a diagram illustrating XML format of TriggerInfoList when trigger type information indicates “mediaTime” according to an embodiment of the present invention.

FIG. 31 is a flow diagram when a first receiver and a second receiver are not paired with each other according to an embodiment of the present invention.

FIG. 32 is a flow diagram of the case in which the first receiver and the second receiver are not paired according to an embodiment of the present invention.

FIG. 33 is a flow diagram of reception of triggering application information by a second receiver from a transmitter according to an embodiment of the present invention.

FIG. 34 is a flowchart illustrating an operation of a broadcast receiving apparatus according to an embodiment of the present invention.

FIG. 35 is a diagram illustrating a structure of a broadcast system according to an embodiment of the present invention.

FIG. 36 is a diagram illustrating a broadcast system for delivery of time information according to an embodiment of the present invention.

FIG. 37 is a diagram illustrating state variables for delivery of service time information according to an embodiment of the present invention.

FIG. 38 is a diagram illustrating service time information according to an embodiment of the present invention.

FIG. 39 is a diagram illustrating XML format of service time information according to an embodiment of the present invention.

FIG. 40 is a diagram illustrating operations required to transmit service time information according to an embodiment of the present invention.

FIG. 41 is a diagram illustrating delivery frequency information according to an embodiment of the present invention.

FIG. 42 is a flow diagram of transmitting service time information to a companion screen device by a broadcast receiving apparatus using an eventing method according to an embodiment of the present invention.

FIG. 43 is a flow diagram of transmitting service time information to a companion screen device by a broadcast receiving apparatus using a requesting method according to an embodiment of the present invention.

FIG. 44 is a flowchart illustrating an operation of a broadcast receiving apparatus according to an embodiment of the present invention.

FIG. 45 is a diagram illustrating a structure of a broadcast receiving apparatus for supporting a time-shifted application according to an embodiment of the present invention.

FIG. 46 is a diagram illustrating a time-shift management table (TMT) according to an embodiment of the present invention.

FIG. 47 is a diagram illustrating XML format data of a TMT according to an embodiment of the present invention.

FIG. 48 is a diagram illustrating TPT signaling according to an embodiment of the present invention.

FIG. 49 is a diagram illustrating XML format data of a TPT according to an embodiment of the present invention.

FIG. 50 is a diagram illustrating trigger signaling according to an embodiment of the present invention.

FIG. 51 is a diagram illustrating an AMT including TPT URL attribute according to an embodiment of the present invention.

FIG. 52 is a diagram illustrating an AMT including expireDate attribute according to an embodiment of the present invention.

FIG. 53 is a diagram illustrating a TMT including trigger information according to an embodiment of the present invention.

FIG. 54 is a flowchart illustrating an operation of an application based on a broadcast signal by a broadcast receiving apparatus according to another embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

The term “signaling” in the present invention may indicate that service information (SI) that is transmitted and received from a broadcast system, an Internet system, and/or a broadcast/Internet convergence system. The service information (SI) may include broadcast service information (e.g., ATSC-SI and/or DVB-SI) received from the existing broadcast systems.

The term “broadcast signal” may conceptually include not only signals and/or data received from a terrestrial broadcast, a cable broadcast, a satellite broadcast, and/or a mobile broadcast, but also signals and/or data received from bidirectional broadcast systems such as an Internet broadcast, a broadband broadcast, a communication broadcast, a data broadcast, and/or VOD (Video On Demand).

The term “PLP” may indicate a predetermined unit for transmitting data contained in a physical layer. Therefore, the term “PLP” may also be replaced with the terms ‘data unit’ or ‘data pipe’ as necessary.

A hybrid broadcast service configured to interwork with the broadcast network and/or the Internet network may be used as a representative application to be used in a digital television (DTV) service. The hybrid broadcast service transmits, in real time, enhancement data related to broadcast A/V (Audio/Video) contents transmitted through the terrestrial broadcast network over the Internet, or transmits, in real time, some parts of the broadcast A/V contents over the Internet, such that users can experience a variety of contents.

The present invention provides apparatuses and methods for transmitting and receiving broadcast signals for future broadcast services. Future broadcast services according to an embodiment of the present invention include a terrestrial broadcast service, a mobile broadcast service, a UHDTV service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

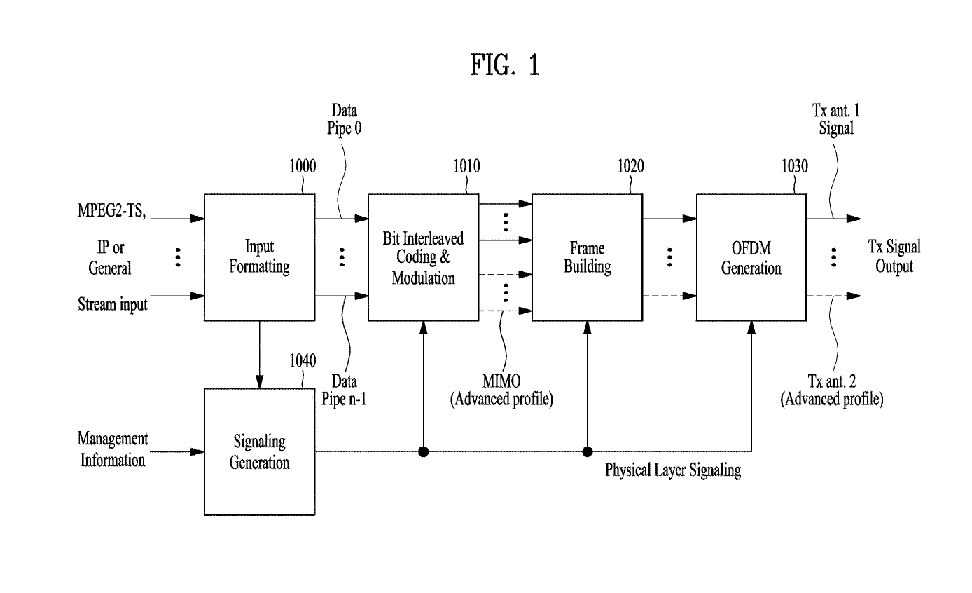

FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

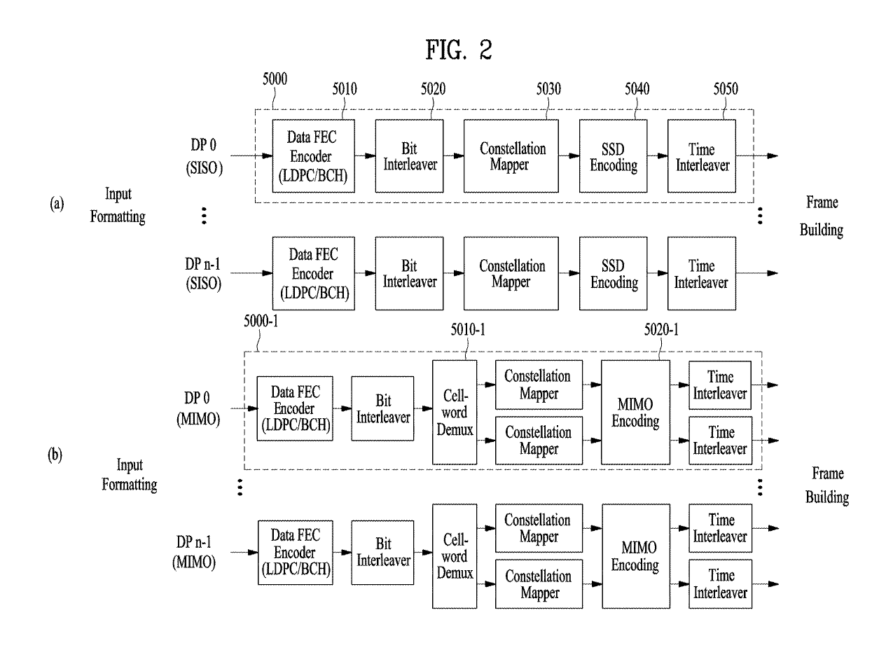

FIG. 2 illustrates a BICM block according to an embodiment of the present invention.

The BICM block illustrated in FIG. 2 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

The above-described blocks may be omitted or replaced by blocks having similar or identical functions.

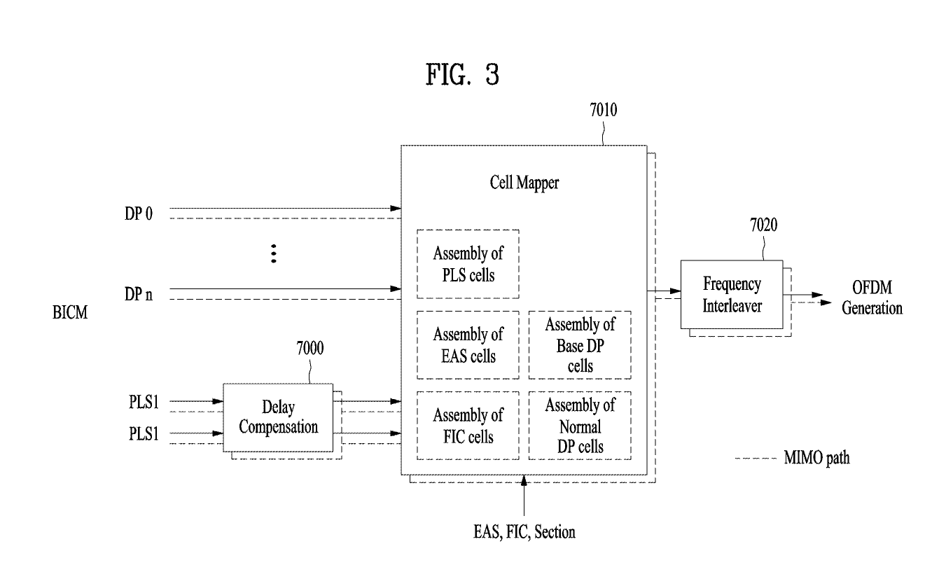

FIG. 3 illustrates a frame building block according to one embodiment of the present invention.

The frame building block illustrated in FIG. 3 corresponds to an embodiment of the frame building block 1020 described with reference to FIG. 1.

Referring to FIG. 3, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver 5050. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame.

The above-described blocks may be omitted or replaced by blocks having similar or identical functions.

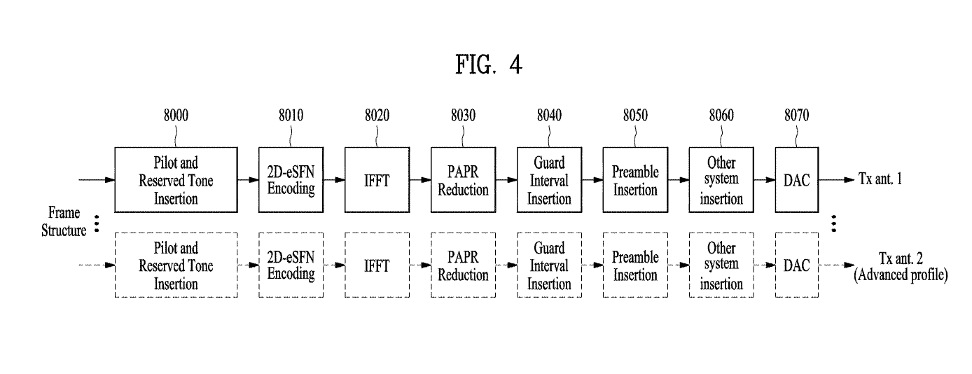

FIG. 4 illustrates an OFDM generation block according to an embodiment of the present invention.

The OFDM generation block illustrated in FIG. 4 corresponds to an embodiment of the OFDM generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 4, the OFDM generation block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

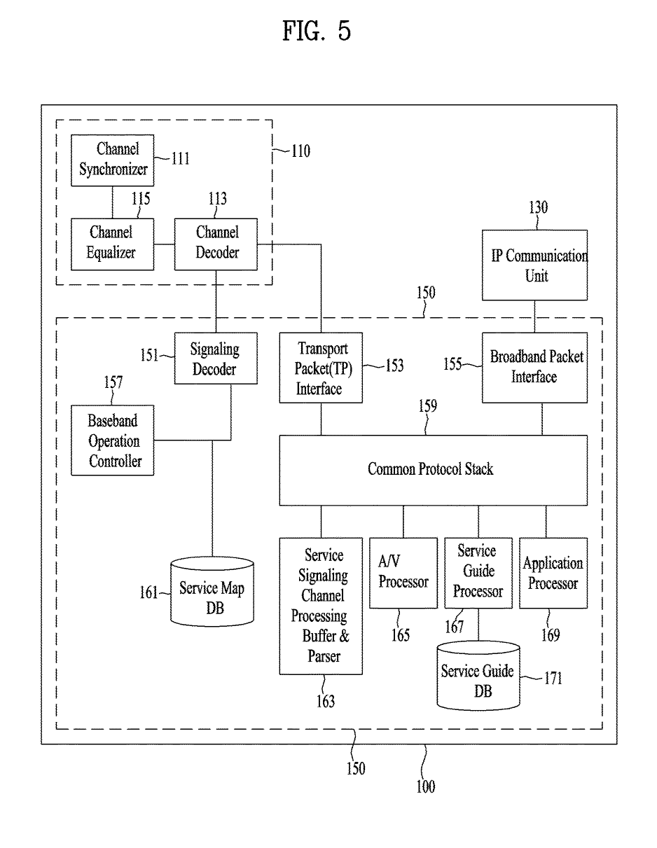

FIG. 5 illustrates a structure of a broadcast receiving apparatus according to an embodiment of the present invention.

In the embodiment of FIG. 5, the broadcast receiving apparatus 100 may include the broadcast receiver 110, the IP transceiver 130, and the controller 150.

The broadcast receiver 110 may include a channel synchronizer 111, a channel equalizer 113, and a channel decoder 115.

The channel synchronizer 111 may synchronize a symbol frequency and timing so as to decode a broadcast signal in a baseband for receiving the broadcast signal.

The channel equalizer 113 may compensate for distortion of the synchronized broadcast signal. In detail, the channel equalizer 113 may compensate for distortion of the synchronized broadcast signal due to multipath interference, Doppler effect, and so on.

The channel decoder 115 may decode the broadcast signal, distortion of which is compensated for. In detail, the channel decoder 115 may extract a transport frame from the broadcast signal, distortion of which is compensated for. In this case, the channel decoder 115 may perform forward error correction (FEC).

The IP transceiver 130 may receive and transmit data through the Internet.

The controller 150 may include a signaling decoder 151, a transport packet interface 153, a broadband packet interface 155, a baseband operation controller 157, a common protocol stack 159, a service map database (DB) 161, a service signaling channel processing buffer and parser 163, an A/V processor 165, a broadcast service guide processor 167, an application processor 169, and a service guide DB 171.

The signaling decoder 151 may decode signaling information of the broadcast signal.

The transport packet interface 153 may extract a transport packet from the broadcast signal. In this case, the transport packet interface 153 may extract data such as signaling information or an IP datagram from the extracted transport packet.

The broadband packet interface 155 may extract the IP packet from the received data through the Internet. In this case, the broadband packet interface 155 may extract the signaling data or the IP datagram from the IP packet.

The baseband operation controller 157 may control an operation associated with reception of received information of broadcast information from a baseband.

The common protocol stack 159 may extract audio or video from the transport packet.

The A/V processor 165 may process audio or video.

The service signaling channel processing buffer and parser 163 may parse and buffer signaling information for signaling a broadcast service. In detail, the service signaling channel processing buffer and parser 163 may parse and buffer the signaling information for signaling the broadcast service from the IP datagram.

The service map DB 165 may store a broadcast service list including information on broadcast services.

The broadcast service guide processor 167 may process terrestrial broadcast service guide data for guiding a program of a terrestrial broadcast service.

The application processor 169 may extract and process application related information from the broadcast signal.

The application processor 169 may extract and process application related information from the broadcast signal.

The service guide DB 171 may store program information of a broadcast service.

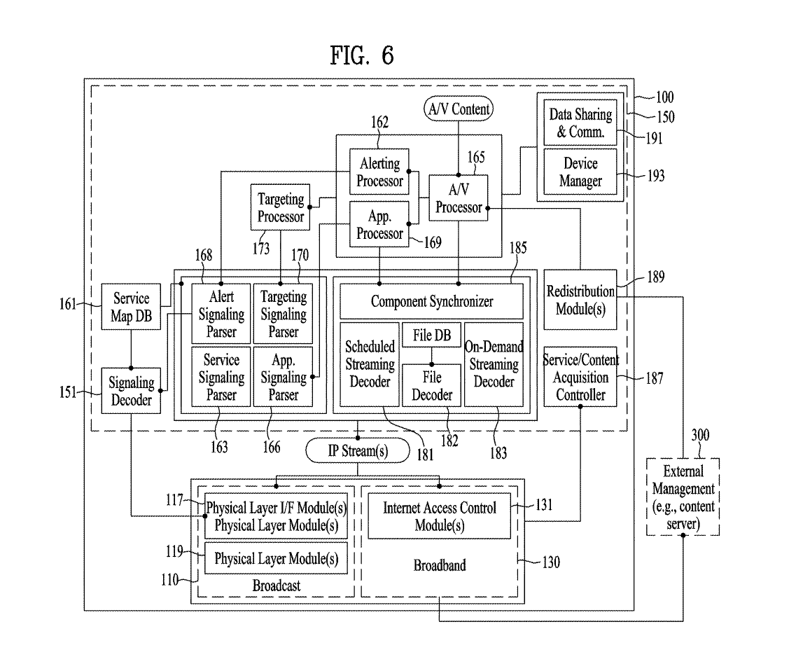

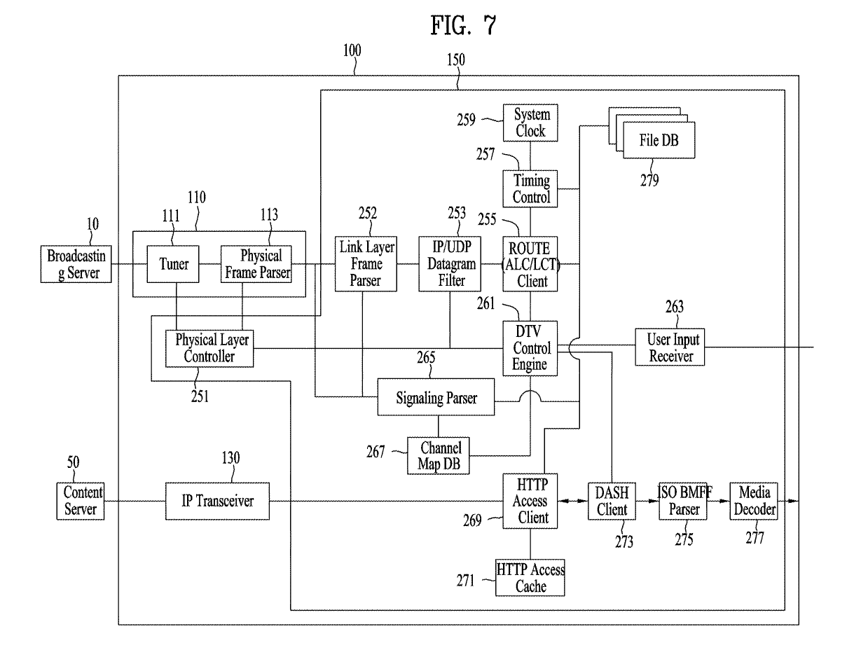

Thus far, a schematic structure and operation of the broadcast receiving apparatus 100 have been described. However, the above description has been given in terms of a typical operation and transmission protocol of the broadcast receiving apparatus 100. However, in order to receive a hybrid broadcast service, the broadcast receiving apparatus 100 needs to process data of various transmission protocols. With reference to FIGS. 6 to 7, a detailed structure and operation of the broadcast receiving apparatus 100 for receiving a hybrid broadcast service will be described below.

FIG. 6 illustrates a structure of a broadcast receiving apparatus according to another embodiment of the present invention.

In the embodiment of FIG. 6, the broadcast receiving apparatus 100 may include the broadcast receiver 110, the IP transceiver 130, and the controller 150.

The broadcast receiver 110 may include one or more processors, one or more circuits, and one or more hardware modules, for performing a plurality of functions performed by the broadcast receiver 110. In detail, the broadcast receiver 110 may be a system on chip (SOC) in which a plurality of semiconductor components are stacked as one structure. In this case, the SOC may be a semiconductor formed by integrating various multimedia components such as graphics, audio, video, and MODEM and a semiconductor such as a processor and a DRAM. The broadcast receiver 110 may include a physical layer module 119 and a physical layer IP frame module 117. The physical layer module 119 may receive and process a broadcast related signal through a broadcast channel of a broadcast network. The physical layer IP frame module 117 may convert a data packet such as an IP datagram acquired from the physical layer module 119 into a specific frame. For example, the physical layer module 119 may convert the IP datagram and so on into an RS Frame, a GSE, or the like.

The IP transceiver 130 may include one or more processors, one or more circuits, and one or more hardware modules, for performing a plurality of functions performed by the IP transceiver 130. In detail, the IP transceiver 130 may be a system on chip (SOC) in which plural semiconductor components are stacked as one structure. In this case, the SOC may be a semiconductor formed by integrating various multimedia components such as graphics, audio, video, and MODEM and a semiconductor such as a processor and a DRAM. The IP transceiver 130 may include an Internet access control module 131. The Internet access control module 131 may control an operation of the broadcast receiving apparatus 100 for acquisition of any one of a service, content, and signaling data through a communication network (a broadband network).

The controller 150 may include one or more processors, one or more circuits, and one or more hardware modules, for performing a plurality of functions performed by the controller 150. In detail, the controller 150 may be a system on chip (SOC) in which a plurality of semiconductor components are stacked as one structure. In this case, the SOC SOC may be a semiconductor formed by integrating various multimedia components such as graphics, audio, video, and MODEM and a semiconductor such as a processor and a DRAM. The controller 150 may include at least one of the signaling decoder 151, the service map DB 161, a service signaling channel parser 163, an application signaling parser 166, an alert signaling parser 168, a targeting signaling parser 170, a targeting processor 173, an A/V processor 165, an alert processor 162, the application processor 169, a scheduled streaming decoder 181, a file decoder 182, an on-demand streaming decoder 183, a file DB 184, a component synchronizer 185, a service/content acquisition controller 187, a redistribution module 189, a device manager 193, and a data sharer 191.

The service/content acquisition controller 187 may control an operation of a receiver for acquisition of a service, content, and signaling data related to the service or content, acquired through a broadcast network or a communication network.

The signaling decoder 151 may decode the signaling information.

The service signaling channel parser 163 may parse the service signaling information.

The application signaling parser 166 may extract and parse signaling information related to a service. In this case, the signaling information related to the service may be signaling information related to service scan. In addition, the signaling information related to a service may be signaling information related to content provided through a service.

The alert signaling parser 168 may extract and parse signaling information related to alerts.

The targeting signaling parser 170 may extract and parse information for signaling targeting information or information for personalization of a service or content.

The targeting processor 173 may process information for personalization of a service or content.

The alert processor 162 may process signaling information related to alerts.

The application processor 169 may control execution of application related information and an application. In detail, the application processor 169 may process a state of a downloaded application and a display parameter.

The A/V processor 165 may process a rendering related operation of audio/video based on decoded audio or video, application data, and so on.

The scheduled streaming decoder 181 may decode scheduled streaming that is content that is streamed according to a schedule predetermined by a content provider such as a broadcaster.

The file decoder 182 may decode a downloaded file. In particular, the file decoder 182 may decode a file downloaded through a communication network.

The on-demand streaming decoder 183 may decode on-demand content provided on-demand.

The file DB 184 may store a file. In detail, the file DB 184 may store a file downloaded through a communication network.

The component synchronizer 185 may synchronize content or a service. In detail, the component synchronizer 185 may synchronize content decoded by at least one of the scheduled streaming decoder 181, the file decoder 182, and the on-demand streaming decoder 183.

The service/content acquisition controller 187 may control an operation of a receiver for acquisition of at least one of a service, content, and signaling information related to the service or content.

When the redistribution module 189 does not receive a service or content through a broadcast network, the redistribution module 189 may perform an operation for supporting acquisition of at least one of a service, content, service related information, and content related information. In detail, at least one of a service, content, service related information, and content related information may be requested to an external management device 300. In this case, the external management device 300 may be the content server 50.

The device manager 193 may manage an associated external device. In detail, the device manager 193 may perform at least one of addition, deletion, and update of an external device. In addition, the external device may be connected to the broadcast receiving apparatus 100 and may exchange data with the broadcast receiving apparatus 100.

The data sharer 191 may perform a data transmission operation between the broadcast receiving apparatus 100 and the external device and process exchange related information. In detail, the data sharer 191 may transmit A/V data or signaling information to the external device. The data sharer 191 may receive the A/V data or the signaling information to the external device.

FIG. 7 illustrates a structure of a broadcast receiving apparatus according to another embodiment of the present invention.

In the embodiment of FIG. 7, the broadcast receiving apparatus 100 may include the broadcast receiver 110, the IP transceiver 130, and the controller 150.

The broadcast receiver 110 may include at least one of a tuner 111 and a physical frame parser 113.

The tuner 111 may receive a broadcast signal transmitted through a broadcast network. The tuner 111 may convert the received broadcast signal into a physical frame form.

The physical frame parser 113 may extract a link layer frame from a physical frame of the received broadcast signal.

The IP transceiver 130 may receive and transmit IP data.

The controller 150 may include at least one of a physical layer controller 251, a link layer frame parser 252, an IP/UDP datagram filter 253, a ROUTE (AL/LCT) client 255, a timing control 257, a system clock 259, a DTV control engine 261, a user input receiver 263, a signaling parser 265, a channel map DB 267, an HTTP access client 269, an HTTP access cache 271, a DASH client 273, an ISO BMFF parser 275, a media decoder 277, and a file DB 279.

The physical layer controller 251 may control an operation of the broadcast receiver 110. In detail, the physical layer controller 251 may control transmission parameters of a broadcast signal received by the broadcast receiver 110 to selectively receive a broadcast signal. For example, the physical layer controller 251 may control a frequency of a broadcast signal received by the tuner 111. The physical layer controller 251 may control the physical frame parser 113 to extract a link layer frame from a broadcast signal.

The link layer frame parser 252 may extract data corresponding to a payload of a link layer frame from the link layer frame of a broadcast signal. In detail, the link layer frame parser 252 may extract link layer signaling from a link layer frame. The link layer signaling may signal a broadcast signal through a link layer. Thereby, the broadcast receiving apparatus 100 may acquire information on a broadcast service without extraction of an application layer. Accordingly, the broadcast receiving apparatus 100 may rapidly scan a broadcast service and convert the broadcast service. The link layer frame parser 252 may extract an IP/UDP datagram from the link layer frame.

The IP/UDP datagram filter 253 may extract specific IP/UDP datagram from the IP/UDP datagram. Data transmission through a broadcast network or multicast through a communication network is unidirectional communication and, thus, the broadcast receiving apparatus 100 may receive data items other than data required by the broadcast receiving apparatus 100. Accordingly, the broadcast receiving apparatus 100 may extract data required by the broadcast receiving apparatus 100 from a data stream. The IP/UDP datagram filter 253 may extract the IP/UDP datagram required by the broadcast receiving apparatus 100 from the IP/UDP datagram stream. In detail, the IP/UDP datagram filter 253 may extract an IP/UDP datagram corresponding to the determined IP address and UDP port number. In this case, the IP address may include any one of a source address and a destination address.

The ROUTE (AL/LCT) client 255 may process an application layer transport packet. In detail, the ROUTE (ALC/LCT) client 255 may process a real-time object delivery over unidirectional transport (ROUTE)-based ALC/LCT packet. The ROUTE protocol is an application layer protocol for transmitting data in real time using an ALC/LCT packet. The broadcast receiving apparatus 100 may extract at least one of broadcast service signaling information, NRT data, and media content from an ALC/LCT packet. In this case, the media content may have an MPEG-DASH form. In detail, the media content may be encapsulated in an ISO base media file format and transmitted according to an MPEG-DASH protocol. The broadcast receiving apparatus 100 may extract an MPEG-DASH segment from a ROUTE packet. The broadcast receiving apparatus 100 may extract an ISO BMFF file from the MPEG-DASH segment.

The timing control 257 may process a packet including system time information as a reference of media content presentation. The timing control 257 may control a system clock based on the system time information.

The system clock 259 may provide a reference clock as a reference of an operation of the broadcast receiving apparatus 100.

The DTV control engine 261 may function as an interface between components. In detail, the DTV control engine 261 may transmit a parameter for control of an operation of each component.

The user input receiver 263 may receive user input. In detail, the user input receiver 263 may receive at least one of a remote control input and a key input of a user.

The signaling parser 265 may transmit information on a broadcast service and parse broadcast service signaling information for signaling the broadcast service to extract information on the broadcast service. In detail, the signaling parser 265 may parse the broadcast service signaling information extracted from the application layer to extract information on the broadcast service. In another detailed embodiment, the signaling parser 265 may parse the broadcast service signaling information extracted from the link layer to extract information on the broadcast service.

The channel map DB 267 may store information on a channel map of the broadcast service. In detail, the signaling parser 265 may extract the information on the broadcast service and store information on a channel map in the channel map DB 267. The DTV control engine 261 may acquire information on a channel map of the broadcast service from a channel map DB. In this case, the information on the channel map may include at least one of a channel number indicating the broadcast service and a broadcast service name of the broadcast service.

The HTTP access client 269 may process HTTP data. In detail, the HTTP access client 269 may transmit a request to the content server 50 using HTTP and receive a response to the request from the content server 50.

The HTTP access cache 271 may cache the HTTP data to enhance processing speed of the HTTP data.

The DASH client 273 may process an MPEG-DASH segment. In detail, the DASH client 273 may process the MPEG-DASH segment received through a communication network. In detail, the DASH client 273 may process the MPEG-DASH segment extracted from the application layer of the broadcast signal received through the broadcast network.

The ISO BMFF parser 275 may process an ISO BMFF packet. In detail, the ISO BMFF parser 275 may extract media content from the ISO BMFF packet.

The media decoder 277 may decode media content. In detail, the media decoder 277 may decode the media content and present the media content.

The file DB 279 may store a file required for the broadcast service. In detail, the file DB 279 may store a file extracted from an application layer of the broadcast signal.

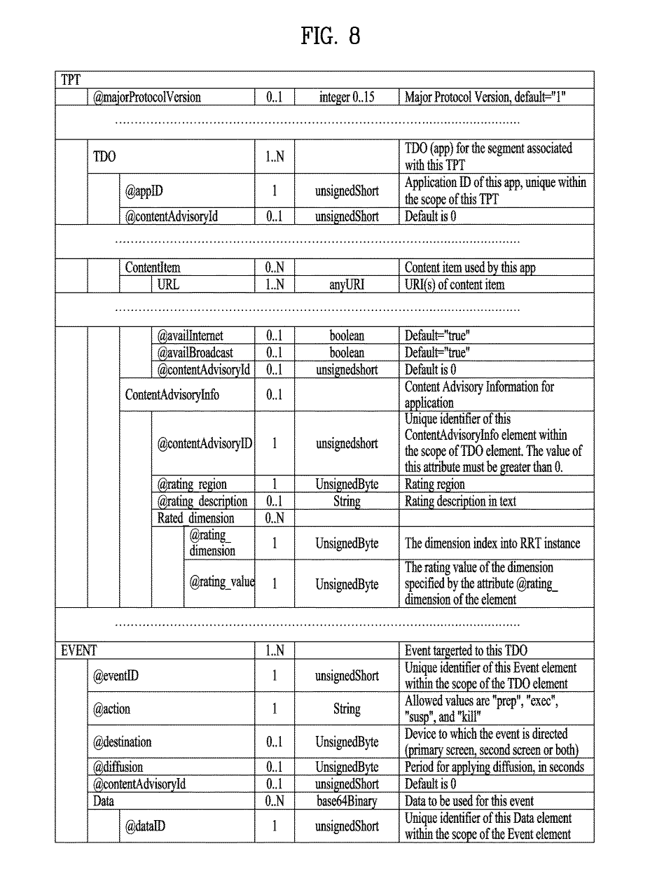

FIG. 8 is a view showing a TPT including content advisory information (ContentAdvisoryInfo element) according to an embodiment of the present invention.

A receiver may decide whether a synchronized application provided by a broadcaster can be used in the receiver based on rating information set for a TV by a user.

An application (for example, TDO) that can be used in next generation hybrid broadcasting may be configured as content according to set rating information and provided as an app service.

The content advisory information may be transported as signaling information while being included in a broadcast signal. Alternatively, the content advisory information may be included in the above-described TPT.

In order to include the content advisory information in the TPT, the ContentAdvisoryInfo element may be further signaled in the TPT.

The ContentAdvisoryInfo element includes rating information of given ContentItem or Event. This value may have the same value as rating information per region declared in a rating region table (RRT).

In order to include the content advisory information in the TPT, one or more of the following elements may be signaled through the TPT.

A contentAdvisoryId element indicates a delimiter that is capable of only recognizing ContentAdvisoryInfo from a TDO element scope.

A rating_region element means a rating region. For example, in a case in which a value of the rating_region element is 1, it may indicate USA. On the other hand, in a case in which a value of the rating_region element is 2, it may indicate Canada.

A rating_description element includes text expressing a rating value in an abbreviated form.

A Rated_dimension element may indicate the number of rating regions predefined per nation.

A rating_dimension element indicates a dimension index in the rating region table (RRT).

A rating_value element indicates a rating value of a dimension indicated by the rating_dimension element. For example, the rating_value element may have a value of TV-G, TV-PG, etc. according to the dimension.

The contentAdvisoryId element may be added to a TDO element, ContentItem element, or Event element. Consequently, the rating information may be applied to the entirety of the TDO. Alternatively, the rating information may be applied per Con-tentItem or Event. In a case in which a corresponding element has no rating information, a value of 0 is provided as a default value. In a case in which a corresponding element is associated with rating information, a value of the contentAdvisoryId element is provided below the ContentAdvisoryInfo element.

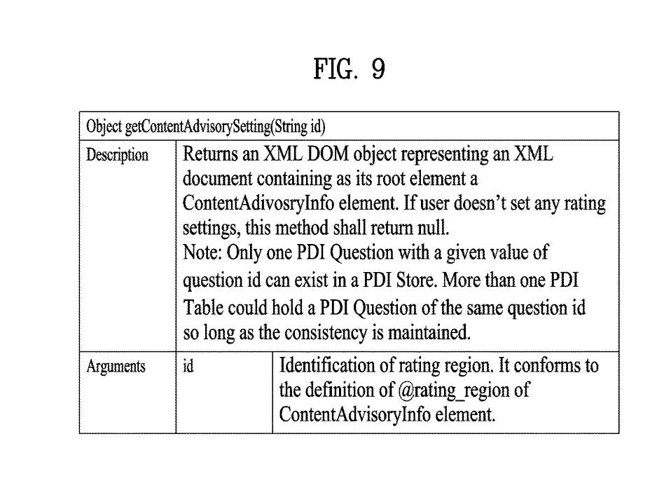

FIG. 9 is a view showing an application programming interface (API) for acquiring a rating value according to an embodiment of the present invention.

In order to obtain a rating value set in a TV from an application (or TDO), an API for the application is needed.

As shown in the figure, a function for obtaining a rating value may be added to an API for an existing broadcasting system.

The application provides rating_region information to the API to obtain a rating information value set by a user. A rating information value stored in a receiver may be transmitted to the above-described ContentAdvisoryInfo element.

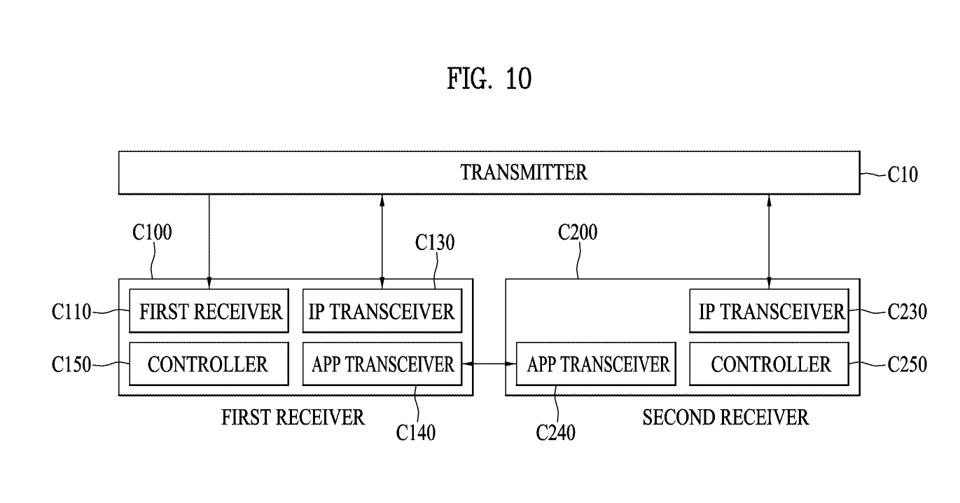

FIG. 10 is a diagram illustrating a structure of a transceiving system according to an embodiment of the present invention.

According to an embodiment of the present invention, the transceiving system may include at least one of a transmitter C10, a first receiver C100, and/or a second receiver C200.

The transmitter C10 may provide a broadcast service. For example, the broadcast service may include at least one of content (or linear service), an application (or non-linear service), and/or signaling information. The transmitter C10 may transmit a broadcast stream including a broadcast service using at least one of satellite, terrestrial, and cable broadcast networks. The transmitter C10 may transmit the broadcast service according to requests of the first receiver C100 and/or the second receiver C200. The transmitter C10 may include at least one of the aforementioned broadcast transmitting apparatus (not shown), a content provider (not shown), a content server (not shown), controller (not shown), and/or a transmitter (not shown).

The first receiver C100 may receive the broadcast service through the broadcast network and/or the Internet. The first receiver C100 may be represented as a broadcast receiving apparatus, a receiver, a first screen device, a master device, and/or a primary device. The first receiver C100 may include at least one of a broadcast receiver C110, an IP transceiver C130, an app transceiver C140, a decoder (not shown), a display (not shown), and/or a controller C150.

The broadcast receiver C110 may receive a broadcast stream including a broadcast service. In this case, the broadcast stream may be transmitted using at least one of satellite, terrestrial, and cable broadcast networks. Accordingly, the broadcast receiver C110 may include at least one of a satellite tuner, a terrestrial tuner, and a cable tuner in order to receive the broadcast stream.

The IP transceiver C130 may make a request for a broadcast service to the transmitter C10. The IP transceiver C130 may receive the broadcast service from the transmitter C10.

The app transceiver C140 may transmit and/or receive the broadcast service to and from an app transceiver C240 of the second receiver C200. The app transceiver C140 may transmit signaling information to the second receiver from the first receiver and may be referred to as an application signaling service.

A decoder (not shown) may decode a broadcast service.

A display (not shown) may display the broadcast service.

The controller C150 may control operations of the broadcast receiver C110, the IP transceiver C130, the app transceiver C140, the decoder, and/or the display.

The second receiver C200 may receive the broadcast service through the Internet. The second receiver C200 may be represented as a second broadcast receiving apparatus, a second receiver, a second screen device, a slave device, and/or a companion device. The second receiver C200 may include at least one of an IP transceiver C230, the app transceiver C240, a decoder (not shown), a display (not shown), and/or a controller C250. However, according to an embodiment, the second receiver C200 may further include a broadcast receiver (not shown). The second receiver C200 may have a plural number.

The IP transceiver C230 may make a request for a broadcast service to the transmitter C10. The IP transceiver C230 may receive the broadcast service from the transmitter C10.

The app transceiver C240 may transmit and/or receive the broadcast service to and from the app transceiver C140 of the first receiver C100. The app transceiver C240 may transmit signaling information to the first receiver from the second receiver and may be referred to as an application signaling service.

A decoder (not shown) may decode a broadcast service.

A display (not shown) may display a broadcast service.

The controller C250 may control operations of a broadcast receiver C210, an IP transceiver C230, the app transceiver C240, a decoder, a broadcast receiver, and/or a display.

A detailed description of the transmitter C10, the first receiver C100, and/or the second receiver C200 may include the entire above description.

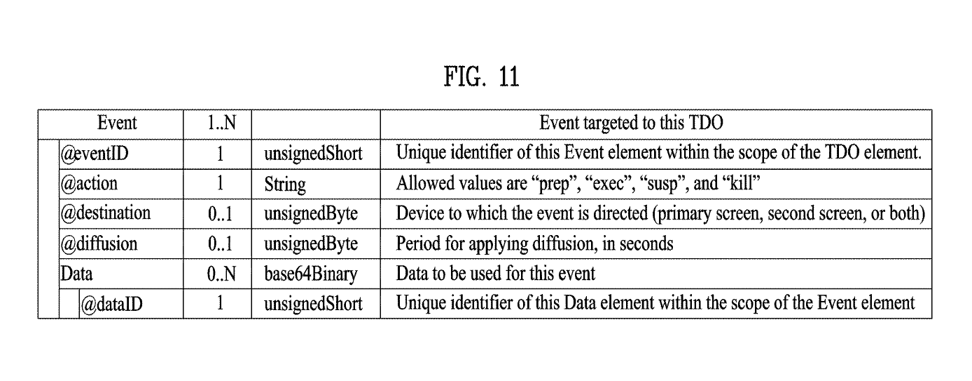

FIG. 11 is a diagram illustrating event information according to an embodiment of the present invention.

According to an embodiment of the present invention, the first receiver may receive signaling information through a broadcast network and/or the Internet. In detail, the first receiver may receive application signaling information including a trigger and/or triggering application information (e.g., TPT). The first receiver may store event information included in the triggering application information in a storage (or primary device storage) included in the first receiver.

According to an embodiment of the present invention, the first receiver may transmit the signaling information to the second receiver. In detail, the first receiver may transmit the application signaling information to the second receiver (e.g. companion device).

For example, the signaling information may include application signaling information. The application signaling information may include at least one of a trigger for triggering an operation of an application and triggering application information for signaling information on a triggered application.

The trigger may include at least one of a trigger for signaling a state (or life cycle) of an application, a trigger for signaling an operation of an application, and/or a trigger for signaling media time. The state of the application may include at least one of preparing, execution, termination, and/or suspending.

The triggering application information may include additional information required to execute an application.

According to an embodiment of the present invention, the triggering application information may include application information (TDO). The application information may include event information indicating information on an event of an application. In a detailed embodiment, the event information may be referred to as event.

The event information may include an event identifier for identifying an event. In detail, the event identifier may uniquely identify an event in a corresponding application range. In a detailed embodiment, the event identifier may be referred to as eventID. In a detailed embodiment, the event identifier may be a 16-bit element.

The event information may include action information indicating an operation of an event. In detail, the event information may include preparing, execution, termination or kill, and/or suspending. In a detailed embodiment, the action information may be referred to as action.

The event information may include destination information indicating target information targeted by an application. The destination information may indicate that an application is used for only the first receiver (or primary device) for receiving a broadcast signal. The destination information may indicate that an application is used for only one or more second receivers (or companion device) that are operatively associated with the first receiver (or primary device) for receiving a broadcast signal. The destination information may indicate that an application is used for both the first receiver and the second receiver. In a detailed embodiment, the destination information may be referred to as destination.

The event information may include diffusion information for diffusing a triggering application information request. In detail, the first receiver may calculate a random value based on the diffusion information, may be on standby by as much as the random value and, then may make a request for triggering application information to a server. In detail, the receiver may be on standby by as much as a value obtained by multiplying the random value by 10 ms and then may make a request for the triggering application information to the server. In a detailed embodiment, the diffusion information may be referred to as diffusion. In a detailed embodiment, the diffusion information may be an 8-bit element.

The event information may include data information indicating data associated with an event. Each event may have a data element associated with an event. In a detailed embodiment, the data information may be referred to as data.

The data information may include a data identifier for identifying data. The data identifier may be referred to as dataID. The data identifier may be a 16-bit element.

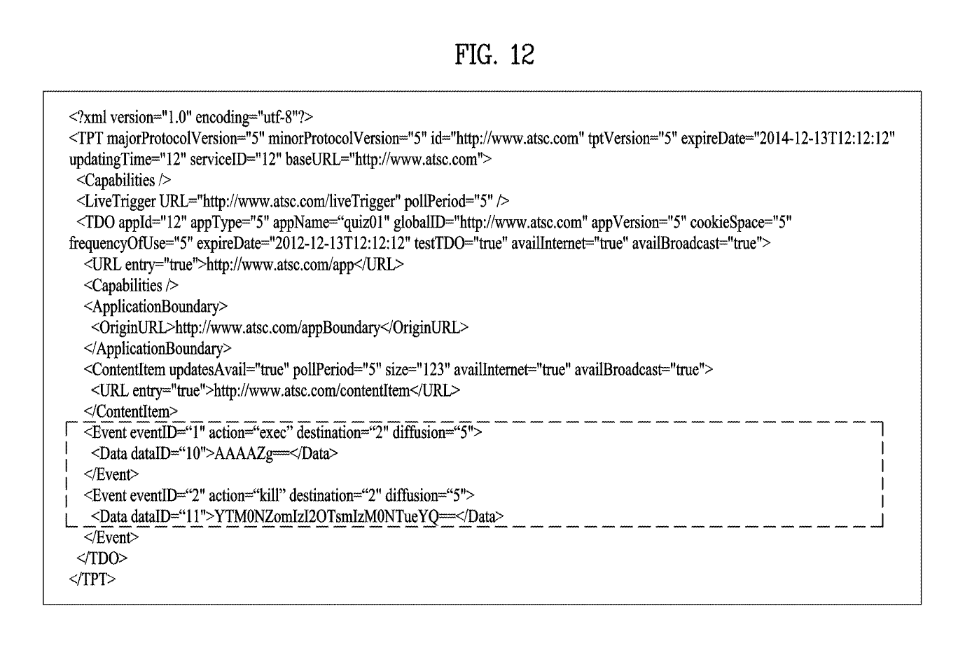

FIG. 12 is a diagram illustrating XML format of event information according to an embodiment of the present invention.

The drawing illustrates XML format of triggering application information received by the first receiver according to an embodiment of the present invention. Hereinafter, event information included in the triggering application information will be described.

The application information may include first event information and/or second event information.

The first event information may include eventID, action, destination, and/or dataID. The eventID may indicate “1”. The action may indicate “exec”. The destination may indicate “2”. Diffusion may indicate “5”. The dataID may indicate “10”. The data may indicate “AAAAZg==”.

The second event information may include eventID, action, destination, and/or dataID. The eventID may indicate “2”. The action may indicate “kill”. The destination may indicate “2”. The diffusion may indicate “5”. The dataID may indicate “11”. The data may indicate “YTM0NZomIzI2OTsmIzM0NTueYQ==”.

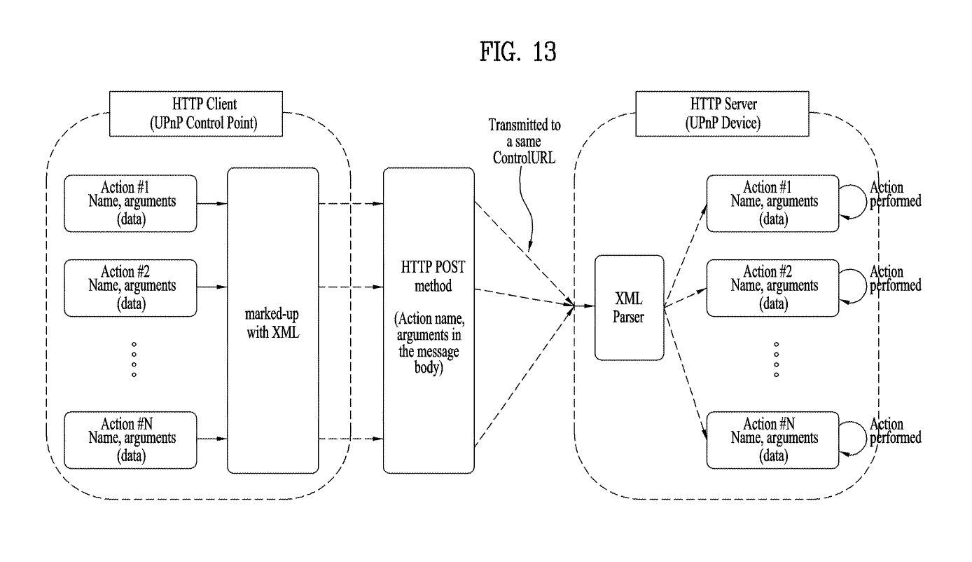

FIG. 13 is a diagram illustrating UPnP Action Mechanism according to an embodiment of the present invention.

Referring to the drawing, one method of communication between devices applied to an embodiment of the present invention may be a communication protocol between devices, obtained by combining protocols of IP-TCP/UDP-HTTP among technology of various layers.

According to an embodiment of the present invention, the technology of layer will be described.

First, according to an embodiment of the present invention, communication between devices may be represented to exchange message, command, call, action, and/or request/response.

Second, according to an embodiment of the present invention, in order to stably transmit a message used during communication between devices to a desired target device, various protocols such as an Internet control message protocol (ICMP) and an Internet group management protocol (IGMP) as well as an Internet protocol (IP) may be applied and may not be limited to a specific protocol.

Third, according to an embodiment of the present invention, in order to stably transmit a message used during communication between devices, to control a message flow, to overcome collision or congestion between a plurality of messages, and to support multiplexing, various protocols such as a datagram congestion control protocol (DCCP) and a stream control transmission protocol (SCTP) as well as a transmission control protocol (TCP) and a user datagram protocol (UDP) and may not be limited to a specific protocol.

Fourth, according to an embodiment of the present invention, in order to transmit various information items in a message used during communication between devices for various purposes, various protocols such as a hypertext transfer protocol (HTTP), a real-time transport protocol (RTP), an extensible messaging and presence protocol (XMPP), and a file transfer protocol (FTP) may be applied and may not be limited to a specific protocol.

Fifth, according to an embodiment of the present invention, when a message used during communication between devices is transmitted through the aforementioned various protocols, desired message data may be transmitted in various message component such as a message header and a message body among message components defined in each protocol and a specific message component may not be limited.

Sixth, according to an embodiment of the present invention, when a message used during communication between devices is transmitted, data to be transmitted may be transmitted using various types (string, integer, floating point, boolean, character, array, list, etc.) defined in each protocol. In order to more structurally represent, transmit, and store data with complex information, a markup method such as extensible markup language (XML), hypertext markup language (HTML), extensible hypertext markup language (XHTML), and javascript object notation (JSON) or text, image format, etc. and a specific method may not be limited.

Seventh, according to an embodiment of the present invention, data included in a message used during communication between devices may be transmitted using various data compression technologies such as “gzip” (RFC 1952), “deflate” (RFC 1950), and “compress” (RFC 2616) and a specific method may not be limited.

UPnP action proposed according to an embodiment of the present invention may be one of various methods of communication between devices and data to be actually transmitted may be transmitted in XML format in an HTTP POST message body using a POST method defined in the HTTP to a control URL acquired during UPnP discovery and description. In the case of a UPnP protocol, an action name is defined and used for each action and is transmitted together with the HTTP POST message body transmitted in XML and, thus, only one URL may be present with respect to a communication target device and an infinite type of action (message) may be exchanged even if only one HTTP POST method is used.

All UPnP actions proposed according to an embodiment of the present invention may be applied via various types of combinations of the aforementioned various technologies of layer and all contents proposed by an embodiment of the present invention may not be limited to the UPnP method.

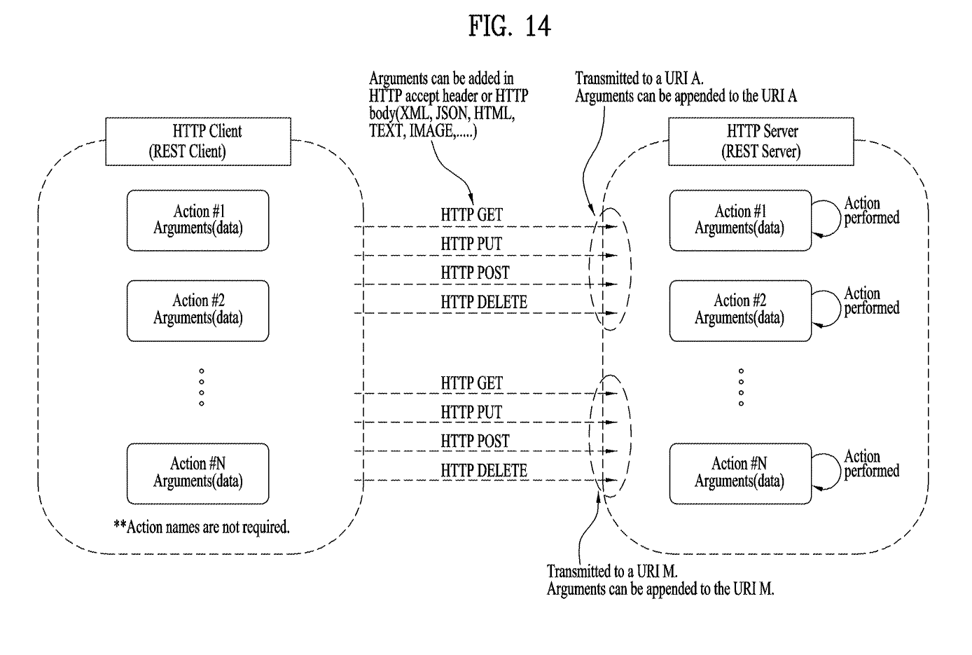

FIG. 14 is a diagram illustrating a REST mechanism according to an embodiment of the present invention.

Referring to the drawing, a REST method as one method of communication between devices applied to an embodiment of the present invention may define a plurality of URIs to be accessed to a communication target device.

For example, when various methods GET, HEAD, PUT, DELETE, TRACE, OPTIONS, CONNECT, and PATCH as well as POST among HTTP methods are used and a plurality of URIs to be accessed to a communication target device are defined, communication between devices proposed by an embodiment of the present invention may be applied without definition of an action name. Data to be transmitted may be appended to a corresponding URL or may be transmitted and transmitted in an HTTP body in various forms. A plurality of URI values required in the REST method may be acquired during a discovery or description procedure.

FIG. 15 is a diagram illustrating state variables for transmitting a trigger according to an embodiment of the present invention.

According to an embodiment of the present invention, a transceiving system may receive signaling information using the first receiver (or primary device) and execute an event by the second receiver based on signaling information.

For example, the first receiver may receive the signaling information. The first receiver may receive the signaling information through a broadcast network. The signaling information may include application signaling information. The application signaling information may include a trigger and/or triggering application information. The triggering application information may include event information. The event information may include destination information. According to an embodiment, the destination may indicate “2”. When the destination indicates “2”, a target device may indicate the second receiver (or companion device) and the corresponding event may be executed by the second receiver.

Hereinafter, a method of receiving signaling information by the first receiver through a broadcast network and executing an event through the second receiver based on the signaling information will be described. For example, the first receiver may receive a trigger for executing an event with destination=“2” through a broadcast network. The first receiver may transmit the trigger to the second receiver. The second receiver (or companion device) may execute the event using the trigger. According to an embodiment of the present invention, an example of UPnP will be described.

The first receiver and/or the second receiver may each include an app transceiver. The app transceiver may transmit signaling information to the second receiver (or CD) from the first receiver (or PD). According to an embodiment, the app transceiver may be referred to as an application signaling service. According to an embodiment, a service type may be defined as urn:atsc.org:serviceId:atsc3.0:applicationsignaling:1.

The app transceiver of the first receiver may transmit the signaling information (e.g., application signaling information) received through a broadcast network by the first receiver to the second receiver. In addition, the first receiver may allow the second receiver to directly receive the signaling information (or application signaling information) from a transmitter through the Internet using the app transceiver.

The drawing illustrates trigger transmission information for transmitting a trigger. The trigger transmission information may include trigger list information and/or trigger position information. The trigger transmission information may be included in the signaling information and/or the application signaling information. The trigger transmission information may be transmitted to the second receiver from the first receiver using an eventing method and in response to a request of the second receiver.

The trigger list information may include overall information items on a trigger for the second receiver (or CD) as a required state variable. According to an embodiment of the present invention, the trigger list information may be referred to as TriggerInfoList variable. The trigger list information may be transmitted to the second receiver from the first receiver using an eventing method and/or in response to a request of the second receiver.

The trigger position information may indicate a position at which the second receiver (or CD) makes a request for trigger information to a transmitter (or content server) as a required state variable. According to an embodiment, the trigger position information may be referred to as A_ARG_TYPE_NotificationInfo variable. The trigger position information may be transmitted to the second receiver from the first receiver in response to a request of the second receiver. However, the present invention is not limited thereto and the trigger position information may be transmitted to the second receiver from the first receiver using an eventing method.

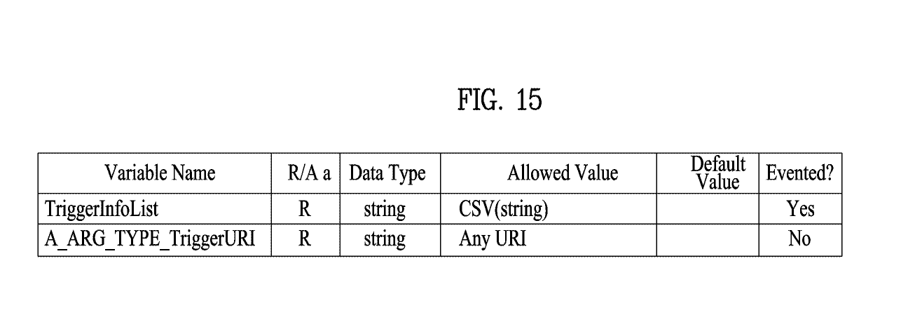

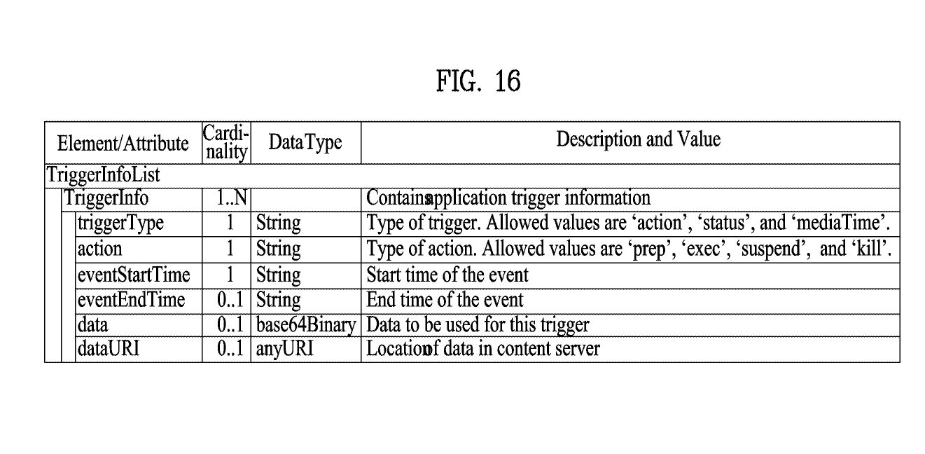

FIG. 16 is a diagram illustrating trigger list information according to an embodiment of the present invention.

Referring to the drawing, the trigger list information may include overall information on a trigger for the second receiver (or CD) as a required state variable. The trigger list information may include trigger information for at least one trigger for the second receiver (or CD).

The trigger information may include at least one of trigger type information, action information, event start time information, event termination time information, data information, and/or data position information.

The trigger type information may indicate a type of a trigger for triggering an application. The trigger type information may be application trigger type information for the second receiver (or CD). The trigger type information may be referred to as triggerType. The application trigger type may include action, status, and/or mediaTime. For example, when the trigger type information indicates “action”, the triggering application information for signaling information on a triggered application may include an action to be executed by the application. When the trigger type information indicates “status”, the triggering application information may signal change in a life cycle of an application. When the trigger type information indicates “mediaTime”, the triggering application information may include media time. Each type may be the same as in the above description and may be changed or added.

The action information may indicate an operation of a triggered application. The action information may be application trigger action information for the second receiver (or CD). The action information may be referred to as action. The application trigger action may be the same as prep, exec, suspend, and kill. The action may be changed or added in the future. When the application trigger type is an action, the application trigger type may be related to a lifecycle of an application. When the application trigger type is a status, the application trigger type may be related to contained data.

The event start time information may indicate time at which a trigger for the second receiver (or CD) is started. The event start time information may be referred to as eventStartTime.

The event termination time information may indicate time at which a trigger for the second receiver (or CD) is terminated. The event termination time information may be referred to as eventEndTime.

The data information may be trigger related data for the second receiver (or CD). The data information may be referred to as data.

The data position information may indicate a position on a content server of the trigger related data for the second receiver (or CD). The data position information may be referred to as dataURI.

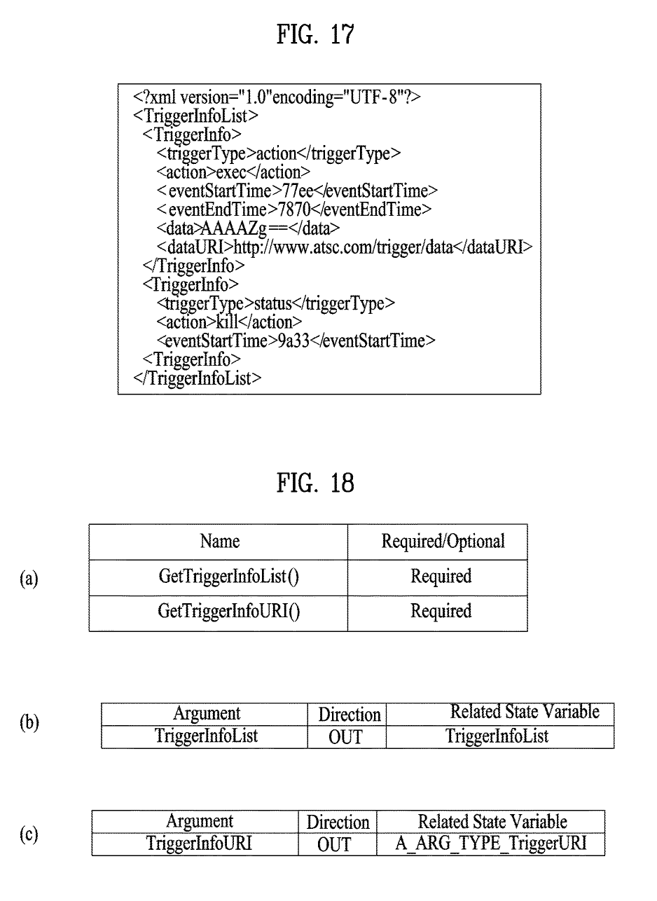

FIG. 17 is a diagram illustrating XML format of trigger list information according to an embodiment of the present invention.

Referring to the drawing, the trigger list information may include first trigger information and/or second trigger information.

The first trigger information may include at least one of trigger type information, action information, event start time information, event termination time information, data information, and/or data position information. The trigger type information may indicate “action”. The action information may indicate “exec”. The event start time information may indicate “77ee”. The event termination time information may indicate 7870”. The data information may indicate “AAAAZg==”. The data position information may indicate “http://www.atsc.com/trigger/data”.

The second trigger information may include at least one of trigger type information, action information, and/or event start time information. The trigger type information may indicate “status”. The action information may indicate “kill”. The event start time information may indicate “9a33”.

FIG. 18 is a diagram illustrating trigger transmission information according to an embodiment of the present invention.

(a) of the drawing illustrates trigger transmission information. The trigger transmission information may include trigger list information and/or trigger position information. The trigger transmission information may be transmitted to the second receiver from the first receiver in response to a request of the second receiver.

The second receiver may make a request for the trigger list information to the first receiver. Information for requesting the trigger list information to the first receiver by the second receiver may be referred to as GetTriggerInfoList( ). For example, GetTriggerInfoList( ) may be information for requesting valid trigger information to the first receiver by the second receiver (or CD). For example, the GetTriggerInfoList( ) may be used to check whether valid trigger information is present in the second receiver (or CD) at a current time point when the second receiver (or CD) is connected to the first receiver (or PD) in the middle of a specific program as a required action.

The second receiver may make a request for trigger position information to the first receiver. The information for requesting trigger position information to the first receiver by the second receiver may be referred to as GetTriggerInfoURI( ). For example, the GetTriggerInfoURI( ) may be used to request trigger related information from a content server through the Internet by the second receiver (or CD) as a required action. As a return value of GetTriggerInfoURI action, a position of trigger information on the second receiver (or CD) on TriggerURI, i.e., the content server may be acquired in the form of URL.

(b) of the drawing illustrates trigger list information. The first receiver may transmit trigger list information in response to a request of the second receiver. For example, the second receiver may acquire trigger list information as a return value of the GetTriggerInfoList action. A state variable related to the trigger list information may be TriggerInfoList.

(c) of the drawing illustrates trigger position information. The first receiver may transmit trigger position information in response to the request of the second receiver. For example, the second receiver may acquire trigger position information as a return value of the GetTriggerInfoURI action. The state variable related to the trigger position information may be A_ARG_TYPE_TriggerURI.

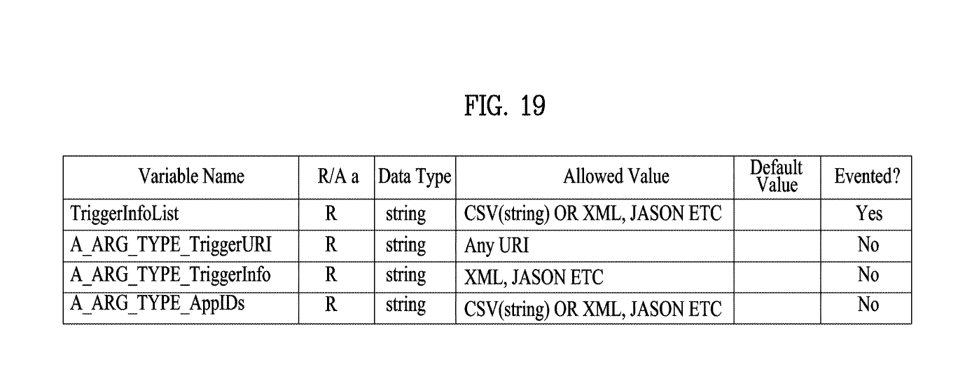

FIG. 19 is a diagram illustrating trigger transmission information according to an embodiment of the present invention.

The trigger list information may include an application identifier (AppID). The application identifier may be included in application attribute related information (e.g., TPT or triggering application information) to be received by the first receiver through the broadcast network and/or the Internet. The application identifier information may identify a specific application that is currently executed or to be executed by the second receiver.

In this case, the trigger transmission information may include at least one of trigger list information, trigger position information, trigger information, and/or application identifier. The trigger transmission information may be included in signaling information and/or application signaling information. The trigger transmission information may be transmitted to the second receiver from the first receiver using an eventing method and/or in response to a request of the second receiver. Alternatively, the trigger transmission information may be transmitted to the first receiver from the second receiver using an eventing method and/or in response to a request of the first receiver.

The trigger list information may include trigger information on at least one trigger for the second receiver (or CD) as a required state variable. According to an embodiment of the present invention, the trigger list information may be referred to as TriggerInfoList variable. The trigger list information may be transmitted to the second receiver from the first receiver using an eventing method and/or in response to a request of the second receiver.

The trigger position information may indicate a position at which the second receiver (or CD) is capable of making a request for trigger information to the transmitter (or content server) as a required state variable. According to an embodiment, the trigger position information may be referred to as A_ARG_TYPE_NotificationInfo variable. The trigger position information may be transmitted to the second receiver from the first receiver in response to a request of the second receiver.

The trigger information may indicate attribute or information on a trigger as a required state variable. According to an embodiment, the trigger information may be referred to as A_ARG_TYPE_TriggerInfo variable. The trigger information may be transmitted to the second receiver from the first receiver in response to a request of the second receiver.

The application identifier list information may indicate a list of an application identifier (or AppID) as a required state variable. According to an embodiment, the application identifier list information may be referred to as A_ARG_TYPE_AppIDs variable. The application identifier list information may be transmitted to the second receiver from the first receiver in response to a request of the second receiver.

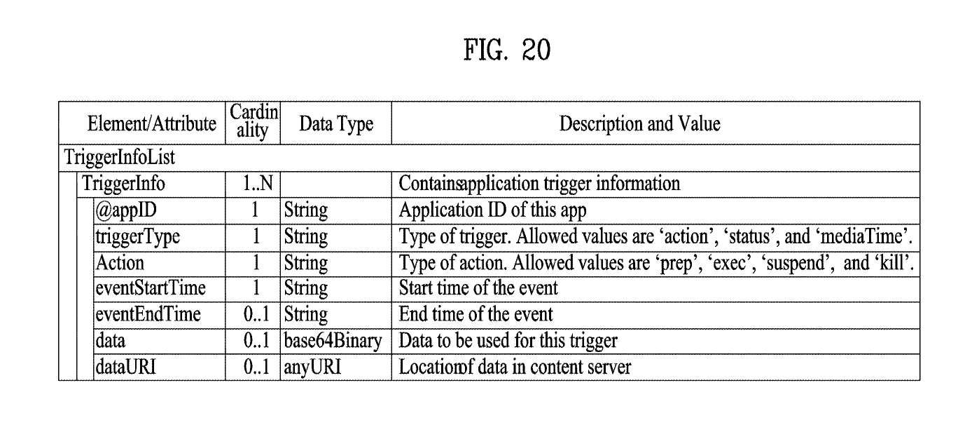

FIG. 20 is a diagram illustrating trigger list information according to an embodiment of the present invention.

The trigger list information may include trigger information on at least one trigger for the second receiver (or CD).

The trigger information may include trigger type information indicating a type of a trigger for triggering an application, action information indicating an operation of a triggered application, event start time information indicating time at which a trigger for the second receiver (or CD) is started, event termination time information indicating time at which a trigger for the second receiver (or CD) is terminated, data information indicating trigger related data for the second receiver (or CD), and/or data position information indicating a position in the content server of trigger related data for the second receiver (or CD).

The trigger information may further include an application identifier for identifying an application. The application identifier may be referred to as appID attribute.

The first receiver may transmit signaling information of an application executed by the first receiver and/or an action for the application to the second receiver.

When the trigger information includes an application identifier, the first receiver may transmit the signaling information on execution of an application with another application identifier to be executed in the future and/or an action of the application as well as the currently executed application and/or an action of the application, to the second receiver.

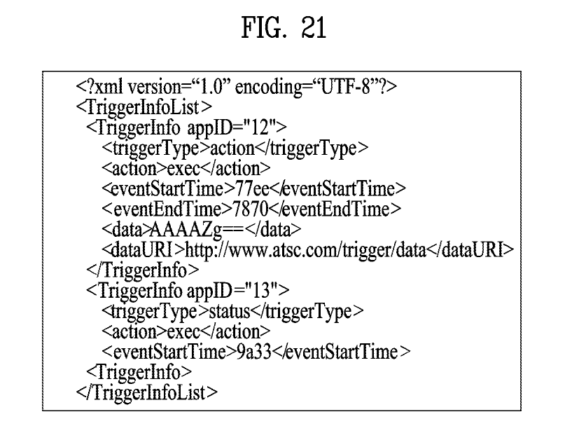

FIG. 21 is a diagram illustrating trigger list information of XML data format according to an embodiment of the present invention.

Referring to the drawing, the trigger list information may include first trigger information and/or second trigger information.

The first trigger information may include at least one of application identifier, trigger type information, action information, event start time information, event termination time information, data information, and/or data position information. The application identifier may indicate “12”. The trigger type information may indicate “action”. The action information may indicate “exec”. The event start time information may indicate “77ee”. The event termination time information may indicate 7870”. The data information may indicate “AAAAZg==”. The data switching information may indicate “http://www.atsc.com/trigger/data”.

The second trigger information may include at least one of application identifier, trigger type information, action information, and/or event start time information. The application identifier may indicate “13”. The trigger type information may indicate “status”. The action information may indicate “kill”. The event start time information may indicate “9a33”.

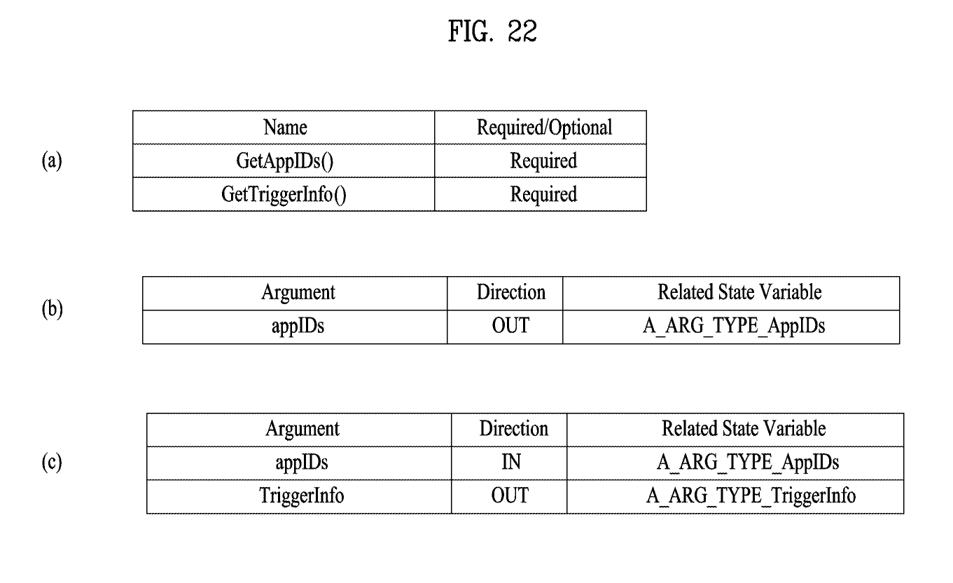

FIG. 22 is a diagram illustrating trigger transmission information according to an embodiment of the present invention.

(a) of the drawing illustrates trigger transmission information. The trigger transmission information may include trigger list information and/or trigger position information. The trigger transmission information may be transmitted to the second receiver from the first receiver in response to a request of the second receiver.

The second receiver may make a request for application identifier list information to the first receiver [symbol] application identifier list information. Information for requesting application identifier list information to the first receiver by the second receiver may be referred to as GetAppIDs( ). For example, the GetAppIDs( ) may be a required action. The GetAppIDs( ) may be used to acquire an application identifier list included in trigger information by the second receiver after the second receiver is connected to the first receiver. The trigger information may be received through a broadcast network and/or the Internet by the first receiver.

The second receiver may make a request for trigger information to the first receiver. Information for requesting trigger information to the first receiver by the second receiver may be referred to as GetTriggerInfo( ). For example, the GetTriggerInfo( ) may be a required action. The GetTriggerInfo( ) may be used to acquire trigger information on a specific application after the second receiver is connected to the first receiver.

(b) of the drawing illustrates application identifier list information. The first receiver may transmit application identifier list information in response to a request of the second receiver. For example, the second receiver may acquire application identifier list information as a return value of the GetAppIDs action. A state variable related to the application identifier list information may be A_ARG_TYPE_AppIDs.

(c) of the drawing illustrates application identifier list information and/or trigger information. The first receiver may transmit trigger information in response to a request of the second receiver.

The second receiver may use application identifier and/or application identifier list information as input argument in order to acquire information on a desired application. The first receiver may transmit a return value thereof as TriggerInfo argument.

For example, the second receiver may acquire trigger information as a return value of the GetTriggerInfo action. A state variable related to application identifier list information may be appIDs. A state variable related to trigger information may be A_ARG_TYPE_TriggerInfo.

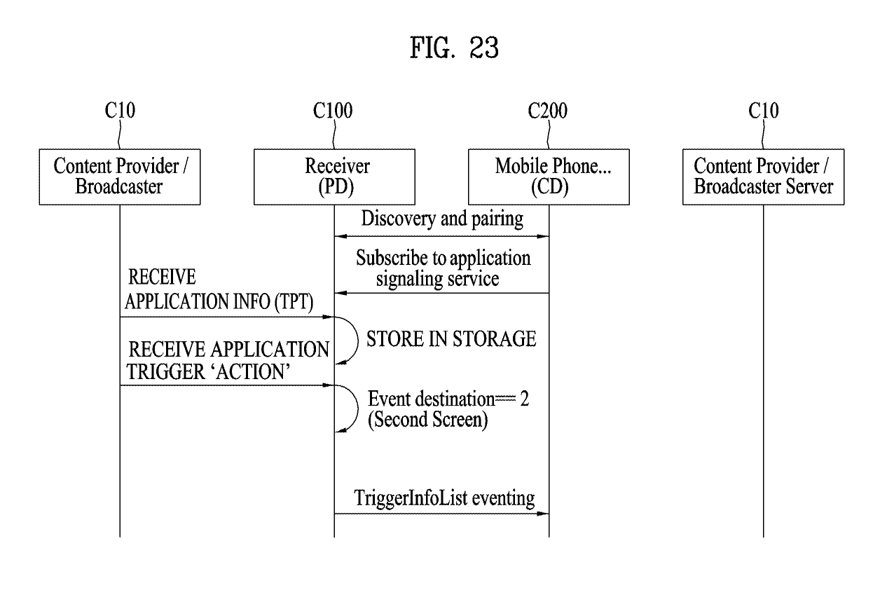

FIG. 23 is a flow diagram when trigger type information indicates “action” according to an embodiment of the present invention.

Referring to the drawing, a transceiving system according to an embodiment of the present invention may include at least one of the transmitter C10, the first receiver C100, and/or the second receiver C200.

The transmitter C10 may provide a broadcast service. For example, the broadcast service may include at least one of content (or linear service), an application (or non-linear service), and/or signaling information. The transmitter C10 may include at least one of the aforementioned broadcast transmitting apparatus (not shown), a content provider (not shown), a content server (not shown), a controller (not shown), and/or a transmitter (not shown).

The first receiver C100 may receive the broadcast service through a broadcast network and/or the Internet. The first receiver C100 may be referred to as a TV receiver and/or PD.

The second receiver C200 may receive the broadcast service through the Internet. The second receiver may be referred to as a mobile phone and/or a CD.

Hereinafter, an operation of a transceiving system according to an embodiment of the present invention when the trigger type information indicates “action” will be described.

The first receiver C100 may perform a discovery and/or pairing operation with respect to the second receiver C200. For example, the first receiver C100 may discover the second receiver and may be electrically connected to the second receiver so as to transmit and receive data.

Then, the first receiver C100 may subscribe an application signaling service of the second receiver C200. The second receiver C200 may subscribe the application signaling service of the first receiver C100. For example, the first receiver C100 may subscribe an app transceiver of the second receiver C200 using the app transceiver of the first receiver C100.

Then, the first receiver C100 may receive a broadcast signal from the transmitter C10. The first receiver C100 may acquire signaling information based on the broadcast signal. In detail, the first receiver C100 may acquire application signaling information based on the signaling information. As described above, the first receiver C100 may acquire application signaling information based on an MPEG-DASH protocol and/or an MMT protocol. The application signaling information may include at least one of a trigger for triggering an operation of an application and triggering application information (or TPT) for signaling information on a triggered application.

Then, the first receiver C100 may store the received signaling information in storage. For example, the first receiver C100 may store the received triggering application information in the storage.

Then, the first receiver C100 may further receive signaling information from the transmitter C10. The signaling information may include a trigger. For example, the trigger may include a trigger that is transmitted to the second receiver from the first receiver or is to be processed by the second receiver.

The trigger may include at least one of an application identifier for identifying a triggered application, a triggering event identifier for identifying a triggering event, and/or a data identifier for identifying data required by a triggering event. The trigger may include at least one of trigger type information indicating a type of a trigger for triggering an application, action information indicating an operation of the triggered application, start time of a triggering event, termination time of a triggering event, and/or data information including trigger related data.

According to an embodiment, when the trigger type information indicates “action”, the trigger type information may indicate a trigger for signaling an operation of an application.

Then, the first receiver C100 may perform an action of signaling information. The first receiver C100 may transmit signaling information to the second receiver C200. For example, the first receiver may transmit trigger transmission information for acquiring a trigger by the second receiver based on signaling information to the second receiver. For example, the first receiver C100 may transmit the trigger list information to the second receiver C200. That is, the first receiver C100 may transmit the trigger list information to the second receiver C200 using an eventing method. Transmission of the trigger list information using an eventing method may indicate occurrence of an event for transmitting the trigger list information to the second receiver by the first receiver.

Hereinafter, an operation for transmitting trigger list information by the first receiver C100 will be described in detail.

The first receiver C100 may parse a trigger based on signaling information. The first receiver C100 may parse an application identifier (or appID) in the received trigger, an event identifier (or eventID), and/or a data identifier (or dataID).

Then, the first receiver C100 may check a target device. For example, the first receiver C100 may check event information included in the triggering application information based on the trigger information in the trigger. The first receiver C100 may search for a corresponding application and/or event based on the application identifier and/or the event identifier and check whether a destination of an event indicates the second receiver. For example, when the destination indicates “2”, the destination of the event may indicate the second receiver (or second screen).

Then, the first receiver C100 may transmit trigger list information (or TriggerInfoList information) including information on the received trigger to the second receiver C200 using an eventing method. When the trigger type information indicates “action”, a tape may be included in an event. When the destination of the event is “second receiver” and data is included in the event, the first receiver C100 may notify the second receiver C200 of the trigger list information (or TriggerInfoList information) using an eventing method. For example, when the destination of the event is ‘2’ and data is included in the event, the first receiver C100 may generate an event of transmitting the trigger list information to the second receiver.

The second receiver C200 may receive signaling information from the first receiver C100. For example, the second receiver C200 may receive trigger list information including information on a trigger. For example, the trigger may be a trigger for executing (or exec) contained data, up to “7870” starting from “77ee” based on media time. The second receiver C200 may execute an application based on the trigger included in the trigger list information.

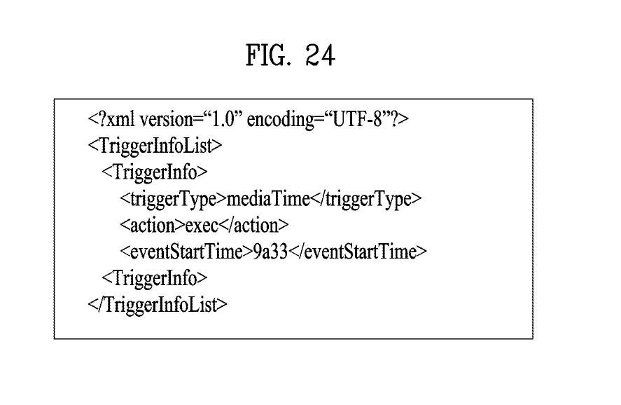

FIG. 24 illustrates XML format of TriggerInfoList when trigger type information indicates “action” according to an embodiment of the present invention.

Referring to the drawing, the trigger list information (or TriggerInfoList) may include trigger information. The trigger information may include at least one of trigger type information, action information, event start time information, event termination time information, and/or data information.

According to an embodiment, the trigger type information (or triggerType) may indicate “action”. The action information (or action) may indicate “exec”. The event start time information (or eventStartTime) may indicate “77ee”. The event termination time information (or eventEndTime) may indicate “7870”. The data information may indicate “AAAAZg==”.

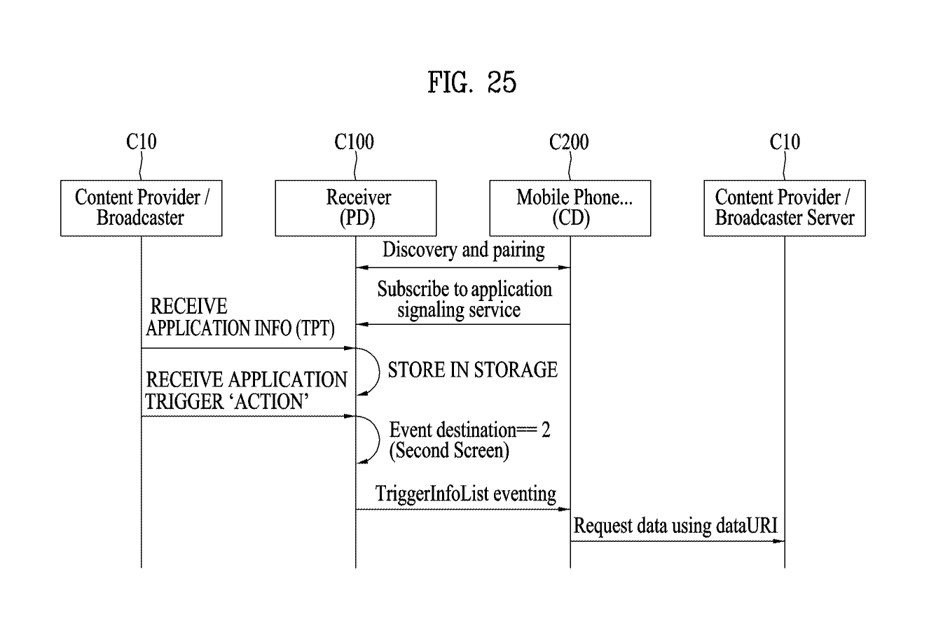

FIG. 25 is a flow diagram when trigger type information indicates “action” according to an embodiment of the present invention.

Referring to the drawing, a transceiving system according to an embodiment of the present invention may include at least one of the transmitter C10, the first receiver C100, and/or the second receiver C200. A description of the transceiving system according to an embodiment of the present invention may include the entire above description of the aforementioned transceiving system.

The signaling information according to an embodiment of the present invention may include a trigger. The trigger may include at least one of an application identifier for identifying a triggered application, a triggering event identifier for identifying a triggering event, and/or a data identifier for identifying data required by the triggering event. In addition, the trigger may further include trigger type information indicating a type of a trigger for triggering an application, action information indicating an action of the triggered application, start time of a triggering event, termination time of a triggering event, data information including trigger related data, and/or data position information indicating a position in a content server of data information. According to an embodiment, the data position information may be referred to as dataURI.

The first receiver C100 may transmit trigger list information including information on the received trigger to the second receiver C200. For example, the first receiver C100 may transmit trigger list information to the second receiver C200 using an eventing method.

The second receiver C200 may receive signaling information from the first receiver C100. For example, the second receiver C200 may receive trigger list information including information on a trigger. For example, the trigger may be a trigger for executing (or exec) of contained data, up to “7870” starting from “77ee” based on media time.

The second receiver C200 may execute an application based on the trigger included in the trigger list information and/or data information received from a content server. In this case, the second receiver C200 may make a request for data information including trigger related data to the transmitter C10 based on data position information (or dataURI). A routine for requesting data to a content server based on the data position information by the second receiver C200 may be changed according to a mechanism of embodying the second receiver C200.

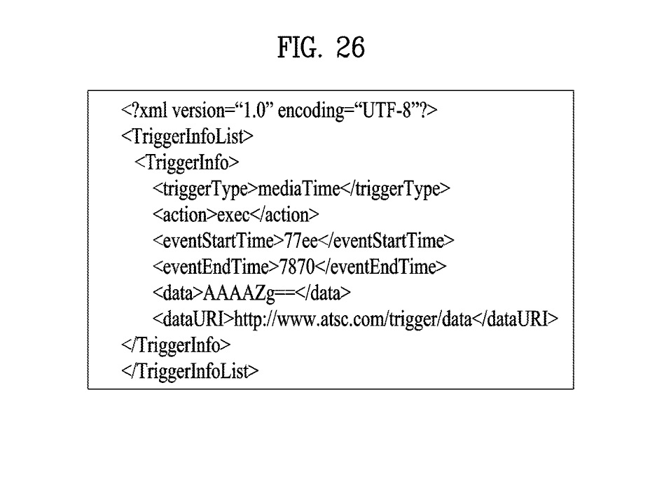

FIG. 26 illustrates XML format of TriggerInfoList when trigger type information indicates “action” according to an embodiment of the present invention.

Referring to the drawing, the trigger list information (or TriggerInfoList) may include trigger information. The trigger information may include at least one of trigger type information, action information, event start time information, event termination time information, data information, and/or data position information.

According to an embodiment, the trigger type information (or triggerType) may indicate “action”. The action information (or action) may indicate “exec”. The event start time information (or eventStartTime) may indicate “77ee”. The event termination time information (or eventEndTime) may indicate “7870”. The data information may indicate “AAAAZg==”. The data position information (or dataURI) may indicate http://www.atsc.com/trigger/data.

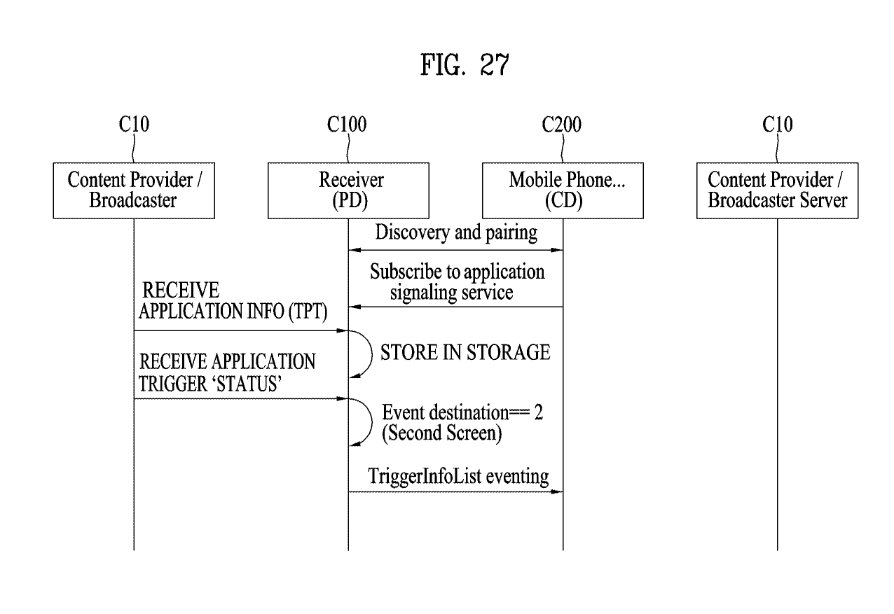

FIG. 27 is a flow diagram when trigger type information indicates “status” according to an embodiment of the present invention.

Referring to the drawing, a transceiving system according to an embodiment of the present invention may include at least one of the transmitter C10, the first receiver C100, and/or the second receiver C200.

A description of the transceiving system according to an embodiment of the present invention may include entire aforementioned transceiving system.

According to an embodiment, the first receiver C100 may receive a trigger including trigger type information (or application trigger type) indicating “status”. When the trigger type information indicates “status”, the trigger type information may indicate a trigger for signaling a status (or lifecycle) of an application. When the trigger type information indicates “status”, the triggering application information may signal change in lifecycle of an application. The status of the application may include at least one of preparing, execution, termination, and/or suspending.

Hereinafter, an operation for transmitting trigger list information by the first receiver C100 when the trigger type information indicates “status” will be described in detail.

The first receiver C100 may parse a trigger based on the signaling information. The first receiver C100 may parse at least one of an application identifier (or appID), an event identifier (or eventID), and/or a data identifier (or dataID) in the received trigger.

Then, the first receiver C100 may check a target device. For example, the first receiver C100 may check event information included in triggering application information based on the trigger information in the trigger. The first receiver C100 may search for a corresponding application and/or event based on the application identifier and/or the event identifier and check whether a destination of the event indicates the second receiver. For example, when the destination indicates “2”, the destination of the event may indicate the second receiver (or second screen).

Then, the first receiver C100 may transmit trigger list information (or TriggerInfoList information) including information on the received trigger to the second receiver C200 using an eventing method. When the destination of the event is “second receiver”, the first receiver C100 may notify the second receiver C200 of the trigger list information (or TriggerInfoList information) using an eventing method. For example, when the destination of the event is ‘2’, the first receiver C100 may generate an event for transmitting the trigger list information to the second receiver.

The second receiver C200 may receive signaling information from the first receiver C100. For example, the second receiver C200 may receive trigger list information including information on a trigger. For example, the trigger may be a trigger for terminating (or killing) an application being executed by the second receiver C200 to “9a33” based on media time. The second receiver C200 may perform an application based on the trigger included in the trigger list information.

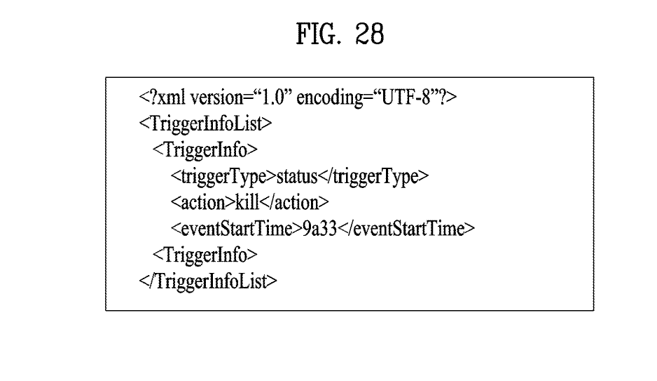

FIG. 28 is a diagram illustrating XML format of TriggerInfoList when trigger type information indicates “status” according to an embodiment of the present invention.

Referring to the drawing, the trigger list information (or TriggerInfoList) may include trigger information. The trigger information may include at least one of trigger type information, action information, and/or event start time information.

According to an embodiment of the present invention, the trigger type information (or triggerType) may indicate “status”. The action information (or action) may indicate “kill”. The event start time information (or eventStartTime) may indicate “9a33”.

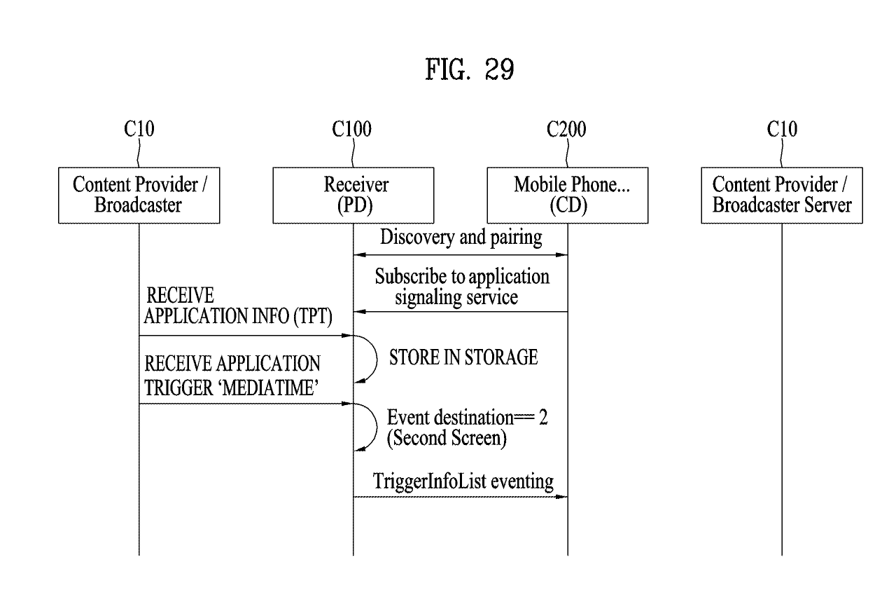

FIG. 29 is a flow diagram when trigger type information indicates “mediaTime” according to an embodiment of the present invention.

Referring to the drawing, a transceiving system according to an embodiment of the present invention may include at least one of the transmitter C10, the first receiver C100, and/or the second receiver C200. A description of the transceiving system according to an embodiment of the present invention may include the entire description of the aforementioned transceiving system.

According to an embodiment, the first receiver C100 may receive a trigger including trigger type information (or application trigger type) indicating “mediaTime”. When the trigger type information indicates “mediatime”, the trigger type information may indicate a trigger for signaling media time. When the trigger type information indicates “mediaTime”, the triggering application information may include media time.

Hereinafter, an operation for transmitting trigger list information by the first receiver C100 when trigger type information indicates “mediaTime” will be described in detail.

The first receiver C100 may parse a trigger based on signaling information. The first receiver C100 may parse at least one of an application identifier (or appID), an event identifier (or eventID), and/or a data identifier (or dataID) in the received trigger.

Then, the first receiver C100 may acquire a target device. For example, the first receiver C100 may check event information included in the triggering application information based on the trigger information in the trigger. The first receiver C100 may search for a corresponding application and/or event based on the application identifier and/or the event identifier and check whether a destination of an event indicates the second receiver. For example, when the destination indicates “2”, the destination of the event may indicate the second receiver (or second screen).

Then, the first receiver C100 may transmit trigger list information (or TriggerInfoList information) including information on the received trigger to the second receiver C200 using an eventing method. When the destination of the event is “second receiver”, the first receiver C100 may notify the second receiver C200 of the trigger list information (or TriggerInfoList information) using an eventing method. For example, when the destination of the event is ‘2’, the first receiver C100 may generate an event for generating the trigger list information to the second receiver.

The second receiver C200 may receive the signaling information from the first receiver C100. For example, the second receiver C200 may receive trigger list information including information on the trigger. For example, the trigger may be a trigger indicating that current media time is “9a33” to the second receiver C200. When the trigger type information indicates “mediaTime”, the second receiver C200 may omit processing of action information. The second receiver C200 may perform an application based on the trigger included in the trigger list information.

FIG. 30 is a diagram illustrating XML format of TriggerInfoList when trigger type information indicates “mediaTime” according to an embodiment of the present invention.

Referring to the drawing, the trigger list information (or TriggerInfoList) may include trigger information. The trigger information may include at least one of trigger type information, action information and/or event start time information.

According to an embodiment, the trigger type information (or triggerType) may indicate “mediaType”. The action information (or action) may indicate “exec”. The event start time information (or eventStartTime) may indicate “9a33”.

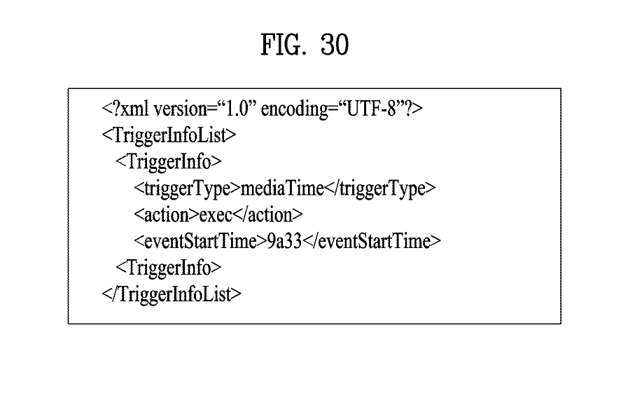

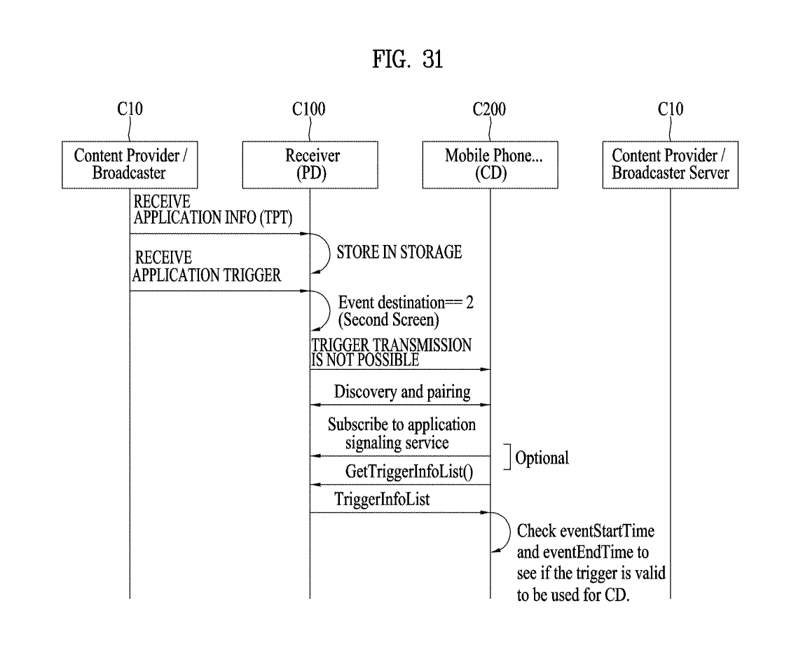

FIG. 31 is a flow diagram when a first receiver and a second receiver are not paired with each other according to an embodiment of the present invention.

Referring to the drawing, a transceiving system according to an embodiment of the present invention may include at least one of the transmitter C10, the first receiver C100, and/or the second receiver C200. A description of the transceiving system according to an embodiment of the present invention may include the entire description of the aforementioned transceiving system.

According to an embodiment of the present invention, the first receiver C100 and the second receiver C200 may not be pared with each other. Hereinafter, a flow diagram of the case in which the first receiver C100 is not paired with the second receiver C200 prior to reception of a trigger will be described.

The first receiver C100 may receive a broadcast signal from the transmitter C10. The first receiver C100 may acquire signaling information based on the broadcast signal. In detail, the first receiver C100 may acquire application signaling information based on the signaling information. As described above, the first receiver C100 may acquire the application signaling information based on the MPEG-DASH protocol and/or the MMT protocol. The application signaling information may include at least one of a trigger for triggering an action of an application and triggering application information (or TPT) for signaling information on a triggered application.

Then, the first receiver C100 may store the received signaling information in storage. For example, the first receiver C100 may store the received triggering application information (or TPT) in the storage.

Then, the first receiver C100 may further receive the signaling information from the transmitter C10. The signaling information may include a trigger. For example, the trigger may include a trigger that is transmitted to the second receiver from the first receiver or is processed by the second receiver.

However, the first receiver C100 may not be connected to the second receiver C200. Accordingly, even if a destination of an event indicates “2”, the first receiver C100 may not transmit the signaling information and/the trigger to the second receiver.

Then, the first receiver C100 may perform a discovery and/or pairing operation with respect to the second receiver C200. For example, the first receiver C100 may discover the second receiver and may be electrically connected to the second receiver so as to transmit and receive data.

Then, the second receiver C200 may subscribe an application signaling service of the first receiver C100. The first receiver C100 may subscribe an application signaling service of the second receiver C200. For example, the second receiver C200 may subscribe an app transceiver of the first receiver C100 using an app transceiver of the second receiver C200. The second receiver may make a request for trigger list information to the first receiver using GetTriggerInfoList action and, thus, it may not be necessary to subscribe the application signaling service of the first receiver.

Then, the first receiver C100 may receive a request for the trigger list information from the second receiver and transmit trigger list information including information on a trigger to the second receiver.

The second receiver C200 may check whether a trigger for the second receiver C200 is present among triggers received by the first receiver C100 using GetTriggerInfoList action. For example, the second receiver C200 may make a request for trigger list information (or TriggerInfoList) including information on a trigger for the second receiver C200 to the first receiver C100 and receive the trigger list information (or TriggerInfoList) from the first receiver C100.

Then, the second receiver C200 may check whether a trigger to be executed based on a current time point is present using the received trigger list information (or TriggerInfoList information). For example, the second receiver C200 may recognize whether an action to be currently performed based on at least one of trigger type information, event start time information, and/or event termination time information of the received trigger.

Then, the second receiver C200 may perform an action based on the trigger. For example, the second receiver C200 may execute an application based on the trigger included in the trigger list information.

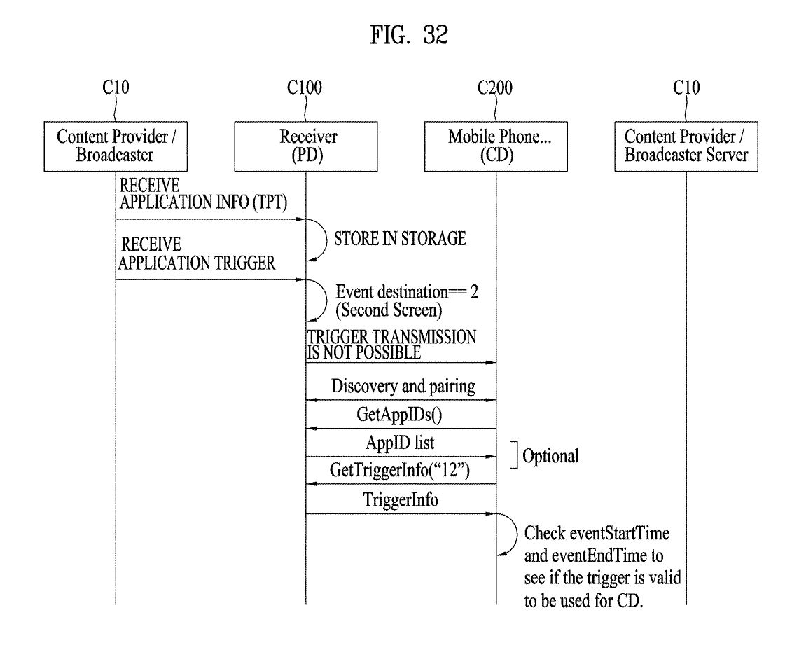

FIG. 32 is a flow diagram of the case in which the first receiver and the second receiver are not paired according to an embodiment of the present invention.

Referring to the drawing, a transceiving system according to an embodiment of the present invention may include at least one of the transmitter C10, the first receiver C100, and/or the second receiver C200. A description of the transceiving system according to an embodiment of the present invention may include the entire above description of the aforementioned transceiving system.

According to an embodiment of the present invention, the first receiver C100 and the second receiver C200 may not be paired with each other. Hereinafter, a flow diagram using an application identifier when the first receiver C100 is not paired with the second receiver C200 prior to reception of a trigger will be described.

The first receiver C100 may receive a request for application identifier list information from the second receiver and transmit the application identifier list information to the second receiver. The application identifier list information may indicate a list of the application identifier (or AppID) as a required state variable. For example, the application identifier list information may be referred to as A_ARG_TYPE_AppIDs variable. The application identifier list information may be transmitted to the second receiver from the first receiver in response to a request of the second receiver.

Then, the first receiver C100 may receive a request for trigger information from the second receiver and transmit the trigger information to the second receiver. For example, the first receiver C100 may receive trigger information on a specific application based on the application identifier list information from the second receiver C200 and transmit trigger information to the second receiver.

The second receiver C200 may make a request for application identifier list information to the first receiver C100 and receive application identifier list information in response thereto. For example, the second receiver C200 may acquire application identifiers corresponding to a trigger for the second receiver C200 among triggered received by the first receiver C100 using GetAppID action.

Then, the second receiver may make a request for trigger information to the first receiver C100 and receive trigger information in response to the trigger information. For example, the second receiver C200 may acquire whether a trigger for the second receiver C200 is present among triggers received by the first receiver C100 using GetTriggerInfo action. In this case, in order to acquire trigger information (or TriggerInfo information) of a specific application, the second receiver C200 may use application identifier information as input argument. For example, the second receiver C200 may make a request for trigger information on a corresponding application based on the application identifier indicating “12” and receive trigger information in response thereto.

Then, the second receiver C200 may check whether a trigger to be executed based on a current time point is present using trigger information. For example, the second receiver C200 may recognize whether an action to be currently performed using triggerType, eventStartTime, and/or eventEndTime information of the received trigger.

Then, the second receiver C200 may perform an action based on the trigger. For example, the second receiver C200 may perform an application based on the trigger.

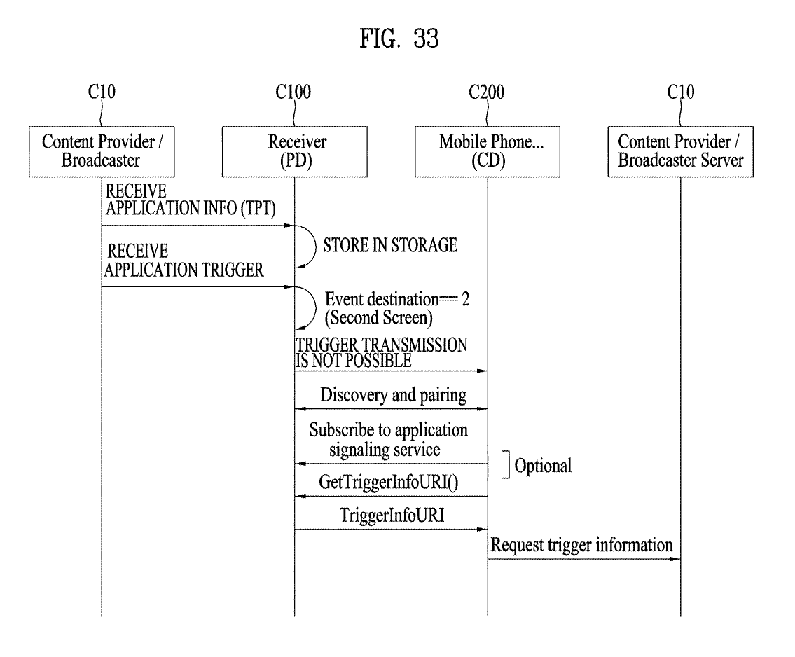

FIG. 33 is a flow diagram of reception of triggering application information by a second receiver from a transmitter according to an embodiment of the present invention.

Referring to the drawing, a transceiving system according to an embodiment of the present invention may include at least one of the transmitter C10, the first receiver C100, and/or the second receiver C200. A description of the transceiving system according to an embodiment of the present invention may include the entire above description of the aforementioned transceiving system.

According to an embodiment of the present invention, the first receiver C100 and the second receiver C200 may not be paired with each other. Hereinafter, a flow diagram of the case in which the first receiver C100 is not paired with the second receiver C200 prior to reception of a trigger will be described.

Then, the second receiver C200 may subscribe an application signaling service of the first receiver C100. The first receiver C100 may subscribe an application signaling service of the second receiver C200. For example, the second receiver C200 may subscribe an app transceiver of the first receiver C100 using an app transceiver of the second receiver C200. The second receiver is capable of making a request for trigger position information to the first receiver using GetTriggerInfoURI action and, thus, it may not be necessary to subscribe the application signaling service of the first receiver.

Then, the first receiver C100 may receive a request for trigger position information indicating a position of a trigger from the second receiver and transmit the trigger position information to the second receiver.

The second receiver C200 may check whether trigger position information for the second receiver C200 is present among trigger position information received by the first receiver C100 using the GetTriggerInfoURI action. For example, the second receiver C200 may make a request for trigger position information (or TriggerInfoURI) to the first receiver C100 and receive the trigger position information (or TriggerInfoURI) from the first receiver C100.

The second receiver C200 may check a trigger to be executed based on a current time point using the received trigger position information (or TriggerInfoURI). For example, the second receiver C200 may recognize whether an operation to be currently performed is present based on at least one of trigger type information, event start time information, and/or event termination time information of the received trigger.

The second receiver C200 may acquire all triggers (or application trigger information) for the second receiver C200 from the transmitter C10 (or content server). The second receiver C200 may recognize whether an operation to be currently performed is present based on at least one of trigger type information, event start time information, and/or event termination time information of the received trigger and pre-recognize whether an operation to be performed in the future according to media time.

Then, the second receiver C200 may perform an operation based on the trigger. For example, the second receiver C200 may execute an application based on the trigger.

This method may be useful in that the second receiver C200 does not necessarily and continuously receive a trigger for the second receiver C200 from the first receiver C100. In addition, this method may be useful in that data about an event included in a trigger is pre-downloaded so as to reduce data loading time.

Then, the second receiver C200 may transmit trigger information (or TriggerInfo information) from the first receiver C100 using an eventing method. For example, the second receiver C200 may receive a media Time trigger from the first receiver C100 using an eventing method.

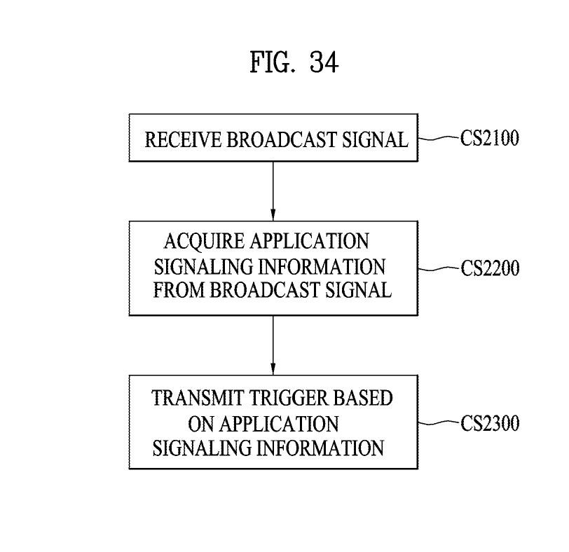

FIG. 34 is a flowchart illustrating an operation of a broadcast receiving apparatus according to an embodiment of the present invention.

A transceiving system according to an embodiment of the present invention may include at least one of a transmitter, a broadcast receiving apparatus (or first receiver), and/or a second screen device (or second receiver). A description of the transceiving system according to an embodiment of the present invention may include the entire above description of the aforementioned transceiving system. Hereinafter, an operation of the broadcast receiving apparatus will be described.

The broadcast receiving apparatus may receive a broadcast signal using a broadcast receiver (CS2100). For example, the broadcast receiving apparatus may receive the broadcast signal using the broadcast receiver and/or the IP transceiver.

The broadcast receiving apparatus may acquire application signaling information for signaling an application included in the broadcast server from the broadcast signal using a controller (CS2200). For example, the broadcast receiving apparatus may acquire signaling information from the broadcast signal using the controller and acquire application signaling information from the signaling information.

The broadcast receiving apparatus may acquire application signaling information based on an MPEG-DASH protocol and/or an MMT protocol.

The application signaling information may include at least one of a trigger, trigger position information, and triggering application information. The trigger may trigger an operation of an application. For example, the trigger may perform a timing related signaling operation for supporting an interactive service. The trigger position information may indicate a position of the trigger. The triggering application information may signal information on the triggered application. For example, the triggering application information may include an application and metadata about an event targeted to the application.

The broadcast receiving apparatus may transmit the trigger to the second screen device based on the application signaling information using the app transceiver (CS2300).

The broadcast receiving apparatus may transmit trigger transmission information for transmitting the trigger to the second screen device using the app transceiver.

The trigger transmission information may include at least one of trigger information indicating attribute for a trigger, trigger list information including at least one trigger information item, trigger position information indicating a position of a trigger, and application identifier list information indicating a list of an application identifier.

The trigger information may include at least one of an application identifier for identifying an application, trigger type information indicating a type of a trigger, action information indicating an operation of an application, event start time information indicating start time of a trigger, event termination time information indicating termination time of a trigger, data information including data related to a trigger, and/or data position information indicating data related to a trigger.

The broadcast receiving apparatus may further transmit application notification information including information on application notification for the second screen device using the app transceiver.

The application notification information may include at least one of targetDevice attribute indicating a device on which application notification is displayed, topMargin attribute indicating top margin of application notification, rightMargin attribute indicating right margin of application notification, show attribute indicating time at which application notification is first displayed, lasting attribute indicating lasting time at which application notification is displayed, interval attribute indicating an interval time between application notifications, a message element indicating a notification message of application notification, and/or a logo element indicating a logo image of application notification.

The broadcast receiving apparatus may transmit the signaling information, the application signaling information, the trigger transmission information, and/or the application notification information to a second screen device based on an event and/or in response to a request of the second screen device. The broadcast receiving apparatus transmits data based on the event and in response to the second screen device, as described above.

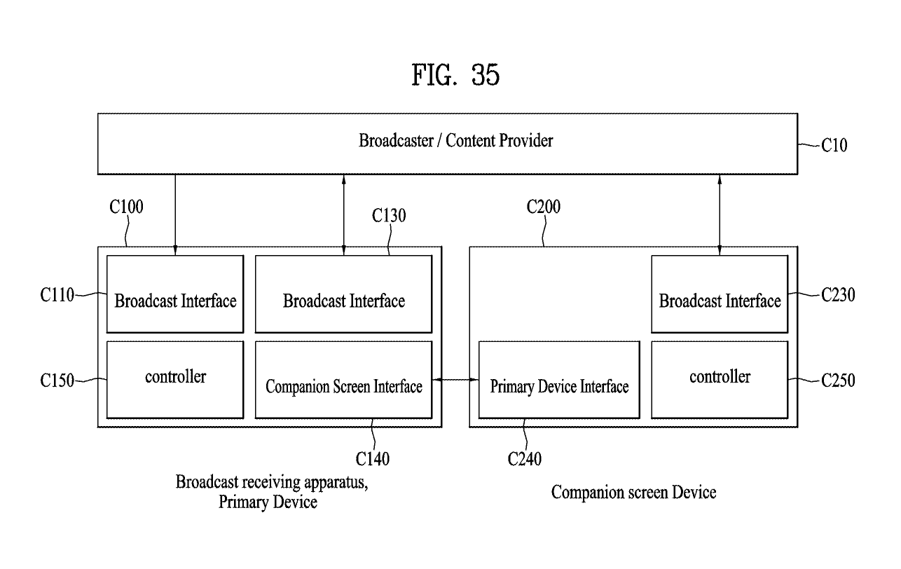

FIG. 35 is a diagram illustrating a structure of a broadcast system according to an embodiment of the present invention.

The broadcast system according to an embodiment of the present invention may include at least one of a broadcaster/content provider C10, a broadcast receiving apparatus C100, and/or a companion screen device C200. The broadcaster/content provider C10 may provide a broadcast service. The broadcaster/content provider C10 may include at least one of the aforementioned broadcast transmitting apparatus (not shown), content provider (not shown), content server (not shown), controller (not shown), and/or transmitter (not shown). The broadcaster/content provider C10 may be represented by a transmitter. The broadcast receiving apparatus C100 may receive a broadcast service through a broadcast network and/or the Internet. The broadcast receiving apparatus C100 may be represented by a receiver, a first receiver, a first screen device, a master device (MD), and/or a primary device (PD). The broadcast receiving apparatus C100 may include at least one of a broadcast interface (or broadcast receiver) C110, a broadband interface (or IP transceiver) C130, a companion screen interface (or app transceiver) C140, a decoder (not shown), a display (not shown), and/or a controller C150. The companion screen device C200 may receive a broadcast service through the Internet. The companion screen device C200 may be represented by a second broadcast receiving apparatus, a second receiver, a second screen device, a slave device (SD), and/or a companion device (CD). The companion screen device C200 may include at least one of a broadband interface (or IP transceiver) C230, a primary device interface (or app transceiver) C240, a decoder (not shown), a display (not shown), and/or a controller C250. A detailed description of the broadcaster/content provider C10, the broadcast receiving apparatus C100, and/or the companion screen device C200 may include the entire above description.

Hereinafter, operations of a PD (or broadcast receiving apparatus) and a CD (companion screen device) will be described.

Operations required for supporting ATSC 3.0 companion device requirements will be described below. Here, there are five types of supported functions.

A first function may use a PD in order to stream continuous components that are some of services that are currently selected by the PD for simultaneous presentation by a CD. Components may be the same as components presented by a PD. Alternatively, the components may be general components that are not currently presented by a PD.

A second function may use a PD in order to deliver data or files that are some of services that are currently selected by the PD to a CD. The data may contain a place or method of accessing content from sources other than the PD. For example, the data may include a URL of a remote server. The CD may make a request for a single particular file or a data package. Alternatively, the CD may make a request for “subscription” of a series of particular files or data.

A third function may use a PD for delivering media timeline information on a service that is currently selected by the PD in order for a CD to synchronize content presented in the CD along with content presented in the PD.

A fourth function may use a CD application that cooperates with a PD application. The PD application may be an enhancement application that is a portion of a scheduled linear service. Alternatively, the PD application may be an application that is a portion of an app-based service or an unscheduled service.

A fifth function may be EAM delivery. That is, the fifth function uses a PD in order to deliver emergency alert messages to a CD. This is particularly important when a CD displays continuous contents. This is because a user (or viewer) may not concentrate on the PD and may not be in the same room as the PD when emergency alert occurs.

Along with a PD that functions as a server, an appropriate paradigm for supporting a CD is expected to be a client-server paradigm. That is, the PD may support certain CD support operations. This may also be applied to the CD. Each interaction may be initiated according to a request to a server (or PD) from a client (or CD) in order to apply a particular operation. Two-way communications may be initiated according to a request to a server (or PD) from a client (or CD) in order to set up communications. Asynchronous notifications to a CD from a PD may be initiated according to a request of a client (or CD) that makes a request for subscription of a stream of notifications to a server (or PD). All messages described below may be unicast unless the context clearly indicates otherwise.

A security mechanism may be required to authenticate CD application requests.

In several operations, a CD may receive a URL in order to retrieve content in a remote server. In this case, in order for the remote server to transmit an appropriate version of requested content to a particular CD, the CD may provide information on the remote server to the remote server. For example, to this end, ATSC 2.0 clearly describes “User Agent” based on HbbTV specifications (Per TS 102 796 Section 7.3.2.4, except replace “HbbTV/1.2.1” with “ATSC-ISS/1.0”).

Hereinafter, device discovery will be described.

Both a PD application and a CD application may transmit multicast discovery messages for searching and/or advertising presence of the PD application and the CD application and ATSC 3.0 service supporting.

One household may have one or more PDs on a home network and, accordingly, a CD application may receive display messages from a plurality of PDs. In this case, the CD application may ask a user a question about PD(s) that interacts with the user (for example, the CD application may display information from discovery messages in order to help user decision).

The CD application may multicast a CD application search request message for searching the PD. For example, when the CD participates in a network or the CD application is initiated, when discovery scan in the CD application is initiated (e.g., when a user wants to access a new or another TV receiver and new scan is initiated), when the CD transmits a multicast request for a device type/service type of the PD, and/or dependently upon execution and periodically, the CD application may multicast a CD app search request message for searching the PD. For example, parameters may include at least one of a device and/or service type CD app is looking for (in order to avoid a response from a DVD player, etc.).

The PD may multicast a PD advertisement message and unicast a search response message. For example, when the PD participates in a network/LAN (advertisement-multicast), when a list of CD supporting operations provided by the PD is changed (advertisement-multicast), dependently upon execution and periodically, (advertisement-multicast), and/or when a multicast search request is received from the CD (search response-unicast), the PD may multicast a PD advertisement message and unicast a search response message. For example, parameters may include at least one of a PD device ID, a PD device type (ATSC 3.0 TV set) and (ATSC 3.0 support) version, a user-friendly name of a PD (e.g., living room TV), supported CD supporting operations, and/or other parameters.

The CD may multicast a CD advertisement message and unicast a search response message. For example, when the CD participates in a network (or when a CD application is initiated) (advertisement-multicast), when a list of CD supporting operations provided by the PD is changed (advertisement-multicast), dependently upon execution and periodically, and/or when a (multicast) search request for a device/service type of the CD is received from the PD (unicast search message response from the CD), the CD may multicast a CD advertisement message and unicast a search response message. For example, parameters may include at least one of a CD device ID, a CD application ID, a CD application version, a name of a CD readable by the human, supported CD services (service types), and/or other parameters.

The PD may multicast a PD search request message for searching the CD. For example, when the PD is initiated/the PD participates in a network, when discovery scan in the PD is initiated (e.g., when a user wants to access a new or another CD and new scan is initiated), whenever the PD transmits a multicast request for a device type/service type of the CD, and/or dependently upon execution and periodically, the PD may multicast a PD search request message for searching the CD. For example, message parameters may include at least one of a retrieved CD device type and/or CD service type. Optionally, message parameters may include PD information (e.g., a PD device ID, a PD application ID, and a PD application version).

Hereinafter, subscription to content identification will be described.

Several CD applications (e.g., “American Idol” companion application) may be designed for only one show. In addition, several CD applications (e.g., WBZ Channel 4 companion application) may be designed for only one service. On the other hand, other CD applications may be designed to be operated with respect to a plurality of services and/or a plurality of shows. In addition, a CD application (e.g., Ford truck application) may be designed to accompany interstitials. Accordingly, the CD application may need to know a service that is currently selected by a PD and need to trace service changes (e.g., channel changes). In a certain case, the CD application may need to know a show or to even know a segment that is currently presented and need to trace changes thereof.

The CD may transmit a content identification subscription request. For example, a time may not be clearly indicated (that is, this may be determined according to an application designer). For example, parameters may include at least one of subscription callback URL/information, and/or requested subscription duration. Optionally, parameters may include a CD device ID, a CD application ID, a CD application version, and so on.

The PD may transmit content identification subscription response. For example, as soon as a subscription request is received (initial response), and/or whenever content is changed (subsequent responses) (i.e., whenever a service, a show, or a segment is changed), the PD may transmit content identification subscription response. For example, parameters may include at least one of a PD device ID, a subscription ID, and/or confirmed subscription duration.

The CD may transmit a content identification subscription renew/cancel request. For example, prior to subscription timeout for renewing subscription and/or at any time for canceling subscription, the CD may transmit a content identification subscription renew/cancel request. For example, parameters may include at least one of subscription ID, and/or requested subscription duration to renew subscription. Optionally, parameters may include CD information (CD device ID), a CD application ID, a CD application version, and so on.

The PD may transmit content identification subscription renew/cancel response. For example, as soon as receiving a subscription renew/cancel request, the PD may transmit the content identification subscription renew/cancel response. For example, parameters may include at least one of a subscription ID, and/or confirmed subscription duration for subscription renewal.

The PD may transmit a content identification message. For example, as soon as a subscription request is received, and/or when identification of current content or related information is changed, the PD may transmit a content identification message. For example, parameters may include at least one of a service ID, a show ID, and/or a segment ID. In addition, the parameters may include a current temporal location within the given show and/or segment. Each service, show, and/or segment may include available information, available continuous components, and/or available files and data. With respect to the available information, parameters may include at least one of a textual name, description, logo, and/or other ESG info (rating, etc.). With respect to each component of the available continuous components, parameters may include at least one of a component ID, a component type, a component name, component description, component attributes (e.g., bit rate, aspect ratio, device capabilities required/desired, etc.), a component filtering criterion (e.g., targeted to certain demographic profiles), and/or a location of each component (e.g., URLs or IP address, port, and protocol) (the location may indicate a stream from the PD or a stream directly from the Internet). With respect to the each file or data element of the available files or data, parameters may include at least one of a file ID/data ID, a file type/data type, a file name/data name, file description/data description, file attributes/data attributes (e.g., size, codec, device capabilities require/desired, etc.), available as subscription or one-off or both, a component filtering criterion (e.g., component filtering criterion targeted to certain demographic profiles), and/or a location for assessing data and/or files (e.g., a location for assessing data and/or files from the PD, a location for assessing data and/or files from a remote server from a certain URL, etc.).

The CD may transmit response to the content identification message. For example, upon receiving the content identification message from the PD, the CD may transmit response to the content identification message. For example, parameters may include a CD device ID or a CD application ID.

Hereinafter, a ESG-type information request for the current service or show will be described.

According to the information, the CD may make a request for information on content in a TV. For example, the information may include information contained in ESG such as a textual name, description, a logo, and rating. According to the information, the CD application may display information readable by the human to a user. For example, the CD application may display “You are watching [Show] starring [actor].”.

The CD may transmit a service/show information request. For example, a time may not be clearly indicated. That is, according to decision of an application designer, the CD may transmit a service/show information request. For example, parameters may include CD information (e.g., CD device ID, CD application ID, CD application version, etc.).

The PD may transmit service/show information response. For example, as soon as receiving a CD request, the PD may transmit service/show information response. For example, parameters may include at least one of a service ID and show ID, and/or service ESG information and show ESG information. Optionally, a parameter may include PD information (e.g., PD device ID, etc.).

Hereinafter, a request for current information about a current service, show or segment without subscription will be described.

In addition to subscription based approach and a follow-on request, the CD may directly obtain information on a service/show/segment that is currently presented by the PD using communication of a single transaction request-response style directed to the PD from the CD as follows without first subscription of service identification.

The CD may transmit a CD request to PD to receive current service information. For example, whenever a CD request is needed by an application, the CD may transmit the CD request to PD to receive current service information. For example, parameters may include at least one of information for making a request for current show ESG information, information for making a request for current available components of a current show, information for making a request for a current timeline location in a current show, information for making a request for current available files of a current show or non real-time content, and/or information for making a request for a filtering criterion (e.g., component attributes). Optionally, parameters may include CD information (CD device ID, CD application ID, a CD application version, etc.).

The PD may transmit PD current service information response. For example, as soon as receiving a current service information request, the PD may transmit PD current service information response. For example, parameters may include current show ESG information, information about current available components for the current show, a current timeline location with the current show, information about current available files or non real-time content for the current show, and/or a filtering criterion. Optionally, parameters may include PD information (e.g., PD device ID emd).

Hereinafter, a request for a continuous component from a PD will be described.

When PD service information response includes an access location and availability of continuous components streaming from the PD, the CD may request reception of the stream (Continuous components are available from a remote server through a broadband (or the Internet) but a detailed description thereof will be omitted.).

The CD may transmit a continuous component request. For example, a time may not be clearly indicated. That is, according to an application designer, the CD may transmit a continuous component request. For example, parameters may include a component ID. Optionally, parameters may include CD information (CD device ID), CD application ID, a CD application version, and so on.

The PD may transmit continuous component request response. For example, as soon as receiving a valid CD application request, the PD may transmit the continuous component request response. For example, parameters may include a component ID, and/or an access location of a component. Optionally, parameters may include PD information (e.g., PD device ID, etc.).

After obtaining the access location (e.g., URL) of a component, the CD may pull content using a HTTP GET method without clearly indicating new content. In addition, a stream is not “pushed” by the PD and is “pulled” by the CD (i.e., streaming is controlled by the CD) and, thus, it may not be necessary to define message protocols (e.g., “Start” or “End”) between the PD and the CD in order to control a stream.

Hereinafter, a request for a data/file from a PD will be described.

When PD service information response includes availability of data or file components accessible from the PD, the CD may request reception of component(s) (data/file components are available from a remote server through a broadband but a detailed description thereof will be omitted.).

The CD may transmit a data/file request. For example, a time may not be clearly indicated. That is, according to decision of an application designer, the CD may transmit the data/file request. For example, a time may not be clearly indicated. For example, parameters may include data/file ID(s) for item(s) to be received by the CD application. When subscription is optional, whether subscription is appropriate may be clearly indicated. When subscription is appropriate, start or stop for receiving subscription may be clearly indicated. Optionally, parameters may include CD information (CD device ID, CD application ID, CD application version, etc.).

The PD may transmit data/file request response. For example, as soon as receiving a CD application request, the PD may transmit data/file request response. In addition, when there is a subscription request, the PD may transmit supplementary data/files according to notifications present in a broadcast stream. For example, parameters may include at least one of an access location of the data/file and/or data/file ID(s) of requested item(s). Optionally, parameters may include PD information (e.g., PD device ID, etc.).

Hereinafter, a request for media timeline checkpoints will be described.

When the CD accesses supplementary content directly from the PD or through another source (e.g., remote server), the CD may require on-going media timeline information from the PD in order to maintain sync between content displayed by the CD and content displayed by the PD.

Subscription based approach as well as single request response approach may be supported in order to receive timeline checkpoints from the PD. The CD has an accurate internal clock and, thus, request response architecture may permit polling of a timeline in an appropriate interval by the CD in order to maintain synchronization with the PD.

Hereinafter, the subscription based approach will be described.

The CD may transmit a media timeline checkpoints subscription request. For example, a time may not be clearly indicated. That is, according to decision of an application designer, the CD may transmit the media timeline checkpoints subscription request. For example, parameters may include a service/show/segment ID of interest. In addition, parameters may include a notification frequency. The notification frequency may be a requested frequency that does not exceed a clearly indicated maximum frequency and may be a requested frequency (e.g., frequency that does not exceed every two seconds) for receiving temporal updates. When the notification frequency is not clearly indicated, a receiver may determine a frequency. In addition, the receiver may set a default value to be determined. Parameters may include at least one of subscription callback URL/information, and/or requested subscription duration. Optionally, parameters may include CD information (CD device ID, CD application ID, CD application version, etc.).

The PD may transmit media timeline checkpoints subscription response. For example, when a request is received from a CD application (initial response), and/or according to a confirmed notification frequency (subsequent responses), the PD may transmit media timeline checkpoints subscription response. For example, parameters may include at least one of a PD device ID, a service/show/segment ID of interest, a subscription ID, confirmed subscription duration, and/or a confirmed notification frequency.

The CD may transmit a media timeline checkpoints subscription renew/cancel request. For example, prior to subscription timeout for renewing subscription and/or at any time for canceling subscription, the CD may transmit a media timeline checkpoints subscription renew/cancel request. For example, parameters may include requested subscription duration in order to renew a subscription ID and/or subscription. Optionally, parameters may include CD information (CD device ID, CD application ID, CD application version, etc.).

The PD may transmit media timeline checkpoints subscription renew/cancel response. For example, as soon as receiving a subscription renew/cancel request, the PD may transmit media timeline checkpoints subscription renew/cancel response. For example, parameters may include at least one of a subscription ID, and/or confirmed subscription duration for subscription renew request.

Hereinafter, media playback state information communication will be described.

An operation for transmitting a media playback state to the CD by the PD may be supported. This may be useful to playback a media stream when the CD synchronizes with the PD.

The CD may transmit the CD subscription request to the PD to receive current media playback state information. For example, whenever a CD subscription request is needed by an application, the CD may transmit the CD subscription request to the PD to receive current media playback state information. For example, parameters may include a URL/ID for which media playback state is requested, media state subscription callback URL/information, and/or requested subscription duration. Optionally, parameters may include CD information (CD device ID, CD application ID, CD application version, etc.).

The PD may transmit PD media callback state subscription response. For example, as soon as receiving a current media playback state subscription information request, the PD may transmit the PD media callback state subscription response. For example, parameters may include at least one of a PD device ID, a media playback state subscription ID, and/or confirmed subscription duration.

The PD may transmit a media playback state PD notification to the CD. For example, when a media playback state is changed in the PD or periodically, the PD may transmit the media playback state PD notification to the CD. For example, notification parameters may include current media playback state information on a requested URL/ID. For example, the state may include at least one of playing, paused, stopped, fast forward; speed of fast forward, fast backward; speed of fast backward, and buffering.

Hereinafter, PD application to CD application communication will be described.

In some cases, the PD application and the CD application may be designed to operate in tandem. In this case, an application designer may be expected to determine detailed content of app-to-app communication. PD applications and CD applications may include information on a user of the other applications and include methods of downloading and launching the other applications. Even if the CD application is not currently launched, the CD application may include a mechanism that always “listens carefully” to an announcement message from a PD application. ATSC may not be expected to clearly indicate standards for this operation (HbbTV 2.0 provides some specifications for required operations.).

Hereinafter, transmission of an emergency alert message from a PD to a CD will be described.

Subscription based delivery of the emergency alert message (EAM) to the CD from the PD may be supported via the following message exchange.

The CD may transmit a CD subscription request to the PD to receive the EAM. For example, when the CD participates in a network to activate an EAM function (or when the CD application is launched), the CD may transmit a CD subscription request to the PD to receive EAMs. For example, parameters may include at least one of subscription callback URL/information and/or requested subscription duration. Optionally, parameters may include at least one of EAM filtering criterion (e.g., geo-location) and/or CD information (CD device ID, CD application ID, CD application version, etc.).

The PD may transmit PD EAM subscription response. For example, as soon as receiving a subscription request, the PD may transmit PD EAM subscription response. For example, parameters may include at least one of a PD device ID, a subscription ID, and/or confirmed subscription duration.

The CD may transmit a CD EAM subscription renew/cancel request. For example, before subscription timeout to renew subscription and/or when subscription is canceled, the CD may transmit a CD EAM subscription renew/cancel request. For example, parameters may include a subscription ID and/or requested subscription duration to renew subscription. Optionally, parameters may include CD information (CD device ID, CD application ID, CD application version, etc.).

The PD may transmit PD EAM subscription renew/cancel response. For example, as soon as receiving a subscription renew/cancel request, the PD may transmit PD EAM subscription renew/cancel response. For example, parameters may include at least one of a subscription ID, and/or confirmed subscription duration for a subscription renewal request.

The PD may transmit a PD Notification of EAM. For example, as soon as receiving the emergency alert message, the PD may transmit a PD notification of EAM. For example, parameters may include a subscription ID, initial contents of the EAM, characteristics of initial contents of the EAM) (e.g., new message, continual or one-time message, includes rich media as well as text), and/or additional available content.

The CD may transmit CD response to the EAM. For example, upon receiving the emergency alert message from the PD, the CD may transmit CD response to the EAM. For example, parameters may include at least one of a CD device ID and/or a CD application ID. Optionally, parameters may include a request for supplementary content.

Note: Many response messages may indicate success/failure in addition to the aforementioned parameters.

Hereinafter, use cases will be described.

For example, Julio is watching a broadcast concert of Rock & Roll band that he likes through a TV screen. Notification pop-up in a TV may indicate that alternative camera views of a concert for presenting each musician to him are available through an application determined in his CD. Julio may launch an application that indicates scenes for close-ups of a guitarist, a bassist, a singer, and a drummer are available. Julio may select the guitarist during a guitar solo of singing performance and, then, change selection to the drummer. Media contents may be synchronously rendered in a TV screen and a companion screen.

For example, Mary is interested in hearing video description for the visually handicapped but does not want all viewers in a room to hear the video description. Using an application in her CD, she may discover various available audio tracks and select a description track for playback in her CD. John is visually handicapped and wants to read closed captions along with sound description. Using an application in his CD, he may discover various options for closed captions and select one option along with audio description for playback in his CD. Hector prefers voice over-dub to reading Spanish subtitles. He has a CD application having a text-to-voice function. Using his CD, he may discover Spanish subtitles and use an application for changing a text to voice that he listens through a head phone.

For example, Jane is watching a game show that she likes. Notification pop-up in a TV may indicate that the game show can also be present by her tablet through a tablet application determined to her. She may launch the application and play back the application in real time according to the game show. Simultaneously being represented in the show, each question may be represented to here in her tablet. In addition, her response time may be limited to a response time owned by a participant of the show. Her score may be traced according to an application and she may view her ranking among other viewers who also perform playback using a tablet application.

For example, George may launch an OnDemand application in his main TV. A TV application may make a request for several demographic information items from George in order to make program recommendations for George. The TV application may propose a companion tablet application to be downloaded by George in order to easily input data. George may download and launch a tablet application. The tablet application may provide data entry fields to George. George may terminate data entry in his tablet and information thereof may be registered in the TV application. The TV application may recommend several OnDemand programs based on entries thereof. George may use his tablet in order to select one among recommended programs represented in his TV. As an alternative method, George may use his tablet in order to select one among recommended programs represented in his tablet instead of a main TV.

For example, Laura is watching a program that she likes in a living room. She has various tasks required around her house. However, she does not want to miss a show that she likes. She launches an application in her tablet for watching her show in her tablet as well as her TV. She continuously watches her show through her tablet while moving to a room from another room. While Laura is in a laundry room, an emergency alert message is broadcast. The message may be represented in her tablet. The tablet may indicate that there is video of an event that she can view when she want to view the event, to her. She may select video and begin to view video. She may follow instructions indicated by the emergency alert message.

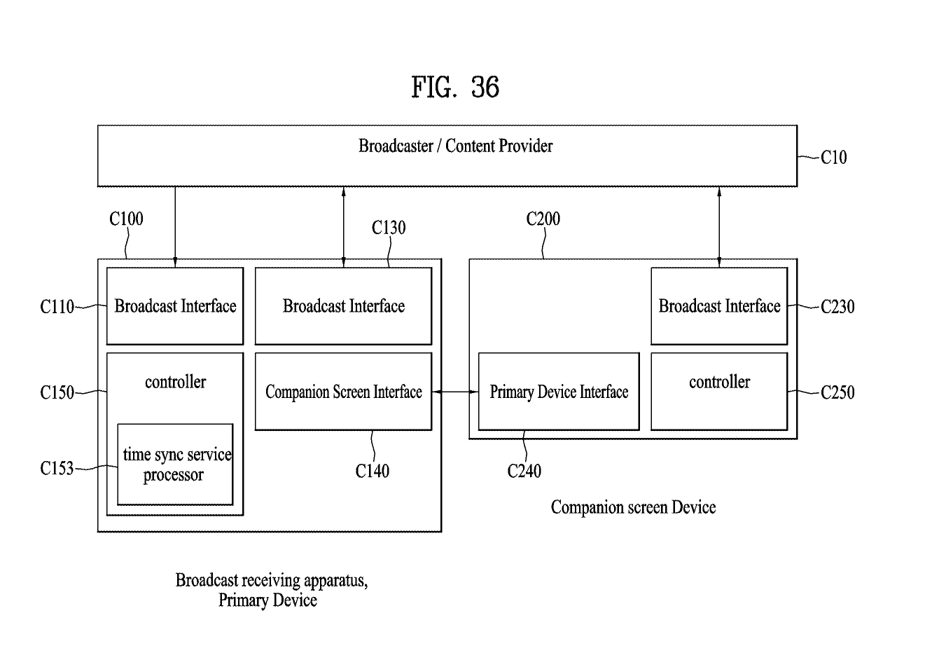

FIG. 36 is a diagram illustrating a broadcast system for delivery of time information according to an embodiment of the present invention.

The broadcast system according to an embodiment of the present invention may include at least one of the broadcaster/content provider C10, the broadcast receiving apparatus C100, and/or the companion screen device C200. The broadcaster/content provider C10 may provide a broadcast service. The broadcaster/content provider C10 may include at least one of the aforementioned broadcast transmitting apparatus (not shown), a content provider (not shown), a content server (not shown), a controller (not shown), and/or a transmitter (not shown). In addition, the broadcaster/content provider C10 may be represented by a transmitter. The broadcast receiving apparatus C100 may receive a broadcast service through a broadcast network and/or the Internet. The broadcast receiving apparatus C100 may be represented by a receiver, a first receiver, a first screen device, a master device (MD), and/or a primary device (PD). The broadcast receiving apparatus C100 may include at least one of a broadcast interface (or broadcast receiver) C110, the broadband interface (or IP transceiver) C130, the companion screen interface (or app transceiver) C140, a decoder (not shown), a display (not shown), and/or the controller C150. The companion screen device C200 may receive a broadcast service through the Internet. The companion screen device C200 may be represented by a second broadcast receiving apparatus, a second receiver, a second screen device, a slave device (SD), and/or a companion device (CD). The companion screen device C200 may include at least one of the broadband interface (or IP transceiver) C230, the primary device interface (or app transceiver) C240, a decoder (not shown), a display (not shown), and/or the controller C250. A detailed description of the broadcaster/content provider C10, the broadcast receiving apparatus C100, and/or the companion screen device C200 may include the entire above description.

The controller C150 of the broadcast receiving apparatus C100 according to an embodiment of the present invention may operate the broadcast interface C110 and the companion screen interface C140.

The controller C150 may include an application signaling service processor (not shown) for delivery of signaling information (e.g., application signaling information, trigger) to the companion screen device C200 from the broadcast receiving apparatus C100. A detailed description of the application signaling service processor is the same as the above description.

The companion screen device C200 needs to maintain time synchronization between the broadcast receiving apparatus C100 and the companion screen device C200 in order to provide a service in association with the broadcast receiving apparatus C100. The broadcast system according to an embodiment of the present invention may receive signaling information including media time information of A/V content using the broadcast receiving apparatus C100, generate service time information for providing data related to synchronization between A/V content displayed by a broadcast receiving apparatus and A/V content displayed by the companion screen device C200 based on the signaling information, and transmit the service time information to the companion screen device C200.

To this end, the controller C150 of the broadcast receiving apparatus C100 according to an embodiment of the present invention may further include a time synchronization service processor C153 for generating service time information for providing data related to time synchronization between A/V content displayed by a broadcast receiving apparatus and A/V content displayed by a companion screen device based on signaling information.

The time synchronization service may refer to a service for generating service time information for time synchronization of the broadcast receiving apparatus C100 and the companion screen device C200 and transmitting the service time information to the companion screen device C200 from the broadcast receiving apparatus C100. The service time information may be information related to synchronization between A/V content displayed by the broadcast receiving apparatus C100 and A/V content displayed by the companion screen device C200. The service time information for providing time synchronization to the companion screen device C200 by the broadcast receiving apparatus C100 may include at least one of media time information (e.g., media time) of a served (e.g., linear service) program and/or current time information (e.g., wall clock).

That is, a processor that is in charge of generation of the service time information and/or transmission of service time information to the companion screen device C200 from the broadcast receiving apparatus C100 may also be referred to as the time sync service processor C153. The time synchronization service processor C153 may transmit at least one of media time information and/or current time information (wall clock information) to the companion screen device C200 for time synchronization of media, an interactive application, and so on to the companion screen device C200 by the broadcast receiving apparatus C100. According to an embodiment of the present invention, Service Type may be defined according to urn:atsc.org:serviceId:atsc3.0:timesync.

For example, the broadcast receiving apparatus C100 may receive signaling information. The broadcast receiving apparatus C100 may receive signaling information through a broadcast network. The signaling information may include application signaling. The application signaling information may include a trigger and/or triggering application information. In addition, the signaling information may include media time information of presented A/V content.

The broadcast receiving apparatus C100 according to an embodiment of the present invention may generate service time information for time synchronization between the broadcast receiving apparatus C100 and the companion screen device C200 based on the signaling information using the time synchronization service processor C153 of the controller C150. Then, the broadcast receiving apparatus C100 may transmit the service time information to the companion screen device C200 using the companion screen interface C140.

In detail, the broadcast receiving apparatus C100 may generate update interval information indicating an interval for delivery of the service time information using the time synchronization service processor C153. The broadcast receiving apparatus C100 may transmit the service time information to the companion screen device C200 based on the update interval information using the companion screen interface C140.

The interval may be a concept including duration and frequency. Hereinafter, the duration will be first described and the frequency will be described.

Hereinafter, a method of receiving signaling information including media time information of A/V content through a broadcast network, generating service time information based on the signaling information, and transmitting the service time information to the companion screen device C200 by the broadcast receiving apparatus C100 will be described. For example, the broadcast receiving apparatus C100 may execute an event (or triggering event) (eventing method) to transmit service time information for time synchronization to the companion screen device C200. The broadcast receiving apparatus C100 may transmit service time information for time synchronization to the companion screen device C200 in response to a request of the companion screen device C200 (requesting method).

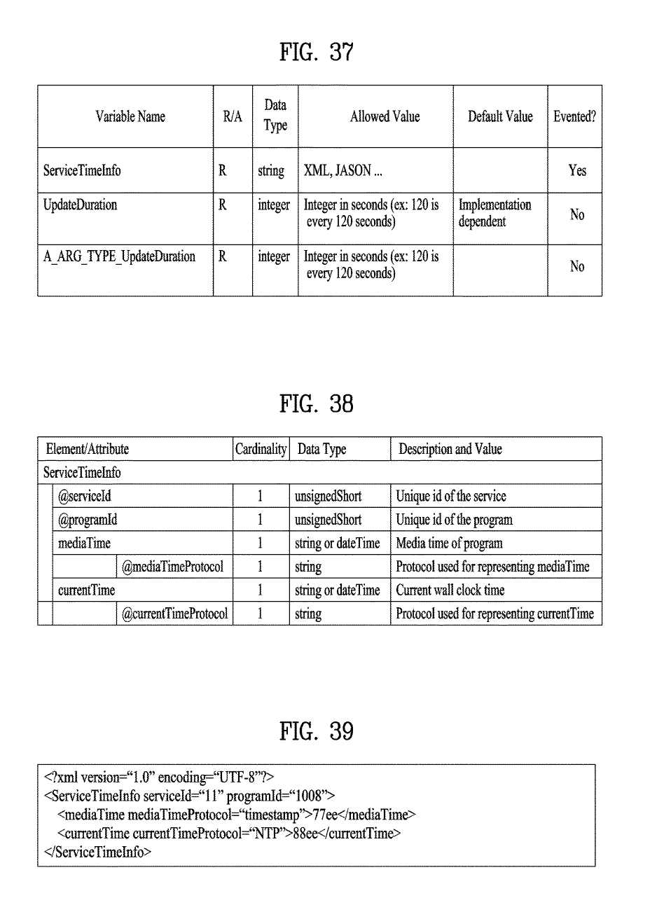

FIG. 37 is a diagram illustrating state variables for delivery of service time information according to an embodiment of the present invention.

The drawing illustrates state variables for delivery of the service time information. The state variables for delivery of the service time information may include at least one of a ServiceTimeInfo state variable including the service time information, an UpdateDuration state variable including delivery duration information, and/or an A_ARG_TYPE_UpdateDuration state variable including requested delivery duration information. The ServiceTimeInfo state variable, the UpdateDuration state variable, and/or the A_ARG_TYPE_UpdateDuration state variable may be a required state variable. The ServiceTimeInfo state variable may include media time and current time, i.e., wall-clock time information of a program that is presented or served by a broadcast receiving apparatus. The UpdateDuration state variable may be variable indicating delivery duration of time information when a broadcast receiving apparatus transmit the time information for synchronization to a companion screen device using an eventing method. The A_ARG_TYPE_UpdateDuration state variable may be variable to be used to make a request for particular delivery duration when a companion screen device receives time information for synchronization from a broadcast receiving apparatus using an eventing method.

Service time information (ServiceTimeInfo) may be information for providing data related to time synchronization between A/V content displayed by a broadcast receiving apparatus and A/V content displayed by a companion screen device. For example, the service time information may include at least one of media time information and/or wall-clock time of a program that is presented or served by a broadcast receiving apparatus. The broadcast receiving apparatus may execute an event (or triggering event) (eventing method) to transmit service time information for time synchronization to a companion screen device. In addition, the broadcast receiving apparatus may transmit the service time information for time synchronization to the companion screen device in response to a request of the companion screen device (requesting method).

The delivery duration information may be information indicating duration for delivery of the service time information. The broadcast receiving apparatus may transmit the service time information to the companion screen device based on the delivery duration information. For example, the delivery duration information (UpdateDuration) may be information indicating delivery duration when the broadcast receiving apparatus transmits service time information for time synchronization to the companion screen device using an eventing method. That is, the delivery duration information may indicate duration for eventing the service time information. When the broadcast receiving apparatus transmits the service time information for time synchronization to the companion screen device using an eventing method, the broadcast receiving apparatus may transmit the service time information to the companion screen device with duration indicated by the delivery duration information.

The requested delivery duration information may be information indicating a value of delivery duration information requested by the companion screen device when the companion screen device receives service time information for time synchronization from the broadcast receiving apparatus using an eventing. In detail, when the broadcast receiving apparatus transmits service time information for time synchronization to the companion screen device using an eventing method, the companion screen device may make a request for predetermined (or particular) delivery duration to the broadcast receiving apparatus based on the requested delivery duration information. In response to the request of the companion screen device, the broadcast receiving apparatus may determine delivery duration information based on the requested delivery duration information and transmit the service time information to the companion screen device with duration indicated by the delivery duration information.

FIG. 38 is a diagram illustrating service time information according to an embodiment of the present invention.

The service time information may be information for time synchronization between the broadcast receiving apparatus and the companion screen device. The service time information may include at least one of media time information and/or current time information of a program that is presented or served by the broadcast receiving apparatus. The service time information may include the aforementioned media timeline checkpoint.

In detail, the service time information may include at least one of serviceId attribute, programId attribute, mediaTime element, and/or currentTime element.

The serviceId attribute may indicate a unique ID of a service that is currently selected by a first receiver. For example, the service may include at least one of a linear service and/or a non-linear service.

The programId attribute may indicate a unique ID of a currently presented program. For example, the program may include content included in a linear service and/or a non-linear service.

The mediaTime element may indicate media time information of a currently presented program. The mediaTime element may include mediaTimeProtocol attribute indicating a program used to represent the mediaTime element. For example, the mediaTimeProtocol attribute may indicate a timestamp.

The currentTime element may indicate current time information (wall-clock time). The currentTime element may include currentTimeProtocol attribute indicating a program used to represent the currentTime element. For example, the currentTimeProtocol attribute may indicate a network time protocol (NTP).

The broadcast receiving apparatus may execute an event (or triggering event) (eventing method) to transmit service time information for time synchronization between the broadcast receiving apparatus and the companion screen device to the companion screen device. In addition, the broadcast receiving apparatus may transmit the service time information for time synchronization to the companion screen device in response to a request of the companion screen device (requesting method).

FIG. 39 is a diagram illustrating XML format of service time information according to an embodiment of the present invention.

Referring to the drawing, service time information may include at least one of serviceId attribute, programId attribute, mediaTime element, and/or currentTime element.

The serviceId attribute may indicate “11”. The programId attribute may indicate “1008”. The mediaTime element may include mediaTimeProtocol attribute. The mediaTimeProtocol attribute may indicate “timestamp”. In addition, the mediaTime element may indicate “77ee”. The currentTime element may include currentTimeProtocol attribute. The currentTimeProtocol attribute may indicate “NTP”. The currentTime element may indicate “88ee”.

The broadcast receiving apparatus may transmit service time information including media time information indicating “77ee” as a timestamp and current time information indicating “88ee” as an NTP to the companion screen device with respect to a program with “1008” as a value of a program ID in a service with “11” as a value of a service ID.

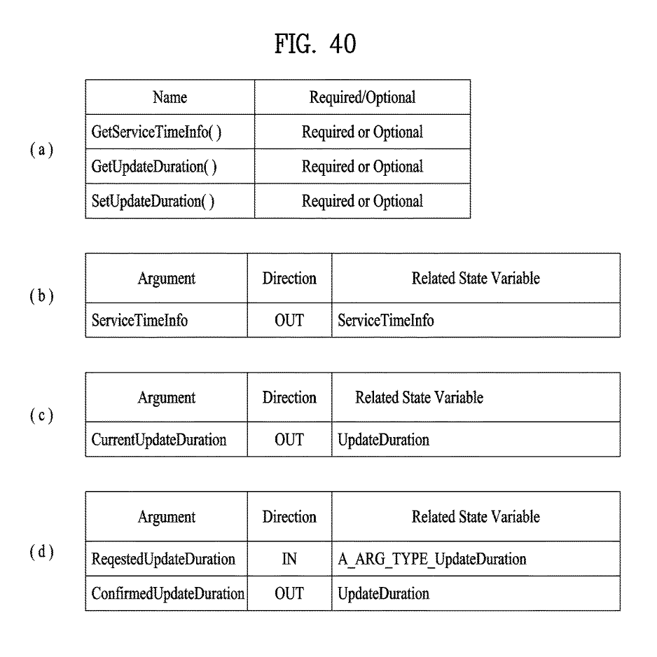

FIG. 40 is a diagram illustrating operations required to transmit service time information according to an embodiment of the present invention.

Referring to (a) of FIG. 40, the operations required to transmit the service time information may include at least one of a service time information request (GetServiceTimeInfo( ) or first request), a delivery duration information request (GetUpdateDuration( ) or second request), and/or a delivery duration information setup request (SetUpdateDuration( ) or third request).

The service time information request (GetServiceTimeInfo( ) or first request) may be an operation of making a request for acquisition of service time information for time synchronization to the service time information by the companion screen device.

The delivery duration information request (GetUpdateDuration( )) may be an operation of making a request for acquisition of delivery duration information to the broadcast receiving apparatus by the companion screen device when the companion screen device receives service time information for time synchronization from the broadcast receiving apparatus using an eventing method.

The delivery duration information setup request (SetUpdateDuration( ) or third request) may be an operation of making a request for setup of delivery duration information to the broadcast receiving apparatus by the companion screen device when the companion screen device receives service time information for time synchronization from the broadcast receiving apparatus using an eventing method.

Each of the service time information request, the delivery duration information request, and/or the delivery duration information setup request may be a necessary operation or an optional operation.

(b) of FIG. 40 illustrates Argument related to a service time information request.

The service time information request (GetServiceTimeInfo( )) may be used when the companion screen device makes a request for service time information for time synchronization from the broadcast receiving apparatus. The companion screen device may make a request for service time information for time synchronization to the broadcast receiving apparatus based on the service time information request. In response to the service time information request from the companion screen device, the broadcast receiving apparatus may transmit service time information (ServiceTimeInfo Argument) to the companion screen device based on the service time information request (or first request) for making a request for acquisition of the service time information using a companion screen interface. The service time information (ServiceTimeInfo Argument) may be information related to the ServiceTimeInfo state variable.

That is, the broadcast receiving apparatus may transmit service time information for time synchronization to the companion screen device in response to a request of the companion screen device (requesting method).

(c) of FIG. 40 illustrates Argument related to a delivery duration information request.

The delivery duration information request (GetUpdateDuration( )) may be used to make a request for current delivery duration information of the broadcast receiving apparatus from the broadcast receiving apparatus by the companion screen device. The companion screen device may make a request for current delivery duration information of the broadcast receiving apparatus to the broadcast receiving apparatus based on the delivery duration information request.

The delivery duration information may refer to duration for eventing service time information. In response to the delivery duration information request from the companion device, the broadcast receiving apparatus may transmit current delivery duration information (CurrentUpdateDuration Argument) indicating a value of delivery duration information at a time point indicated by wall-clock time (or current time) to the companion screen device. The current delivery duration information (CurrentUpdateDuration Argument) may be information related to UpdateDuration state variable.

That is, the broadcast receiving apparatus may transmit current delivery duration information to the companion screen device in response to a request of the companion screen device (requesting method). The broadcast receiving apparatus and/or the companion screen device may confirm current delivery duration information and, then, make a request for setup (or change) of the delivery duration information as necessary.

(d) of FIG. 40 illustrates Arguments related to a delivery duration information setup request.

The delivery duration information setup request (SetUpdateDuration( ) may be used to setup and/or change the delivery duration information when the companion screen device receives service time information for time synchronization from the broadcast receiving apparatus using an eventing method. The companion screen device may setup/change the delivery duration information when receiving service time information for time synchronization from the broadcast receiving apparatus using an eventing method based on the delivery duration information setup request.

When the broadcast receiving apparatus transmits service time information for time synchronization to the companion screen device using an eventing method, the broadcast receiving apparatus may transmit the service time information to the companion screen device with predetermined duration. For example, the broadcast receiving apparatus may transmit service time information when media time and/or current time (wall-clock time) are changed (e.g., every second). In this case, delivery duration of the service time information may be very short or long. The broadcast receiving apparatus may set delivery duration information (e.g., every second) that is basically set to a default value. According to the characteristics and/or types of an application and/or service to be provided in association with the broadcast receiving apparatus by the companion screen device, the delivery duration information setup request may be used to set up the delivery duration information (UpdateDuration) by the companion screen device.

Arguments related to the delivery duration information setup request may include at least one of requested delivery duration information (ReqestedUpdateDuration Argument) and/or confirmed delivery duration information (ConfirmedUpdateDuration Argument).

When the companion screen device makes a request for particular delivery duration information (UpdateDuration) of service time information for time synchronization based on the delivery duration information setup request (SetUpdateDuration( ) action), the companion screen device may transmit requested delivery duration information (RequestedUpdateDuration Argument) indicating a value of the requested delivery duration information as an input argument to the broadcast receiving apparatus. The requested delivery duration information (RequestedUpdateDuration Argument) may be information related to the A_ARG_TYPE_UpdateDuration state variable.

In response to the delivery duration information setup request (SetUpdateDuration( ) action) from the companion screen device, the broadcast receiving apparatus may transmit the confirmed delivery duration information (ConfirmedUpdateDuration argument) as an output argument to the companion screen device. The confirmed delivery duration information (ConfirmedUpdateDuration variable) may be information related to the UpdateDuration state variable.

When the broadcast receiving apparatus is capable of normally transmitting the service time information to the companion screen device with the delivery duration information (RequestedUpdateDuration Argument) requested by the companion screen device, the broadcast receiving apparatus may set the confirmed delivery duration information as the same value as the requested delivery duration information. Then, the broadcast receiving apparatus may return the confirmed delivery duration information (ConfirmedUpdateDuration Argument) including the delivery duration information indicated by the requested delivery duration information as an output argument. Then, the broadcast receiving apparatus may transmit the service time information to the companion screen device based on the confirmed delivery duration information using an eventing method.

When the broadcast receiving apparatus is not capable of transmitting the service time information to the companion screen device with the delivery duration information (RequestedUpdateDuration Argument) requested by the companion screen device, the broadcast receiving apparatus may set (or maintain) the delivery duration information to a value (default value or minimum value) closest to the requested delivery duration information. Then, the broadcast receiving apparatus may return the confirmed delivery duration information (ConfirmedUpdateDuration Argument) including the delivery duration information indicating the value closest to the requested delivery duration information as an output argument. Then, the broadcast receiving apparatus may transmit the service time information to the companion screen device based on the confirmed delivery duration information using an eventing method.

For example, the companion screen device transmits the requested delivery duration information indicating the delivery duration information (UpdateDuration) in a unit of “every second” to the broadcast receiving apparatus (RequestedUpdateDuration=1) but a corresponding program or application may set the delivery duration information (UpdateDuration) only in a unit of minimum “every minute (default value)” in the broadcast receiving apparatus. In this case, the broadcast receiving apparatus may return the confirmed delivery duration information indicating the delivery duration information in a unit of “every minute” as an output argument (ConfirmedUpdateDuration=60). The delivery duration information (UpdateDuration) of the confirmed delivery duration information may be maintained as “every minute” as a default value of the broadcast receiving apparatus (UpdateDuration=60). Then, the broadcast receiving apparatus may transmit the service time information to the companion screen device based on the confirmed delivery duration information indicating the delivery duration information in a unit of “every minute” using an eventing method.

When the broadcast receiving apparatus is set (or change) the delivery duration information (UpdateDuration) in a unit of “per second (every second)”, the broadcast receiving apparatus may return the confirmed delivery duration information indicating the delivery duration information in a unit of “every second” as an output argument (ConfirmedUpdateDuration=1). Then, the broadcast receiving apparatus may transmit the service time information to the companion screen device based on the confirmed delivery duration information indicating the delivery duration information of a unit of “every second” using an eventing method.

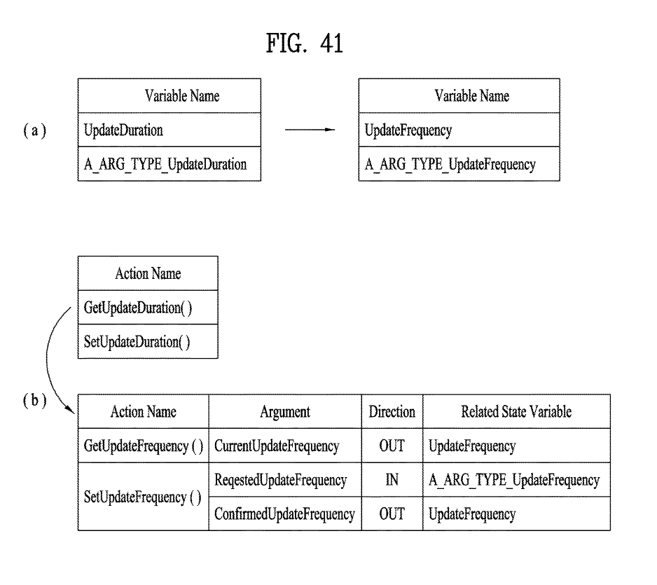

FIG. 41 is a diagram illustrating delivery frequency information according to an embodiment of the present invention.

According to an embodiment of the present invention, Duration may be replaced with Frequency. In this case, Duration=1/Frequency may be satisfied. Here, a unit of Duration may be a second and a unit of Frequency may be 1/second. That is, when a value of Duration is “2 (second)”, Frequency is “0.5 (1/second)”.

When Frequency is used instead of Duration, names of state variable and action may be changed as illustrated in the drawing.

Referring to (a) of FIG. 41, delivery duration information (UpdateDuration state variable) may be changed to delivery frequency information (UpdateFrequency state variable). The delivery frequency information may indicate a delivery frequency when the broadcast receiving apparatus transmits service time information for time synchronization to the companion screen device using an eventing.

The request delivery duration information (A_ARG_TYPE_UpdateDuration state variable) may be changed to the request delivery frequency information (A_ARG_TYPE_UpdateFrequency state variable). The requested delivery frequency information may be information indicating a value of the delivery frequency information requested by the companion screen device when the companion screen device receives service time information for time synchronization from the broadcast receiving apparatus using an eventing method.

Referring to (b) of FIG. 41, operations required to transmit the service time information may include at least one of a service time information request, a delivery frequency information request, and/or a delivery frequency information setup request.

The service time information request may be an operation of making a request for service time information for time synchronization from the broadcast receiving apparatus by the companion screen device.

The delivery duration information request (GetUpdateDuration( )) may be changed to the delivery frequency information request (GetUpdateFrequency( )).

The delivery frequency information request (GetUpdateFrequency( )) may be used when the companion screen device makes a request for current delivery frequency information of the broadcast receiving apparatus from the broadcast receiving apparatus. The companion screen device may make a request for the current delivery frequency information of the broadcast receiving apparatus to the broadcast receiving apparatus based on the delivery frequency information request.

The delivery frequency information indicates a frequency for eventing the service time information. In response to the delivery frequency information request from the companion device, the broadcast receiving apparatus may transmit current delivery frequency information (CurrentUpdateFrequency Argument) indicating a value of delivery frequency information at a time point indicated by wall-clock time (or current time) to the companion screen device. The current delivery frequency information (CurrentUpdateFrequency Argument) may be information related to the UpdateFrequency state variable.

That is, the broadcast receiving apparatus may transmit the current delivery frequency information to the companion screen device in response to a request of the companion screen device (requesting method). The broadcast receiving apparatus and/or the companion screen device may confirm the current delivery frequency information and, then, make a request for setup (or change) of the delivery frequency information as necessary.

The delivery duration information setup request (SetUpdateDuration( )) may be changed to delivery frequency information setup request (SetUpdateFrequency( )).

The delivery frequency information setup request (SetUpdateFrequency( )) may be used to setup and/or change delivery frequency information when the companion screen device receives the service time information for time synchronization from the broadcast receiving apparatus using an eventing method. Upon receiving the service time information for time synchronization from the broadcast receiving apparatus based on the delivery frequency information setup request using an eventing method, the companion screen device may setup and/or change the delivery frequency information.

Arguments related to the delivery frequency information setup request may include at least one of requested delivery frequency information (ReqestedUpdateFrequency Argument) and/or confirmed delivery frequency information (ConfirmedUpdateFrequency Argument).

When the companion screen device makes a request for particular delivery frequency information (UpdateFrequency) of service time information for time synchronization based on the delivery frequency information setup request (SetUpdateFrequency( ) action), the companion screen device may transmit the requested delivery frequency information (RequestedUpdateFrequency Argument) indicating a value of the requested delivery frequency information as an input argument to the broadcast receiving apparatus. The requested delivery frequency information (RequestedUpdateFrequency Argument) may be information related to the A_ARG_TYPE_UpdateFrequency state variable.

In response to the delivery frequency information setup request (SetUpdateFrequency( ) action) from the companion screen device, the broadcast receiving apparatus may transmit the confirmed delivery frequency information (ConfirmedUpdateFrequency argument) as an output argument to the companion screen device. The confirmed delivery frequency information (ConfirmedUpdateFrequency variable) may be information related to the UpdateFrequency state variable.

When the broadcast receiving apparatus is capable of normally transmitting the service time information to the companion screen device with the delivery frequency information (RequestedUpdateFrequency Argument) requested by the companion screen device, the broadcast receiving apparatus may set the confirmed delivery frequency information as the same value as the requested delivery frequency information. Then, the broadcast receiving apparatus may return the confirmed delivery frequency information (ConfirmedUpdateFrequency Argument) including the delivery frequency information indicated by the requested delivery frequency information as an output argument. Then, the broadcast receiving apparatus may transmit the service time information to the companion screen device based on the confirmed delivery frequency information using an eventing method.

When the broadcast receiving apparatus is not capable of transmitting the service time information to the companion screen device with the delivery frequency information (RequestedUpdateFrequency Argument) requested by the companion screen device, the broadcast receiving apparatus may set (or maintain) the delivery frequency information to a value (default value or minimum value) closest to the requested delivery frequency information. Then, the broadcast receiving apparatus may return the confirmed delivery frequency information (ConfinnedUpdateFrequency Argument) including the delivery frequency information indicating the value closest to the requested delivery frequency information as an output argument. Then, the broadcast receiving apparatus may transmit the service time information to the companion screen device based on the confirmed delivery frequency information using an eventing method.

A detailed operation of the broadcast receiving apparatus and/or the companion screen device when duration is changed to a frequency may include the entire above description.

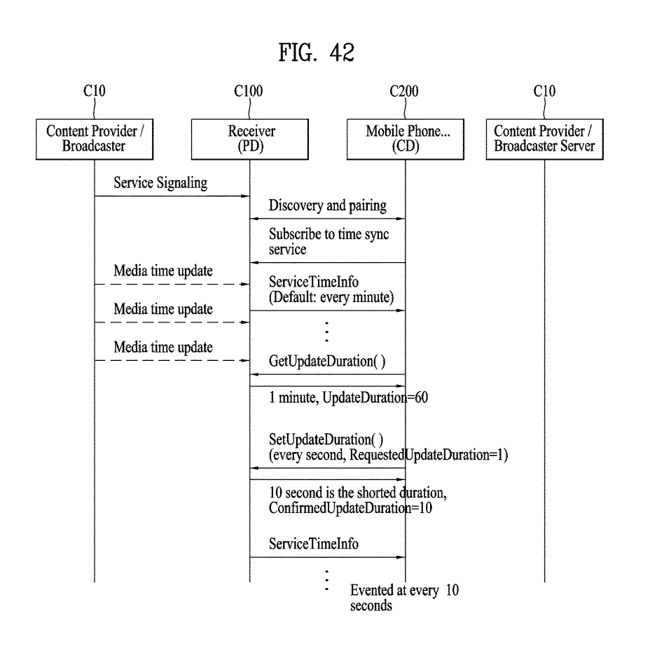

FIG. 42 is a flow diagram of transmitting service time information to a companion screen device by a broadcast receiving apparatus using an eventing method according to an embodiment of the present invention.

Referring to the drawing, the broadcast system according to an embodiment of the present invention may include at least one of the broadcaster/content provider C10, the broadcast receiving apparatus C100, and/or the companion screen device C200.

The broadcaster/content provider C10 may provide a broadcast service. For example, the broadcast service may include content (or linear service), an application (or non-linear service), and/or signaling information. The broadcaster/content provider C10 may include at least of the aforementioned broadcast transmitting apparatus (not shown), content provider (not shown), content server (not shown), controller (not shown), and/or transmitter (not shown).

The broadcast receiving apparatus C100 may receive a broadcast service through a broadcast network and/or the Internet. The broadcast receiving apparatus C100 may be referred to as a TV receiver and/or a PD.

The companion screen device C200 may receive a broadcast service through the Internet. The companion screen device may be referred to as a mobile phone and/or a CD.

Hereinafter, a method of transmitting service time information for time synchronization to the companion screen device by the broadcast receiving apparatus using an eventing method will be described.

First, the broadcast receiving apparatus C100 may receive a broadcast signal from the broadcaster/content provider C10. The broadcast receiving apparatus C100 may acquire signaling information based on the broadcast signal. In detail, the broadcast receiving apparatus C100 may acquire the application signaling information based on the signaling information. As described above, the receiver C100 may acquire the signaling information based on an MPEG-DASH protocol and/or an MMT protocol. The application signaling information may include at least one of a trigger for triggering an operation of an application and triggering application information (or TPT) for signaling information on the triggered application. When a user selects a channel, the broadcast receiving apparatus C100 may provide (or broadcast) a particular program based on the signaling information.

Then, the broadcast receiving apparatus C100 may perform discovery and/or pairing with the companion screen device C200. For example, according to the provided program, the broadcast receiving apparatus C100 may discover the companion screen device and may be electrically paired with the companion screen device so as to transmit and receive data.

Then, the broadcast receiving apparatus C100 may receive a request for subscription of the time synchronization service from the companion screen device C200. In addition, the companion screen device C200 may make a request for subscription of the time synchronization service to the broadcast receiving apparatus C100. The time synchronization service may refer to a service of generating service time information for providing time synchronization between A/V content displayed by the broadcast receiving apparatus C100 and content displayed by the companion screen device C200 and transmitting service time information to the companion screen device C200 from the broadcast receiving apparatus C100. The service time information may include the aforementioned media timeline checkpoint.

Then, the broadcast receiving apparatus C100 may receive the signaling information including media time information of presented A/V content from the broadcaster/content provider C10. The signaling information may include at least one of media time information and/or current time information (wall clock). As described above, the broadcast receiving apparatus C100 may receive signaling information based on the MPEG-DASH protocol and/or the MMT protocol. The broadcast receiving apparatus C100 may receive signaling information including media time information at a preset time interval during broadcast of a program.

Then, the broadcast receiving apparatus C100 may transmit the service time information (ServiceTimeInfo) to the companion screen device C200 using an eventing method. For example, the broadcast receiving apparatus C100 may transmit the service time information to the companion screen device C200 based on delivery duration information (e.g., every minute) obtained by setting the service time information to a default value using an eventing method.

Then, the broadcast receiving apparatus C100 may receive delivery duration information request (GetUpdateDuration( ) or second request) for making a request for acquisition of current delivery duration information of the broadcast receiving apparatus C100 from the companion screen device C200.

The companion screen device C200 may make a request for current delivery duration information of the broadcast receiving apparatus C100 to the broadcast receiving apparatus C100 based on the delivery duration information request. In response to the delivery duration information request from the companion screen device C200, the current delivery duration information indicating a value of delivery duration information at a time point indicated by wall-clock time based on the delivery duration information request may be generated and the current delivery duration information may be transmitted to the companion screen device C200.

The broadcast receiving apparatus C100 may transmit the current delivery duration information to the companion screen device C200 in response to a request of the companion screen device C200 (requesting method). The companion screen device C200 may check current delivery duration information of the broadcast receiving apparatus C100 based on the delivery duration information request.

Then, the broadcast receiving apparatus C100 may receive delivery duration information setup request (SetUpdateDuration( ) or third request) for making a request for setup of the delivery duration information from the companion screen device C200.

For example, when the companion screen device C200 receives service time information for time synchronization from the broadcast receiving apparatus C100 using an eventing method, the broadcast receiving apparatus C100 may receive delivery duration information setup request (SetUpdateDuration( ) action) for setup (or change) of delivery duration from the companion screen device C200. For example, the companion screen device C200 may transmit the requested delivery duration information (RequestedUpdateDuration Argument) indicating a value of the requested delivery duration information to the broadcast receiving apparatus.

For example, the requested delivery duration information (RequestedUpdateDuration Argument) may indicate “1 second”. The companion screen device C200 may make a request for setup of delivery duration to 1 second using the delivery duration information setup request (SetUpdateDuration( ) action).

Then, the broadcast receiving apparatus may generate confirmed delivery duration information (ConfirmedUpdateDuration Argument) based on the requested delivery duration information (RequestedUpdateDuration Argument). In addition, the broadcast receiving apparatus C100 may transmit the confirmed delivery duration information to the companion screen device. The confirmed delivery duration information (ConfirmedUpdateDuration Argument) may indicate the same value as the requested delivery duration information (RequestedUpdateDuration Argument) and/or a closest value to the requested delivery duration information (RequestedUpdateDuration Argument) of delivery duration information items provided by the broadcast receiving apparatus C100. For example, the confirmed delivery duration information (ConfirmedUpdateDuration Argument) may indicate “10 seconds”. Since “10 seconds” are a closest value (or minimum value of delivery duration information) if possible and, thus, the broadcast receiving apparatus C100 may set the confirmed delivery duration information to “10 seconds”.

Then, the broadcast receiving apparatus C100 may transmit service time information to the companion screen device based on the confirmed delivery duration information using an eventing method. For example, the first receiver may transmit the service time information to the companion screen device C200 every 10 seconds using an eventing method.

The broadcaster/content provider C10 may transmit time information (or signaling information) including media time information (or media time update) to the broadcast receiving apparatus at a particular time point of a program and/or periodically according to the type and/or characteristics of the program.

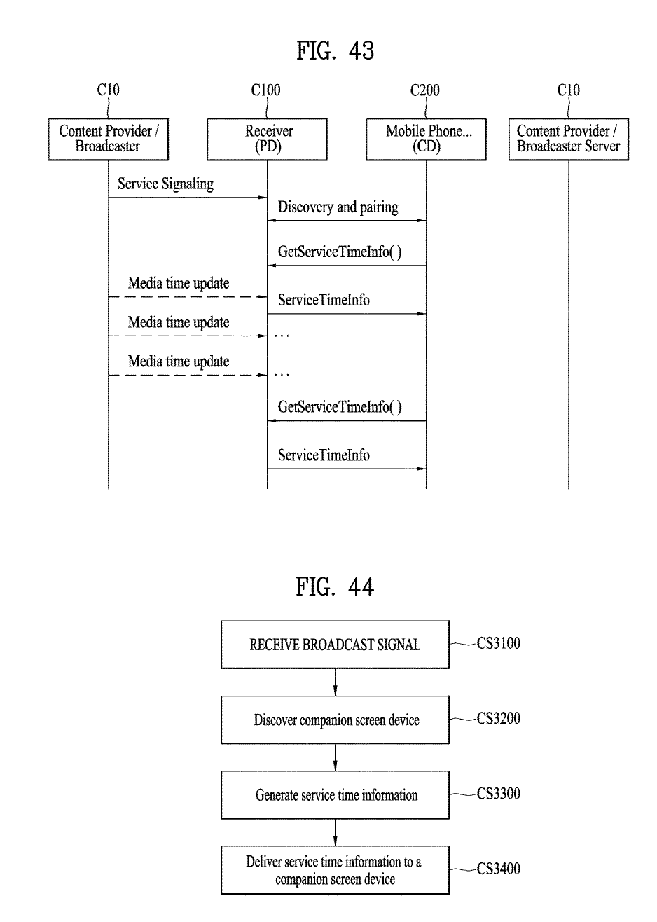

FIG. 43 is a flow diagram of transmitting service time information to a companion screen device by a broadcast receiving apparatus using a requesting method according to an embodiment of the present invention.

Referring to the drawing, the broadcast system according to an embodiment of the present invention may include at least one of the broadcaster/content provider C10, the broadcast receiving apparatus C100, and/or the companion screen device C200. A detailed description of the broadcast system according to an embodiment of the present invention may include the entire above description.

Hereinafter, a method of transmitting service time information for time synchronization to the companion screen device C200 by the broadcast receiving apparatus C100 using a requesting method will be described.

First, the broadcast receiving apparatus C100 may receive a broadcast signal from the broadcaster/content provider C10. The broadcast receiving apparatus C100 may acquire signaling information based on the broadcast signal. When a user selects a channel, the broadcast receiving apparatus C100 may provide (or broadcast) a particular program to the user based on the signaling information.

Then, the broadcast receiving apparatus C100 may perform discovery and/or pairing with the companion screen device C200. For example, according to the provided program, the broadcast receiving apparatus C100 may discover the companion screen device and may be electrically paired with the companion screen device C200 so as to transmit and receive data.

Then, the broadcast receiving apparatus C100 may receive service time information request (GetServiceTimeInfo( ) or first request) of making a request for acquisition of service time information from the companion screen device C200. The service time information request (GetServiceTimeInfo( ) action) may be an operation of making a request for service time information for time synchronization from the broadcast receiving apparatus C100 by the companion screen device C200. For example, the companion screen device C200 may make a request for service time information to the broadcast receiving apparatus C100 using the service time information request (GetServiceTimeInfo( ) action) at every required time.

Then, in response to a request of the companion screen device C200, the broadcast receiving apparatus C100 may transmit recent service time information to the companion screen device C200. For example, the broadcast receiving apparatus C100 may transmit service time information to the companion screen device C200 based on a request for acquisition of the service time information using a requesting method.

The broadcaster/content provider C10 may transmit time information (or signaling information) including media time information (or media time update) to the broadcast receiving apparatus at a particular time point of a program and/or periodically according to the type and/or characteristics of the program.

FIG. 44 is a flowchart illustrating an operation of a broadcast receiving apparatus according to an embodiment of the present invention.

A broadcast signal receiving apparatus may receive a broadcast signal using a broadcast interface (CS3100). For example, the broadcast signal receiving apparatus may receive signaling information and a service including an audio/video (A/V) program using the broadcast interface. For example, the program may refer to content. That is, the A/V program may refer to A/V content.

For example, the signaling information may include media time information of a presented A/V program.

Then, the broadcast receiving apparatus may discover the companion screen device using a companion screen interface (CS3200). The broadcast receiving apparatus may transmit data and/or signaling information to the companion screen device or receive data and/or signaling information from the companion screen device using the companion screen interface.

Then, the broadcast receiving apparatus may operate the broadcast interface and the companion screen interface using a controller. The controller may include a time synchronization service processor.

Then, the broadcast receiving apparatus may generate service time information for providing data related to time synchronization between an A/V program based on signaling information and an A/V program displayed by the companion screen device using the controller and/or the time synchronization service processor (CS3300).

Then, the broadcast receiving apparatus may transmit the service time information to the companion screen device using the companion screen interface (CS3400).

The service time information according to an embodiment of the present invention may include at least one of serviceId attribute indicating a service ID, programId attribute indicating an ID of a program presented in a service, mediaTime element indicating media time information of a program, and/or currentTime element indicating wall-clock time.

The broadcast receiving apparatus according to an embodiment of the present invention may transmit service time information using a requesting method. The broadcast signal receiving apparatus may transmit service time information to the companion screen device based on a first request of making a request for acquisition of service time information received from the companion screen device using the companion screen interface.

The broadcast receiving apparatus according to an embodiment of the present invention may transmit service time information using an eventing method. The broadcast receiving apparatus may generate update interval information indicating an interval for transmitting the service time information using the time synchronization service processor. Then, the broadcast receiving apparatus may transmit the service time information to the companion screen device based on the update interval information using the companion screen interface.

The update interval information according to an embodiment of the present invention may be one of delivery duration information indicating duration for transmitting service time information and delivery frequency information indicating a frequency for transmitting service time information. For example, the interval may include duration and/or a frequency. The update interval information may include update duration information and/or update frequency information.

The broadcast receiving apparatus may make a request for acquisition of the update interval information. The broadcast receiving apparatus may receive a second request (or update interval information request) of making a request for acquisition of the update interval information from the companion screen device using the companion screen interface. Then, the broadcast receiving apparatus may generate current update interval information indicating a value of the update interval information at a time point indicated by wall-clock time based on the second request using the time synchronization service processor. Then, the broadcast receiving apparatus may transmit the current update interval information to the companion screen device using the companion screen interface.

For example, the update interval information request may include a delivery duration information request and/or the delivery frequency information request. The current update interval information may include current delivery duration information and/or current delivery frequency information.

The broadcast receiving apparatus may make a request for setup of the update interval information. The broadcast receiving apparatus may receive a third request (or update interval information setup request) of making a request of setup of the update interval information from the companion screen device using the companion screen interface. The third request may include the requested update interval information indicating a value of the update interval information requested by the companion screen device. Then, the broadcast receiving apparatus may generate confirmed update interval information indicating one of the same value as the requested update interval information and a closest value to the requested update interval information using the time synchronization service processor. Then, the broadcast receiving apparatus may transmit the service time information to the companion screen device based on the confirmed update interval request information using the companion screen interface.

For example, the update interval information setup request may include a delivery duration information setup request and/or a delivery frequency information setup request. The requested update interval information may include the requested delivery duration information and/or the requested delivery frequency information. The confirmed update interval information may include confirmed delivery duration information and/or confirmed delivery frequency information.

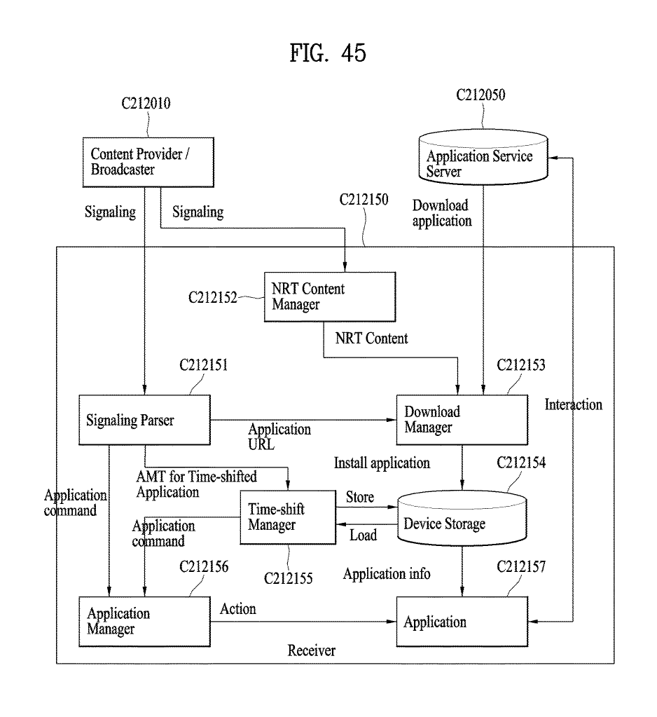

FIG. 45 is a diagram illustrating a structure of a broadcast receiving apparatus for supporting a time-shifted application according to an embodiment of the present invention.

Hereinafter, a method of supporting a time-shifted application in a next-generation hybrid broadcast system will be described.

With respect to a program provided for each service in a next-generation hybrid broadcast system, a user may perform replay, trick play, and so on using a time-shift function of the broadcast receiving apparatus. The present invention proposes a method of supporting time-shift by interactive application to be executed along with a program, i.e., app-based enhancement in a linear service when the program is time-shifted.

In order to support the time-shifted application by a companion screen device (e.g. second receiver or companion device) connected to the broadcast receiving apparatus (e.g. TV, primary device, and first receiver), signaling information for a time-shifted application may be transmitted using a method of transmitting application signaling to the companion screen device (or companion device) by the aforementioned broadcast receiving apparatus (or primary device).

According to an embodiment of the present invention, a user is watching a live car racing program being broadcast in channel #10 and, then, may start recording in order to re-watch the program. A broadcaster may inform the user that there is an interactive application for the current program. The interactive application to be provided in the Car racing program may allow the user to select a desired driver and to examine profile information of the driver, such as past competition record. Since the user is recording competition, the user may expect to examine profile information of a desired driver through the interactive application even when the user re-watches competition in the future like the user experience while live broadcast is watched. The interactive application may be valid for an available time period (e.g., one week) to be determined by a broadcaster server (broadcast transmitting apparatus, content server, or application service server). During the available time period determined by the broadcaster server, the user may user the interactive application whenever the user watches the recorded program.

According to an embodiment of the present invention, the user may set scheduled recording for a drama to be supposed to be broadcast in channel #20. A broadcaster may provide the interactive application for the current drama. The interactive application for the drama may provide information such as quiz of personal information and storyline to the user according to media time. The user may expect to use the interactive application even when the user watches the recorded drama in the future. Similarly, the interactive application may be valid for available time (e.g., three days) to be determined by the broadcaster server (broadcast transmitting apparatus, content server, or application service server). For the available time to be determined by the broadcaster server, the user may use the interactive application whenever the user watches the recorded program.

According to an embodiment of the present invention, the user may watch a drama in channel #30. The current drama may provide the interactive application. The user may return after stepping out in front of a TV for a while and, then, review the drama from the past scene and re-watch the drama using a tile-shift function of the TV. In this case, the user may expect to use the interactive application provided from the drama as before.

The drawing illustrates a structure of the next-generation hybrid broadcast system for supporting a time-shifted application according to an embodiment of the present invention.

The broadcast system according to an embodiment of the present invention may include at least one of a content provider/broadcaster C212010, an application service server C212050, and/or a broadcast receiving apparatus (receiver).

The content provider/broadcaster C212010 may indicate a content provider or a broadcast transmitting apparatus. The content provider/broadcaster C212010 may include a content provider and/or a broadcast transmitting apparatus.

The content provider may provide media content (e.g., real-time content and/or non-real time content) to the content provider/broadcaster C212010 and/or the application service server C212050.

The content provider/broadcaster C212010 may transmit a broadcast signal including a broadcast service using at least one of satellite, terrestrial, and cable broadcast networks. The broadcast service may include at least one of signaling data (or signaling information), ESG data, non real time (NRT) content data, and/or real-time content data. The real time content data may include media data such as video data, audio data, and/or subtitle data. In addition, the NRT content data may include media data and/or an application.

The content provider/broadcaster C212010 may include a controller (not shown) and a transmitter (not shown) of the content provider/broadcaster C212010. The controller may control an operation of the content provider/broadcaster C212010.

When an application provided for a particular program supports a time-shift function, the content provider/broadcaster C212010 may transmit application signaling information (e.g., trigger) on the case in which a particular program is presented via time-shift in a particular table (e.g., activation messages table and AMT) to the broadcast receiving apparatus. According to an embodiment of the present invention, the content provider/broadcaster C212010 transmits a trigger to the broadcast receiving apparatus through the AMT. The AMT may be originally used when activation trigger information of a plurality of applications, that is, bulk application triggers, are transmitted. According to an embodiment of the present invention, the ATM may be used to trigger an application for the time-shifted program. The ATM may be transmitted to the broadcast receiving apparatus through a broadcast network and/or the Internet.

The application service server C212050 may transmit a broadcast signal including a broadcast service based on a request of the broadcast receiving apparatus. The application service server C212050 may be an application service server for providing an application and/or application data. The application service server may be provided by a content provider or a broadcaster and, in this case, may be included in the content provider/broadcaster C212010.

The broadcast receiving apparatus (or receiver) according to an embodiment of the present invention may include at least one of a broadcast interface (not shown or broadcast receiver), a broadband interface (not shown or IP transceiver), a companion screen interface (not shown or an app transceiver), and/or a controller C212150. The broadcast receiving apparatus may operate a broadcast interface, a broadband interface, and/or a companion screen interface using the controller C212150. The broadcast receiving apparatus may receive a broadcast signal including a broadcast service using the broadcast interface. In this case, the broadcast signal may be transmitted using at least one of satellite, terrestrial, and cable broadcast networks. Accordingly, the broadcast interface may include at least one of a satellite tuner, a terrestrial tuner, and a cable tuner in order to receive the broadcast signal. The broadcast receiving apparatus may make a request for the broadcast service to the application service server C212050 using the broadband interface. The broadcast receiving apparatus may receive the broadcast service from the application service server C212050 using the broadband interface. The broadcast receiving apparatus may transmit data and/or signaling information to the companion screen device (not shown) or receive data and/or signaling information from the companion screen device using the companion screen interface. The broadcast receiving apparatus may decode the broadcast service using a decoder.

The controller C212150 of the broadcast receiving apparatus according to an embodiment of the present invention may include at least one of a signaling parser C212151, an NRT content manager C212152, a download manager C212153, device storage C212154, a time-shift manager C212155, an application manager C212156, and/or an application processor C212157.

The signaling parser C212151 may parse a broadcast signal provided by the content provider/broadcaster C212010 to extract a broadcast service. For example, the broadcast service may include at least one of signaling data (or signaling information), ESG data, non real time (NRT) content data, and/or real-time content data. The signaling parser C212151 may parse signaling information to extract application signaling information for signaling an application. For example, the application signaling information may include at least one of a trigger (e.g., application command) for triggering an operation of an application, an AMT, and/or application location information (e.g., application URL) indicating a location of an application for downloading an application in the application service server C212050. For example, the AMT may be an AMT for an application (time-shifted application) for supporting a time-shift function. The application signaling information may further include at least one of triggering application information (e.g., TPT) for signaling information on a triggered application and/or application notification including information on an application notification.

The NRT content manager C212152 may mange NRT content data. For example, the NRT content manager C212152 may parse the broadcast signal to extract NRT content data. For example, the NRT content manager C212152 may parse the broadcast signal to extract NRT content. For example, the NRT content data may include signaling information including triggering application information (e.g., TPT).

The download manager C212153 may receive NRT content data from the content provider or the content provider/broadcaster C212010 and/or the application service server C212050. For example, the download manager C212153 may receive information related to NRT content from the NRT content manager C212152. The download manager C212153 may receive information signaling information, an application, application data, and/or application related information from the application service server C212050. The download manager C212153 may receive signaling information, application, application related information, and NRT content data based on the signaling information. For example, the download manager C212153 may receive signaling information, an application, application related information, and NRT content data from the application service server C212050 based on the application location information. Then, the download manager C212153 may transmit signaling information, an application, application related information, and NRT content data to the device storage C212154. In addition, the download manager C212153 may install an application in the device storage C212154.

The device storage C212154 may store a broadcast service, data, content, a time-shift management table (TMT), application related information, and/or signaling information. For example, the device storage C212154 may store signaling information including an AMT and/or triggering application information (e.g., TPT). The device storage C212154 may transmit the stored information items to other devices.

The time-shift manager C212155 may generate a time-shift management table (TMT) for stating an application for supporting a time-shift function. For example, the time-shift manager C212155 may generate signaling information and/or a TMT for stating an application for supporting a time-shift function based on the AMT. The time-shift manager C212155 may transmit or store the AMT, the TMT, and/or the signaling information to the device storage C212154 or extract or load the AMT, the TMT, and/or signaling information stored in the device storage C212154. The time-shift manager C212155 may extract the AMT and/or a TPT related to the application based on the TMT. For example, the time-shift manager C212155 may extract a trigger (e.g. application command) for triggering an operation of an application included in the AMT based on the TMT.

In the case of a real time program, a broadcaster transmits a trigger and signaling information on an application through a broadcast network but, in the case of a time-shifted program, the time-shift manager C212155 may perform this function. That is, the time-shift manager C212155 may transmit a trigger and signaling information on an application for supporting a time-shift function for a time-shifted program based on the TMT.

The time-shift manager C212155 may configure a new table (e.g., time-shift management table) using a current service, program information, and a TPT ID when timeShiftEnabled attribute of application attribute information (e.g. TPT) to be transmitted from a broadcaster is “true” and store the new table in the device storage C212154. The signaling information may include timeshift attribute indicating whether the corresponding content or program is time-shifted content or program. The time-shift manager C212155 may configure the new table (e.g., Time-shift Management Table) using the current service, program information, and a TPT ID based on the timeshift attribute and store the new table in the device storage C212154.

In the future, when a program recorded by a user is presented or trick-played, the broadcast receiving apparatus may extract application attribute information (e.g., TPT) and application trigger information (e.g., trigger) related to a program using a time-shift management table (TMT) of a currently watched program and perform an operation of an application according to the application trigger information. For example, the broadcast receiving apparatus may extract a trigger included in the AMT and a TPT stored in device storage based on the TMT using the time-shift manager C212155. The broadcast receiving apparatus may operate an application based on the trigger and the TPT using an application manager.

The application manager C212156 may manage an application based on signaling information (e.g., application signaling information) related to the application. For example, the application manager C212156 may control an operation of the application based on the trigger (e.g. application command) and/or the triggering application information (e.g. TPT and application information). Here, the operation of the application may be Activate (Launch or Execute), Suspend, Resume, or Terminate (Exit).

The application processor C212157 may operate the application based on the signaling information. For example, the application processor C212157 may operate an application based on the trigger and/or the triggering application information. For example, the application processor C212157 may perform interaction with the application service server C212050. The application processor C212157 may transmit data to the application service server C212050 and receive data from the application service server C212050. The application processor C212157 may decode the received application and display the application on a screen. According to an embodiment of the present invention, the application may be included in the application processor C212157.

Each device included in the broadcast system may be embodied in the form of hardware or software. When each device is embodied in the form of hardware, the expression ‘manager’ may be replaced with the ‘processor’.

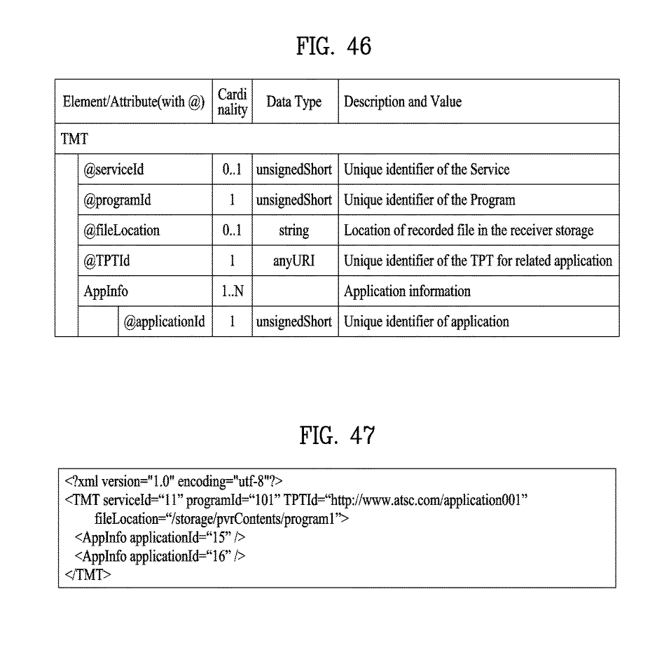

FIG. 46 is a diagram illustrating a time-shift management table (TMT) according to an embodiment of the present invention.

The TMT may describe an application applicable to a time-shifted program. The TMT may describe an application for supporting a time-shift function. For example, the TMT may include at least one of serviceId attribute, programId attribute, fileLocation attribute, TPTId attribute, and/or AppInfo element. The TMT may include at least one trigger and/or trigger information. The trigger information may include information on attribute of a trigger.

The serviceId attribute may indicate a unique ID of a service. For example, the serviceId attribute may indicate a service ID of a service for providing an application for supporting a time-shift function. The serviceId attribute may be optional information.

The programId attribute may indicate a unique ID of a program. For example, the programId attribute may indicate an ID for identifying a particular program included in a service. The program may provide an application for supporting a time-shift function. The programId attribute may be necessary information.

The fileLocation attribute may indicate a location of a file recorded in device storage of the broadcast receiving apparatus. The fileLocation attribute may indicate a location of a program stored in the broadcast receiving apparatus. The fileLocation attribute may be optional information.

The TPTId attribute may indicate a unique ID of triggering application information (or TPT) on a related application. The TPTId attribute may be necessary information.

The AppInfo element may include application attribute or application information. The AppInfo element may be necessary information. The AppInfo element may include applicationId attribute. The applicationId attribute may indicate a unique Id of an application. The applicationId attribute may be necessary information. The AppInfo element may include at least one trigger and/or trigger information on a corresponding application. The trigger information may include information on trigger attribute.

FIG. 47 is a diagram illustrating XML format data of a TMT according to an embodiment of the present invention.

The TMT according to an embodiment of the present invention may include at least one of serviceId attribute, programId attribute, fileLocation attribute, TPTId attribute, and/or AppInfo element.

The serviceId attribute may indicate “11”. The programId attribute may indicate “101”. The TPTId attribute may indicate “http://www.atsc.com/application001”. The fileLocation attribute may indicate “/storage/pvrContents/program1”. The AppInfo element may include first application information and second application information.

The applicationId attribute of the first application information may indicate “15”.

The applicationId attribute of the second application information may indicate “16”.

When the broadcast receiving apparatus starts recording a program for time-shift, a service ID, a program ID, and so on are already known and, thus, a name of a file to be recorded may be stored in storage of the broadcast receiving apparatus using the service ID and/or the program ID. In this case, the broadcast receiving apparatus may also store the name with the same service ID and/or program ID in the TMT.

When a recorded program is presented in the future, the broadcast receiving apparatus may know a service ID and/or a program ID through the file mane and search the TMT to know a related application ID.

Alternatively, when a recorded program is presented in the future, the broadcast receiving apparatus may search the TMT to know a related application ID based on fileLocation attribute of the TMT.

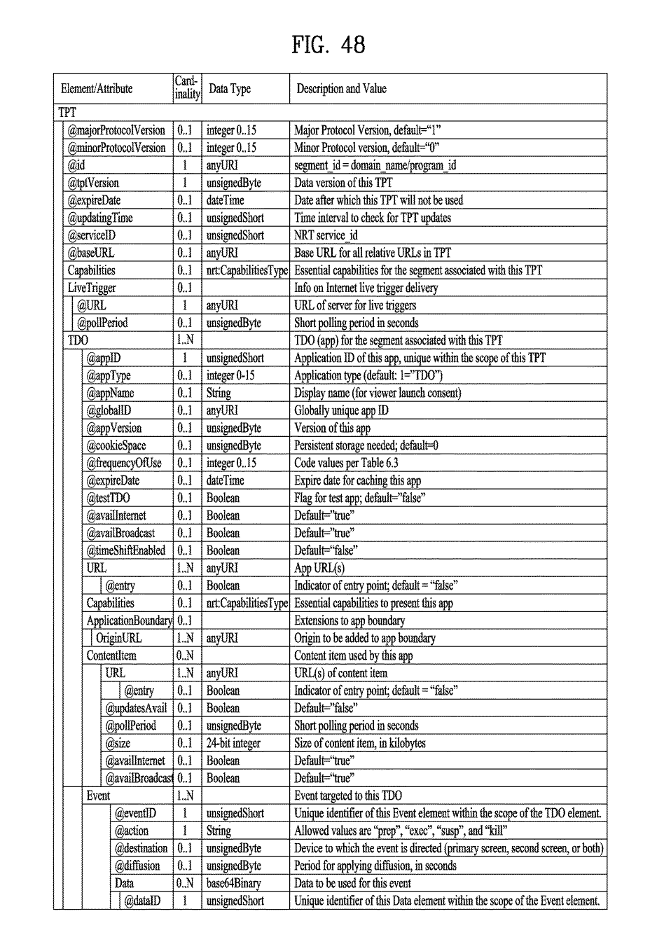

FIG. 48 is a diagram illustrating TPT signaling according to an embodiment of the present invention.

Hereinafter, application signaling information for an application for supporting a time-shift function will be described. The application signaling information may include a trigger and/or triggering application information (or TPT). First, the triggering application information (or TPT) will be described.

The triggering application information may signal information on a triggered application. Alternatively, the triggering application information may include at least one triggered declarative object (TDO) of a segment and metadata of at least one event targeted to at least one TDO. For example, the TDO may be an application. The triggering application information may be a TDO parameters table (TPT). The triggering application information may signal an application corresponding to an entire program segment or a partial program segment according to a time. In this case, the segment or the program segment may indicate time duration included in the program.

The triggering application information may include at least one of majorProtocolVersion attribute, minorProtocolVersion attribute, id attribute, tptVersion attribute, expireDate attribute, updatingTime attribute, serviceID attribute, baseURL attribute, Capabilities element, LiveTrigger element, and/or TDO element. A detailed description of the attribute and/or the element included in triggering application information may include the entire above description.

The TDO element may include at least one of appID attribute, appType attribute, appName attribute, globalID attribute, appVersion attribute, cookieSpace attribute, frequencyOfUse attribute, expireDate attribute, testTDO attribute, availInternet attribute, availBroadcast attribute, URL element, Capabilities element, ApplicationBoundary element, ContentItem element, and/or Event element. A detailed description of the attribute and/or the element included in the TDO element may include the entire above description.

In order to support time-shift according to an application, the broadcast transmitting apparatus may also transmit flag information indicating whether an application is capable of being used in a time-shifted program. For example, the broadcast transmitting apparatus may also transmit flag information indicating whether a corresponding application of the application signaling information (or triggering application information) is capable of supporting time-shift.

To this end, the TDO element according to an embodiment of the present invention may further include timeShiftEnabled attribute. The timeShiftEnabled attribute may indicate whether the application is capable of supporting a time-shift function. For example, the timeShiftEnabled attribute may indicate whether an application is capable of being operated with respect to a time-shifted program. The timeShiftEnabled attribute may have a “false” as a default value.

The broadcast transmitting apparatus may add the timeShiftEnabled attribute to a table (e.g., TPT) indicating information on an application during application signaling and transmit the table to the broadcast receiving apparatus.

The broadcast receiving apparatus may receive triggering application information (or TPT). The broadcast receiving apparatus may store a TPT based on the timeShiftEnabled attribute and/or an AMT for time-shift. For example, when timeShiftEnabled attribute is “true”, the broadcast receiving apparatus may also store the AMT for time-shift transmitted along with the current TPT when a program is recorded by a user in the future.

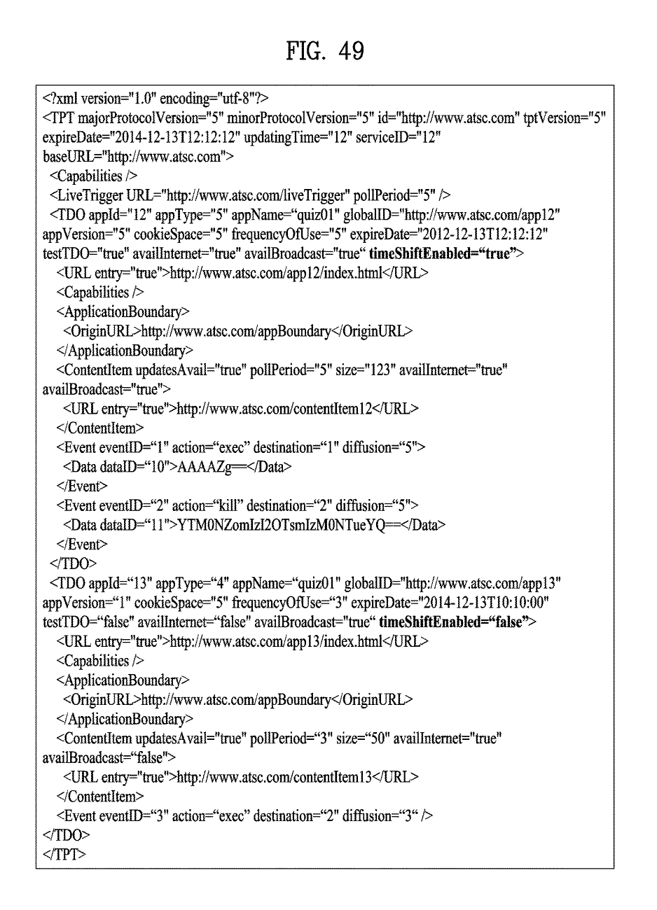

FIG. 49 is a diagram illustrating XML format data of a TPT according to an embodiment of the present invention.

The triggering application information (or TPT) according to an embodiment of the present invention may include at least one of majorProtocolVersion attribute, minorProtocolVersion attribute, id attribute, tptVersion attribute, expireDate attribute, updatingTime attribute, serviceID attribute, baseURL attribute, Capabilities element, LiveTrigger element, and/or TDO element.

The majorProtocolVersion attribute may indicate “5”. The minorProtocolVersion attribute may indicate “5”. The id attribute may indicate “http://www.atsc.com”. The tptVersion attribute may indicate “5”. The expireDate attribute may indicate “2014-12-13T12:12:12”. The updatingTime attribute may indicate “12”. The serviceID attribute may indicate “12”. The baseURL attribute may indicate “http://www.atsc.com”. The Capabilities attribute may indicate a default value. URL attribute of the LiveTrigger element may indicate “http://www.atsc.com/liveTrigger”. The pollPeriod attribute of the LiveTrigger element may indicate “5”.

The TDO element may include a first TDO element and/or a second TDO element.

The first TDO element may include at least one of appID attribute, appType attribute, appName attribute, globalID attribute, appVersion attribute, cookieSpace attribute, frequencyOfUse attribute, expireDate attribute, testTDO attribute, availInternet attribute, availBroadcast attribute, URL element, Capabilities element, ApplicationBoundary element, ContentItem element, and/or Event element.

The appId attribute may indicate “12”. The appType attribute may indicate “5”. The appName attribute may indicate “quiz01”. The globalID attribute may indicate “http://www.atsc.com/app12”. The appVersion attribute may indicate “5”. The cookieSpace attribute may indicate “5”. The frequencyOfUse attribute may indicate “5”. The expireDate attribute may indicate “2012-12-13T12:12:12”. The testTDO attribute may indicate “true”. The availInternet attribute may indicate “true”. The availBroadcast attribute may indicate “true”. The timeShiftEnabled attribute may indicate “true”.

The entry attribute of the URL element may indicate “true”. The URL element may indicate “http://www.atsc.com/app12/index.html”. The Capabilities element may indicate a default value. The OriginURL element of the ApplicationBoundary element may indicate “http://www.atsc.com/appBoundary”. The updatesAvail attribute of the ContentItem element may indicate “true”, the pollPeriod attribute may indicate “5”, the size attribute may indicate “123”, the availInternet attribute may indicate “true”, and the availBroadcast attribute may indicate “true”. The entry attribute of the URL element may indicate “true” and the URL element may indicate “http://www.atsc.com/contentItem12”.

The Event element may include a first Event element and/or a second Event element.

The eventID attribute of the first Event element may indicate “1”, the action attribute may indicate “exec”, the destination attribute may indicate “1”, and the diffusion attribute may indicate “5”.

The dataID attribute of the Data element may indicate “10” and the Data element may indicate “AAAAZg==”.

The eventID attribute of the second Event element may indicate “2”, the action attribute may indicate “kill”, the destination attribute may indicate “2”, and the diffusion attribute may indicate “5”.

The dataID attribute of the Data element may indicate “11” and the Data element may indicate “YTM0NZomIzI2OTsmIzM0NTueYQ=”.

The second TDO element may include at least one of appID attribute, appType attribute, appName attribute, globalID attribute, appVersion attribute, cookieSpace attribute, frequencyOfUse attribute, expireDate attribute, testTDO attribute, availInternet attribute, availBroadcast attribute, URL element, Capabilities element, ApplicationBoundary element, ContentItem element, and/or Event element.

The appId attribute may indicate “13”, the appType attribute may indicate “4”, the appName attribute may indicate “quiz01”, the globalID attribute may indicate “http://www.atsc.com/app13”, the appVersion attribute may indicate “1”, the cookieSpace attribute may indicate “5”, the frequencyOfUse attribute may indicate “3”, the expireDate attribute may indicate “2014-12-13T10:10:00”, the testTDO attribute may indicate “false”, the availInternet attribute may indicate “false”, the availBroadcast attribute may indicate “true”, and the timeShiftEnabled attribute may indicate “false”. The entry attribute of the URL element may indicate “true” and the URL element may indicate “http://www.atsc.com/app13/index.html”. The Capabilities element may have a default value. The OriginURL attribute of the ApplicationBoundary element may indicate “http://www.atsc.com/appBoundary”. The updatesAvail attribute of the ContentItem element may indicate “true”, the pollPeriod attribute may indicate “3”, the size attribute may indicate “50”, the availInternet attribute may indicate “true”, and the availBroadcast attribute may indicate “false”. The entry attribute of the URL element may indicate “true” and the URL element may indicate “http://www.atsc.com/contentItem13”.

The eventID attribute of the Event element may indicate “3”, the action attribute may indicate “exec”, the destination attribute may indicate “2”, and the diffusion attribute may indicate “3”.

Referring to the drawing, the timeShiftEnabled attribute of the first TDO element may indicate “true”. Accordingly, an application signaled by the first TDO element may support time-shift. However, the timeShiftEnabled attribute of the second TDO element may indicate “false”. Accordingly, an application signaled by the second TDO element may not support time-shift.

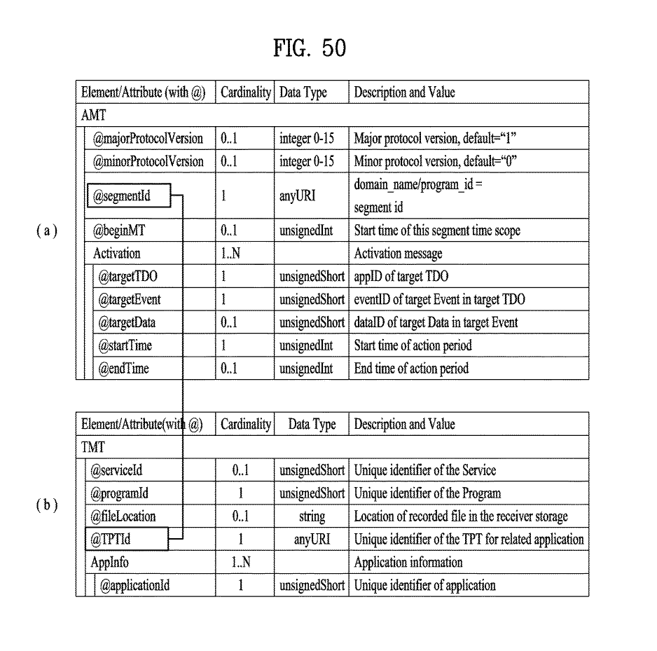

FIG. 50 is a diagram illustrating trigger signaling according to an embodiment of the present invention.

When the broadcast receiving apparatus presents a time-shifted program, the broadcast receiving apparatus may not receive a trigger (or application trigger) from the broadcast transmitting apparatus through a broadcast network.

Hereinafter, a method of signaling a trigger by a broadcast receiving apparatus when the broadcast receiving apparatus presents a time-shifted program will be described.

A trigger may trigger an operation of an application. The trigger may identify signaling and may establish timing of play out of at least one interactive event. The trigger may perform timing-related signaling functions in order to support at least one interactive service.

For example, the trigger information may include information on attribute of the trigger. The trigger information may include at least one of an application ID (or appID) for identifying an application (or TDO) targeted by a triggering event, a triggering event ID (or eventID) for identifying a triggering event (or event) of an application, a data ID (or dataID) for identifying data related to a triggering event, start time information (or startTime) indicating start time of a triggering event, and/or end time information (or endTime) indicating end time of a triggering event.

(a) of FIG. 50 illustrates an Activation Messages Table (AMT).

The AMT may include information corresponding to at least one activation trigger of a program segment. For example, the AMT may include a large amount of at least one activation trigger of the program segment. The AMT may be transmitted through a broadcast network and/or the Internet by the broadcast transmitting apparatus.

The AMT may include at least one of majorProtocolVersion attribute, minorProtocolVersion attribute, segmentId attribute, beginMT attribute, and/or Activation element.

The majorProtocolVersion attribute may indicate a major protocol version. When the majorProtocolVersion attribute is present, the optional attribute of the AMT element with an integer of 0 to 15 may indicate a major version number of AMT definition. The major version number may be set to “1” as a default value. The broadcast receiving apparatus may disregard the AMT indicating a major version value that is not capable of being supported.

The minorProtocolVersion attribute may indicate a minor protocol version. When the minorProtocolVersion attribute is present, the optional attribute of the AMT element with an integer of 0 to 15 may indicate a minor version number of AMT definition. When the minorProtocolVersion attribute is not present, the minor version number may be set to “0”. The minor version number may be set to “0” as a default value. The broadcast receiving apparatus may disregard an AMT indicating a minor version value that is not capable of being supported. In this case, the broadcast receiving apparatus may disregard the attribute or element that is not capable of being supported.

The segmentId attribute may be an ID matched with an ID of triggering application information (or TPT) including at least one application (or TDO) and/or at least one triggering event. The activation element in the AMT may be applied to at least one application (or TDO) and/or at least one triggering event.

The beginMT attribute may indicate start media time of a program segment. The AMT instance may provide activation times of start media time of a program segment.

The Activation element may include an activation message. The Activation element may indicate a command for activating a particular triggering event at a particular time point. Optionally, the Activation element may indicate a command for activating a particular triggering event with particular data related to a triggering event. The Activation element may include at least one of targetTDO attribute, targetEvent attribute, targetData attribute, startTime attribute, and/or endTime attribute. The Activation element may correspond to a trigger.

The targetTDO attribute may be information matched with an application ID (or appID) of an application (or TDO) of triggering application information (or TPT) related to an AMT. The targetTDO attribute may identify a target application of an activation command.

The targetEvent attribute may be information matched with a triggering event ID (e.g., eventID) of a triggering event element (or event element) included in an application (or TDO element) identified according to the targetTDO attribute. The targetEvent attribute may identify a target triggering event of an activation command.

The targetData attribute may be information matched with a data ID (or dataID) of a data element (or Data element) included in the triggering event (or Event element) identified according to the targetTDO attribute and the targetEvent attribute. When the activation command is applied, the targetData attribute may identify data related to the target triggering event.

The startTime attribute may indicate start of a valid time period of a triggering event related to media time. When the media time reaches a value of the startTime attribute, the broadcast receiving apparatus may execute a command.

The endTime attribute may indicate end of a valid time period of a triggering event related to media time. When the media time exceeds a value of the endTime attribute, the broadcast receiving apparatus may not execute a command.

Activation elements of an AMT may be indicated in an order in which a value of the startTime attribute increases. When the broadcast receiving apparatus activates triggering events according to the Activation elements in the AMT, the broadcast receiving apparatus may apply activation of each triggering event at a time point indicated by a value of the startTime attribute. The broadcast receiving apparatus may apply activation of each triggering event at an earlier time if possible after a time point indicated by the startTime attribute. For example, when the broadcast receiving apparatus participates in a service and receives an AMT at a particular time point after time indicated by the startTime attribute prior to time indicated by the endTime attribute, the broadcast receiving apparatus may apply activation of each triggering event at an earlier time if possible after time indicated by the startTime attribute. When the action attribute of a triggering event indicates “execution (or exec)”, the broadcast receiving apparatus may transmit a triggering event (or TriggerEvent) to a target application.

(b) of FIG. 50 illustrates a Time-shift Management Table (TMT).

The TMT may describe an application for supporting a time-shift function. For example, the TMT may include at least one of serviceId attribute, programId attribute, fileLocation attribute, TPTId attribute, and/or AppInfo element. The AppInfo element may include applicationId attribute. A detailed description of the TMT may be the same as the above description.

The broadcast receiving apparatus may record a program that is present in real time.

While recording a program, the broadcast receiving apparatus may receive and store an Activation Messages Table (AMT) for time-shift. According to an embodiment of the present invention, the AMT may include at least one trigger (or trigger information).

Then, the broadcast receiving apparatus may generate a TMT that describes an application for supporting a time-shift function based on an AMT including at least one trigger using a time-shift manager.

Then, when a program recorded by a user is present, a time-shift manager of the broadcast receiving apparatus may search for a TPT and/or application ID (or application ID) associated with a program based on the TMT. For example, the TPTId attribute of the TMT may be matched with the ID attribute of the TPT. In addition, the applicationId attribute of the TMT may be matched with the appID attribute of the TPT.

The broadcast receiving apparatus may search for a trigger based on an AMT related to the TMT. For example, the broadcast receiving apparatus may search for a trigger (trigger information or application trigger information) of time-shifted application using the segmented of the AMT as the same ID value as TPTId of the TMT. For example, the TPTId attribute of the TMT may be matched with the segmentId attribute of the AMT. In addition, the applicationId attribute of the TMT may be matched with the targetTDO attribute of the AMT.

Then, the broadcast receiving apparatus may execute an application based on a trigger included in the AMT. In addition, the broadcast receiving apparatus may execute an application based on the AMT. For example, the broadcast receiving apparatus may execute an application like real time broadcast based on the AMT that is related to the TMT and has the same application ID (or application ID).

The broadcast receiving apparatus may provide an interaction to a user through an action of an application.

Accordingly, the broadcast receiving apparatus may discover a TPT and/or an application based on the TMT and may execute the application based on a trigger included in the AMT included in the TMT. For example, the broadcast receiving apparatus may execute a target triggering event included in the TPT on a target application based on a trigger.

The broadcast receiving apparatus may transmit signaling information signaling including a TMT, an AMT, and/or a TPT to the companion screen device. For example, the broadcast receiving apparatus may transmit signaling information including a TMT, an AMT, and/or a TPT to the companion screen device using an eventing method and/or a requesting method.

Accordingly, the companion screen device may operate an application for supporting a time-shift function while presenting a time-shifted program. A detailed description of the companion screen device may include the entire above description of the broadcast receiving apparatus.

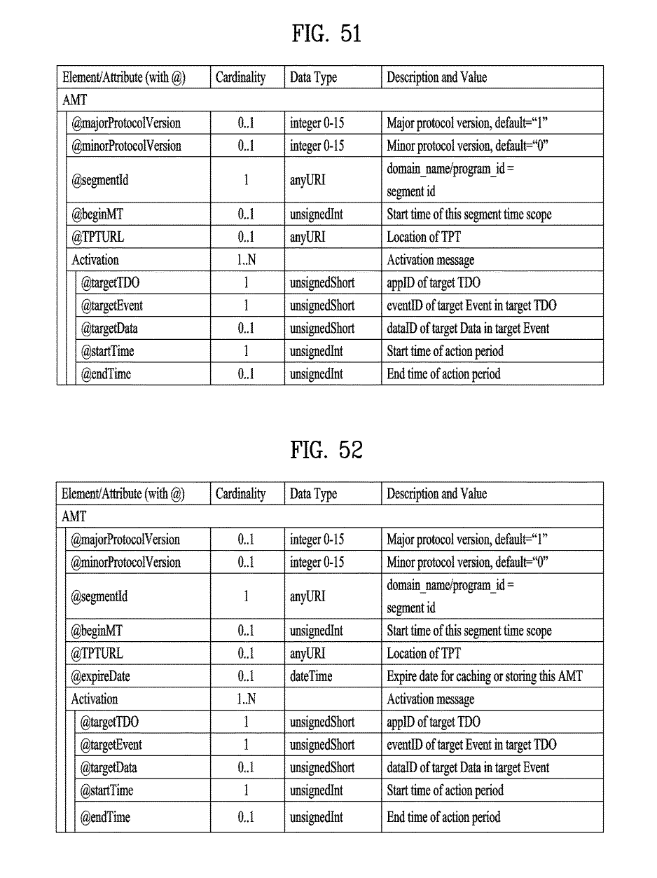

FIG. 51 is a diagram illustrating an AMT including TPT URL attribute according to an embodiment of the present invention.

The AMT according to an embodiment of the present invention may include at least one of majorProtocolVersion attribute, minorProtocolVersion attribute, segmentId attribute, beginMT attribute, and/or Activation element. The Activation element may include at least one of targetTDO attribute, targetEvent attribute, targetData attribute, startTime attribute, and/or endTime attribute. A detailed description of the AMT may include the entire above description of the aforementioned AMT.

The AMT according to an embodiment of the present invention may further include TPTURL attribute. The TPTURL attribute may indicate a location of the triggering application information (or TPT).

For example, the location of the triggering application information may be represented in the form of uniform resource identifier (URI). The URI may include a Uniform Resource Locator (URL) and/or a Uniform Resource Name (URN). The URL may be information indicating a network location of a web resource. The URN may be information for identifying a resource according to a name of a particular namespace. When a location in on-line is indicated, the location of the triggering application information may be represented according to “http://[domain]/[directory]”. When a location in Session (e.g. FLUTE session, ROUTE session, and ALC/LCT session) is indicated, the location of the triggering application information may be represented according to “file://[ip_address]/[path]”. That is, a format ID element and/or a format ID field may be represented according to “http://[domain]/[directory]” and/or “file://[ip_address]/[path]”.

The broadcast receiving apparatus may receive triggering application information (or TPT) through a broadcast network while a program is watched in real time. However, when a user attempts to watch a time-shifted program in the future, triggering application information (or TPT) of a corresponding program in storage (or device storage) of the broadcast receiving apparatus may not be valid any longer.

In this case, the broadcast transmitting apparatus may transmit an AMT including TPTURL attribute indicating a location of the triggering application information (or TPT). The broadcast transmitting apparatus may transmit the triggering application information through the Internet.

The broadcast receiving apparatus may receive an AMT including TPT URL attribute indicating a location of the triggering application information (or TPT). The broadcast receiving apparatus may receive the triggering application information (or TPT or application property information) related to a program to be time-shifted based on the TPTURL attribute through the Internet.

FIG. 52 is a diagram illustrating an AMT including expireDate attribute according to an embodiment of the present invention.

The AMT according to an embodiment of the present invention may include at least one of majorProtocolVersion attribute, minorProtocolVersion attribute, segmentId attribute, beginMT attribute, and/or Activation element. The Activation element may include at least one of targetTDO attribute, targetEvent attribute, targetData attribute, startTime attribute, and/or endTime attribute. A detailed description of the AMT may include the entire above description of the aforementioned AMT.

The AMT according to an embodiment of the present invention may further include expireDate attribute. The expireDate attribute may indicate available time of the AMT. For example, the expireDate attribute may indicate expire data (or which includes date) for cashing or storing the AMT. The expireDate attribute may indicate an available time of a time-shift application, that is, an available time of the AMT.

The broadcast transmitting apparatus may transmit an AMT including the expireDate attribute indicating an available time of the AMT. For example, the broadcast transmitting apparatus may transmit the AMT including the expireDate attribute in order to set the available time of the AMT.

The broadcast receiving apparatus may receive the AMT including the expireDate attribute indicating the available time of the AMT. The broadcast receiving apparatus may process the AMT based on the expireDate attribute. For example, when a time indicated by the expireDate attribute elapses, the AMT related to the broadcast receiving apparatus may be deleted.

The broadcast receiving apparatus may process the AMT based on the expireDate attribute included in the triggering application information (or TPT). For example, when a time indicated by the expireDate attribute elapses, the broadcast receiving apparatus may delete a related AMT.

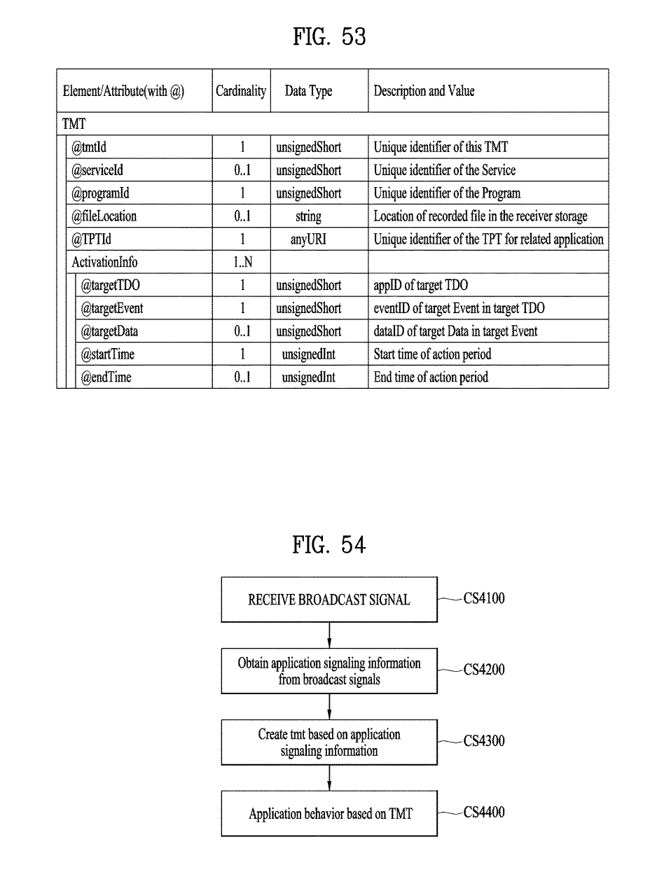

FIG. 53 is a diagram illustrating a TMT including trigger information according to an embodiment of the present invention.

The TMT according to an embodiment of the present invention may describe an application related to a time-shifted program. For example, the TMT may include at least one of serviceId attribute, programId attribute, fileLocation attribute, and/or TPTId attribute. A detailed description of the TMT may include the entire above description of the aforementioned TMT.

The TMT according to an embodiment of the present invention may include at least one of tmtId attribute and/or ActivationInfo element. The TMT may include at least one trigger information item indicating attribute of at least one trigger of a program segment.

The tmtId attribute may an ID for uniquely identifying the TMT.

The ActivationInfo element may include trigger information indicating attribute of at least one trigger. For example, the ActivationInfo element may include at least one of targetTDO attribute, targetEvent attribute, targetData attribute, startTime attribute, and/or endTime attribute.

The targetTDO attribute may be information matched with an application ID (or appID) of an application (or TDO) in triggering application information (or TPT) related to the AMT. The targetTDO attribute may identify a target application of an activation command.

The targetEvent attribute may be information matched with a triggering event ID (or eventID) of a triggering event element (or event element) included in an application (or TDO element) identified by the targetTDO attribute. The targetEvent attribute may identify a target triggering event of the activation command.

The targetData attribute may be information matched with a data ID (or dataID) of a data element (or dataID) of a data element (or Data element) included in a triggering event (or Event element) identified according to the targetTDO attribute and the targetEvent attribute. When the activation command is applied, the targetData attribute may identify data related to the target triggering event.

The startTime attribute may indicate start of a valid time period of a triggering event in association with media time. When the media time reaches a value of the startTime attribute, the broadcast receiving apparatus may execute a command.

The endTime attribute may indicate end of the valid time period of the triggering event in association with the media time. When the media time passes a value of the endTime attribute, the broadcast receiving apparatus may not execute a command.

The broadcast transmitting apparatus may transmit at least one of triggering application information (or TPT) and/or an AMT.

The triggering application information may include at least one triggered declarative object (TDO) of a segment and metadata of at least one event targeted to at least one TDO.

The AMT may include at least one trigger information time indicating attribute of at least one trigger of a program segment. The program segment may indicate a segment of the time-shifted program. The segment or the program segment may indicate time duration included in the program.

The broadcast receiving apparatus at least one of triggering application information (or TPT) and/or an AMT. The broadcast receiving apparatus may store at least one of the triggering application information (or TPT) and/or the AMT.

Then, the broadcast receiving apparatus may generate a TMT that describes an application related to a segment of a time-shifted program based on the AMT using a time-shift manager.

The TMT may include application signaling information. For example, the TMT may include at least one trigger information item indicating attribute of at least one trigger of a program segment. The TMT may include information included in the triggering application information (or TPT) and/or at least one trigger information item indicating attribute of at least one trigger included in the AMT for time-shift.

In this case, the broadcast receiving apparatus needs to maintain the triggering application information (or TPT) but it may not be necessary to maintain the AMT. This is because the broadcast receiving apparatus already generates a TMT including information included in the triggering application information (or TPT) based on the AMT and/or at least one trigger information item indicating attribute of at least one trigger included in the AMT for time-shift.

Then, the broadcast receiving apparatus may operate an application related to a segment of a time-shifted program based on at least one trigger information item included in the TMT.

Hereinafter, a method of supporting an interactive application of a non-real time program according to an embodiment of the present invention will be described.

A next-generation hybrid broadcast system may also provide an interactive application in the case of a program provided by an app-based service such as on-demand. For example, the next-generation hybrid broadcast system may also provide an interactive application in the case of a program provided by a service that is not capable of transmitting application signaling information through a broadcast network.

For example, a user is watching a drama using an on-demand VOD service provided in channel #100. The drama may provide an interactive application. The interactive application may provide information such as quiz of personal information and storyline. While watching the drama using the on-demand VOD service, the user may expect to use the interactive application provided anytime.

In this case, the next-generation hybrid broadcast system according to an embodiment of the present invention may provide an interactive application. The broadcast system according to an embodiment of the present invention may transmit signaling information and/or trigger information of an application to the broadcast receiving apparatus using Automatic Contents Recognition (ACR). The ACR method may include a method using Finger Printing and/or a method of inserting watermark.

FIG. 54 is a flowchart illustrating an operation of an application based on a broadcast signal by a broadcast receiving apparatus according to another embodiment of the present invention.

The broadcast receiving apparatus may receive a broadcast signal (CS4100). In detail, the broadcast receiving apparatus may receive signaling information and a service including a program using a broadcast interface. The broadcast receiving apparatus may receive signaling information based on an MPEG-DASH protocol and/or an MMT protocol using a broadcast interface. The signaling information may include media time information of the presented program.

The broadcast receiving apparatus may acquire signaling information including application signaling information from the broadcast signal using a signaling parser (CS4200).

The broadcast receiving apparatus may discover a companion screen device using a companion screen interface. The broadcast receiving apparatus may operate a broadcast interface and a companion screen interface using a controller. For example, the controller may include a time synchronization service processor for generating service time information for providing data related to time synchronization between the program and a program displayed by the companion screen device based on signaling information. The broadcast receiving apparatus may transmit the service time information to the companion screen device using the companion screen interface.

The signaling information may include an activation message table including at least one trigger of a program.

The broadcast receiving apparatus may generate a time-shift management table (TMT) based on the application signaling information using the controller (CS4300).

For example, the controller may further include a time-shift manager for generating a time-shift management table that describes an application executed in a time-shifted program based on the activation message table.

The broadcast receiving apparatus may operate an application based on the activation message table (CS4400). For example, the broadcast receiving apparatus may operate an application based on the time-shift management table using the controller.

The signaling information may include triggering application information including metadata of an application. The broadcast receiving apparatus may extract a trigger and triggering application information based on the time-shift management table using the controller. The broadcast receiving apparatus may operate an application based on the trigger and the triggering application information using the controller.

The triggering application information may include timeShiftEnabled attribute indicating whether an application is operated with respect to a time-shifted program.

The activation message table may include at least one of majorProtocolVersion attribute indicating a major protocol version, minorProtocolVersion attribute indicating a minor protocol version, segmentId attribute indicating an ID matched with an ID of the triggering application information, beginMT attribute indicating start media time of a program segment, and Activation element including an activation message.

The broadcast receiving apparatus may further include a broadcast interface connected to a content server through the Internet. The activation message table may further include TPTURL attribute indicating a location of the triggering application information. The broadcast receiving apparatus may receive triggering application information from the content server based on the TPTURL attribute using the broadband interface.

The activation message table may further include expireDate attribute indicating an available time of the activation message table. The broadcast receiving apparatus may delete an activation message table using the controller when a time indicated by the expireDate attribute elapses.

The time-shift management table may include at least one of serviceId attribute indicating a unique ID of a service, programId attribute indicating a unique ID of the program, fileLocation attribute indicating a location of a file, TPTId attribute indicating a unique ID of triggering application information, AppInfo element including attribute of the application, and ActivationInfo element including trigger information indicating attribute of the trigger

The broadcast receiving apparatus may transmit a time-shift management table to a second screen device using the companion screen interface. For example, the broadcast receiving apparatus may transmit the time-shift management table to the second screen device using at least one of an eventing method and/or a requesting method using the companion screen interface.

A module, a processor, a device, or a unit may be processors for execution of consecutive procedures stored in a memory (or storage unit). Each operation described in the aforementioned embodiments may be performed by hardware/processors. Each module/block/units described in the aforementioned embodiments may be executed as code. The code may be written in a storage medium readable by a processor and, accordingly, readable by a processor provided by an apparatus.

A method invention according to the present invention may be embodied in the form of a program command to be executed through various computer elements and recorded in a computer readable medium.

The computer readable medium may include a program command, a data file, a data configuration, and so on alone or in combination thereof. The program command stored in the medium may be particularly designed and configured for the present invention or may be well known or used by one of the ordinary skill in the art of computer software. Examples of the computer readable medium may include magnetic media such as a hard disk, a floppy disk, and a magnetic tape, optical media such as CD-ROM and DVD, magneto-optical media such as floptical disks, and a hardware device that is particularly configured to store and execute a program command such as a read only memory (ROM), a random access memory (RAM), and a flash memory. Examples of the program command may include a high-level language code to be executed by a computer using an interpreter or the like as well as a machine code generated by a compiler. The hardware device may be configured to operate as one or more software modules in order to perform the operation according to the present invention and vice versa.

It will be apparent to those skilled in the art that various modifications and variations can be made in the present invention without departing from the spirit or scope of the inventions. Thus, it is intended that the present invention cover the modifications and variations of this invention provided they come within the scope of the appended claims and their equivalents.

Accordingly, it will be apparent to those skilled in the art that various modifications and variations can be made in the present invention within the scope of the appended claims and their equivalents.

In addition, throughout this specification, both device and method inventions have been described. As necessary, the description of the device and method inventions may be applied supplementarily.

### MODE FOR INVENTION

Various embodiments have been described in the best mode for carrying out the invention.

### INDUSTRIAL APPLICABILITY

The present invention may be used in all fields related to broadcasting.

1. A broadcast receiving apparatus comprising:
a broadcast interface to receive signaling information and a service including a program, the signaling information including media time information of the presented program;
a companion screen interface to discover a companion screen device; and
a controller to operate the broadcast interface and the companion screen interface,
wherein the controller comprises a time synchronization service processor to generate service time information for providing information related to time synchronization between the program and a program displayed by the companion screen device based on the signaling information, and
wherein the companion screen interface transmits the service time information to the companion screen device.

2. The broadcast receiving apparatus according to claim 1,
wherein the service time information comprises at least one of serviceId attribute indicating an identifier (ID) of the service, programId attribute indicating an ID of the program presented in the service, mediaTime element indicating the media time information of the program, and/or currentTime element indicating wall-clock time.

3. The broadcast receiving apparatus according to claim 1,
wherein the companion screen interface transmits the service time information to the companion screen device based on a first request of making a request for acquisition of the service time information received from the companion screen device.

4. The broadcast receiving apparatus according to claim 1,
wherein the time synchronization service processor generates update interval information indicating an interval for transmitting the service time information, and
wherein the companion screen interface transmits the service time information to the companion screen device based on the update interval information.

5. The broadcast receiving apparatus according to claim 4,
wherein the update interval information is one of delivery duration information indicating duration for transmitting the service time information and delivery frequency information indicating a frequency for transmitting the service time information.

6. The broadcast receiving apparatus according to claim 4,
wherein the companion screen interface receives a second request of making a request for acquisition of the update interval information,
wherein the time synchronization service processor generates current update interval information indicating a value of the update interval information at a time point indicated by the wall-clock time based on the second request, and
wherein the companion screen interface transmits the current update interval information to the companion screen device.

7. The broadcast receiving apparatus according to claim 4,
wherein the companion screen interface receives a third request of making a request for setup of the update interval information from the companion screen device,
wherein the third request comprises requested update interval information indicating a value of update interval information requested by the companion screen device,
wherein the time synchronization service processor generates confirmed update interval information indicating one of the same value as the requested update interval information and a closest value to the requested update interval information, and
wherein the companion screen interface transmits the service time information to the companion screen device based on the confirmed update interval request information.

8. The broadcast receiving apparatus according to claim 1,
wherein the signaling information comprises an activation message table comprising at least one trigger of the program,
wherein the controller further comprises a time-shift manager to generate a time-shift management table that describes an application operated in the time-shifted program based on the activation message table, and
wherein the controller operates the application based on the time-shift management table.

9. The broadcast receiving apparatus according to claim 8,
wherein the signaling information comprises triggering application information comprising metadata of the application,
wherein the controller extracts the trigger and the triggering application information based on the time-shift management table, and
wherein the controller operates the application based on the trigger and the triggering application information.

10. The broadcast receiving apparatus according to claim 9,
wherein the triggering application information comprises timeShiftEnabled attribute indicating whether the application is operated with respect to the time-shifted program.

11. The broadcast receiving apparatus according to claim 8,
wherein the activation message table comprises at least one of majorProtocolVersion attribute indicating a major protocol version, minorProtocolVersion attribute indicating a minor protocol version, segmentId attribute indicating an ID matched with an ID of the triggering application information, beginMT attribute indicating start media time of a program segment, and Activation element comprising an activation message.

12. The broadcast receiving apparatus according to claim 11, further comprising a broadband interface connected to a content server through the Internet,
wherein the activation message table further comprises TPTURL attribute indicating a location of the triggering application information, and
wherein the broadband interface receives the triggering application information from the content server based on the TPTURL attribute.

13. The broadcast receiving apparatus according to claim 11,
wherein the activation message table further comprises expireDate attribute indicating an available time of the activation message table, and
wherein the controller deletes the activation message table when a time indicated by the expireDate attribute elapses.

14. The broadcast receiving apparatus according to claim 12,
wherein the time-shift management table comprises at least one of serviceId attribute indicating a unique ID of the service, programId attribute indicating a unique ID of the program, fileLocation attribute indicating a location of a file, TPTId attribute indicating a unique ID of triggering application information, AppInfo element comprising attribute of the application, and ActivationInfo element comprising trigger information indicating attribute of the trigger.

15. The broadcast receiving apparatus according to claim 8,
wherein the companion screen interface transmits the time-shift management table to the second screen device.
